(19) United States
(12) Patent Application Publication
(10) Pub. No.: US 2012/0296029 A1
(43) Pub. Date: Nov. 22, 2012

(54) FLUORINE-CONTAINING MULTIFUNCTIONAL MICROSPHERES AND USES THEREOF

(76) Inventors: Guojun Liu, Kingston (CA); Dean Xiong, Kingston (CA)

(21) Appl. No.: 13/461,404

(22) Filed: May 1, 2012

(30) Foreign Application Priority Data
May 20, 2011 (CN) 201110131477.X

(51) Int. Cl. C09D 133/12; C09D 133/16; B82Y 30/00

(52) U.S. Cl. 524/520; 524/522; 977/773

(57) ABSTRACT

Fluorine-containing multifunctional microspheres and applications thereof are provided. There are provided multifunctional microspheres comprising polymer chains having a first portion and a second portion, wherein the first portion is anchored to the surface of the multifunctional microsphere via grafting, crosslinking or a combination thereof, and the second portion comprises at least one fluorinated group and at least one reactive functional group capable of forming a covalent bond with an adhesive, and uses thereof to prepare amphiphobic coatings on material surfaces. Also provided are multifunctional microspheres comprising two or more different types of such polymer chains, wherein the relative proportions of the different polymer chains may be tuned during preparation of the multifunctional microspheres.

### FIELD OF THE INVENTION

This invention relates to multifunctional microspheres, methods for preparing same, and applications thereof for providing amphiphobic coatings on material surfaces, as well as to amphiphobic coating formulations or preparations and amphiphobic coatings.

### BACKGROUND OF THE INVENTION

Perfluorinated hydrocarbons and fluorinated polymers such as Teflon® possess low surface tension. Common liquids such as water and oil do not spread on these surfaces, which are considered to be amphiphobic, i.e., both hydrophobic (water-repelling) and lipophobic or oleophobic (fat- or oil-repelling). There are few examples of naturally-occurring amphiphobic surfaces.

Water droplets generally have contact angles 90° or larger on hydrophobic surfaces. Superhydrophobic surfaces comprise a material that allows water droplets to roll off easily when tilted at an angle of 10° or less relative to a horizontal surface, and have contact angles 150° or larger (Wang, S. and Jiang, L., Adv. Mater., 2007, 19: 3423-3424). In addition, the difference between advancing and receding contact angles (contact angle hysteresis) is small. When oil droplets also demonstrate this phenomenon or are repelled similarly on the surface of a particular material, the material is considered to be amphiphobic or superamphiphobic. Superamphiphobic materials have excellent repellent properties and are often referred to as “self-cleaning”.

One key criterion for amphiphobicity is that surface energy of a material is lower than surface energy of water or oil (Nosonovsky, M. and Bhushan, B., J. Phys.: Condens. Matter, 2008, 20; Bico, J. et al., Europhys. Lett, 1999, 47: 220-226; Chen, W. et al., Langmuir, 1999, 15: 3395-3399). Consequently, low-surface-energy fluorinated compounds or polymers are often used to prepare amphiphobic material surfaces. However fluorinated-compounds or polymers are expensive. A typical way to prepare a fluorinated material surface is therefore to graft only a thin layer of a fluorinated compound onto a substrate or material surface without changing the bulk composition of the substrate or material surface. This can, for example, be achieved using coupling agents such as 1H,1H,2H,2H-perfluorodecyltriethoxysilane or 2-(perfluorooctyl)ethyl triethoxysilane (CF₃(CF₂)₇CH₂CH₂Si(OC₂H₅)₃ or FOETREOS). To modify silica or glass surfaces that bear surface silanol groups (Si—OH), one can graft onto them a 2-(perfluorooctyl)ethyl triethoxysilane (CF₃(CF₂)ₙCH₂CH₂Si(OC₂H₅)₃ (FOETREOS) layer (Sun, T. et al., J. Am. Chem. Soc., 2003, 125: 14996-14997). FOETREOS grafts onto these surfaces because of reactive triethoxysilane (TREOS) groups; TREOS undergoes sol-gel reactions, which involve hydrolysis of ethoxy groups to yield silanols and then condensation of different silanol groups to produce siloxane linkages (Si—O—Si) (Brinker, C. J. and Scherer, G., W., Sol-Gel Science: The Physics and Chemistry of Sol-Gel Processing, Academic Press, Inc.: Boston, 1990).

Several methods have been used previously to prepare fluorine-containing amphiphobic materials. A material surface may be directly coated with a fluorine-containing compound, which can bond with the material surface through hydrogen bonds, static electricity, van der Waals forces or covalent bonds. Alternatively, a coating substrate containing a fluorine-containing compound is prepared first, and the coating substrate is then applied to a material surface. For example, nano- or micro-sized particles may be coated first, and then used to coat a material surface, forming a rough coating. In this manner, particles and assembled structures thereof can form a multi-scale rough surface, providing favorable conditions for hydrophobic/oleophobic properties of a coated material.

In addition to having a low surface tension, surfaces should generally be rough to render amphiphobicity. One practical and relatively inexpensive way to prepare a rough surface is to apply a rough coating onto a surface. Rough coatings can be applied using traditional coating techniques, such as dry powder coating or wet painting (Bailey, A. G., J. Electrostat., 1998, 45: 85-120). For example, in wet painting, non-deformable particles with fluorinated surfaces are added into a paint mixture including a binder (resin), a vehicle (solvent), and other additives. After solvent evaporates, the binder can form a uniform film strewn with the fluorinated particles, which protrude above the binding film, providing a composite rough coating.

However, while many fluorinated particles and rough coatings have been reported (Wang, H. X. et al., Chem. Commun., 2008, 877-879; Ofir, Y. et al., Adv. Mater., 2007, 19: 4075-79), prior particles were designed and prepared with little consideration to the final integration of the particles into a durable rough coating. Fluorinated particles do not stick to hydrocarbon polymers, and a durable coating is generally possible only if there is a strong particle-resin interaction and/or a resin-surface interaction. Accordingly, with known methods, since particle surfaces often contain only fluorine, coatings are prone to fall off material surfaces, resulting in loss of hydrophobic/oleophobic properties.

There is a need therefore for improved fluorine-containing particles, in order to provide robust amphiphobic coatings on material surfaces.

### SUMMARY OF THE INVENTION

We report herein that some or all of the above shortcomings of present methods of preparing fluorine-containing amphiphobic particles can be overcome using multifunctional particles, e.g., nano- or micro-sized particles containing a variety of functional groups. Accordingly, fluorine-containing multifunctional microspheres and applications thereof to provide amphiphobic coatings on material surfaces, e.g., amphiphobic particulate coatings on material surface, are provided herein. Amphiphobic coatings comprising such multifunctional microspheres and an adhesive which is bonded to the multifunctional microspheres are also provided herein. Also provided are coating preparations or formulations comprising such multifunctional microspheres, optionally in combination with an adhesive or an adhesive precursor. In addition, powder coating comprising application of multifunctional microspheres directly (i.e., without solvent) to a material surface is provided. Even if the multifunctional microsurfaces employed for a coating comprise functionalities that can react with the material surface, it is preferred to provide adhesive (e.g., solid adhesive) with said multifunctional microspheres, as a more durable coating is obtained.

Fluorine-containing functionalities protruding from the multifunctional microspheres contribute to amphiphobicity. In some aspects of the invention, particulate coatings comprising multifunctional microspheres provide roughness which also contributes to amphiphobicity. In some embodiments, roughness may arise from a closely-packed rugged particle array (rather than a continuous film). In certain embodiments, a rugged array may arise because both the cores and shells of particles are crosslinked and are substantially not deformable and/or because dense coronal chains of different particles do not interpenetrate extensively with one another. In some embodiments, roughness may arise because bumps and/or lobes, formed at least in part by surface chains, exist on at least some of the multifunctional microspheres.

In some aspects of the invention, a multifunctional microsphere which provides an amphiphobic coating comprises two or more types of surface polymer chains. The relative proportions of the different polymer chains may be selected and provided depending upon intended use of the multifunctional microsphere preparation or on other factors. In an embodiment, during preparation of multifunctional microspheres in a “one-pot” reaction, the mole fraction of different polymers in the reaction mixture is selected so that the chosen proportions of polymers are bound to the surface of the microspheres in the end product, i.e., the multifunctional microspheres. That is, the structure or composition of the multifunctional microspheres bearing different polymer chains, and hence their characteristics, may be “tuned”. Such multifunctional microspheres comprising different polymer chains may provide amphiphobic coatings on material surfaces when applied in combination with an adhesive, as described hereinbelow, or in other embodiments may provide amphiphobic coatings on material surfaces in the absence of an adhesive. It will be understood that in general a more durable coating is obtained when adhesive is provided.

According to a first aspect of the invention, there is provided herein a fluorine-containing bi-functional microsphere having the structure of Formula (I):

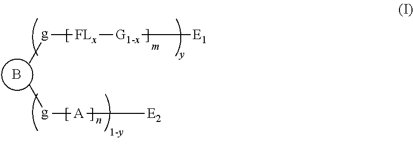

wherein B is a crosslinked polymer microsphere, silicon dioxide microsphere, aluminum(III) trioxide microsphere, or iron(III) trioxide microsphere; g represents a graft; FL is a structural unit containing elemental fluorine; G is a structural unit containing a hydroxyl group, an amino group, a carboxyl group, or an epoxy group; A is a structural unit containing a hydroxyl group, an amino group, a carboxyl group, or an epoxy group; E₁ and E₂ are hydrogen, a halogen, or a thiol group; x is 0 or 1; y is 0 or 1; m is a whole number greater than or equal to 0; and n is a whole number greater than or equal to 0. In an embodiment, x is 1. In an embodiment, y is 1. In an embodiment, m is 1. In an embodiment, x is not 1 when n is 0. In an embodiment, x is 1, y is 1, m is 1, and x is not 1 when n is 0.

In an embodiment, there is provided a fluorine-containing bi-functional microsphere of Formula (I), wherein B is a poly(methyl methacrylate) microsphere having the structure of Formula (II):

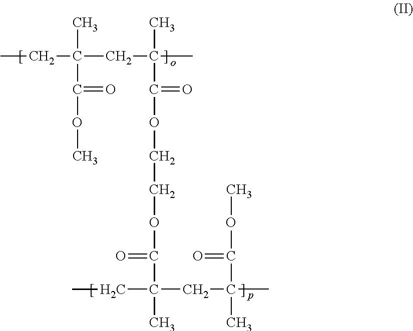

wherein o is a whole number greater than or equal to 0; p is a whole number greater than or equal to 0; m is a value taken from the range 100≦m≦1000; n is a value taken from the range 100≦n≦1000); and the remaining constituents are as defined above for the first aspect. In an embodiment, p and o are not both 0.

In another embodiment, there is provided a fluorine-containing bi-functional microsphere of Formula (I), wherein FL has the structure of Formula (III):

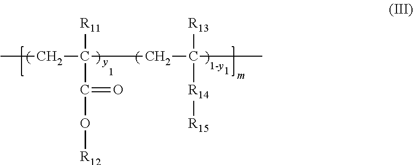

wherein R₁₁ and R₁₃ are hydrogen or a methyl group; R₁₂ and R₁₅ are a fluorine-containing alkyl or a fluorine-containing benzene ring; R₁₄ is an alkylene; and y₁ is a whole number greater than or equal to 0.

In another embodiment, there is provided a fluorine-containing bi-functional microsphere of Formula (I), wherein G has the structure of Formula (IV):

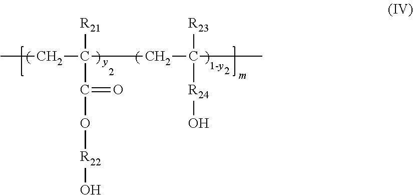

wherein R₂₁ and R₂₃ are hydrogen or a methyl group; R₂₂ and R₂₄ are an alkylene or benzene ring; and y₂ is a whole number greater than or equal to 0.

In another embodiment, there is provided a fluorine-containing bi-functional microsphere of Formula (I), wherein A has the structure represented by Formula (V):

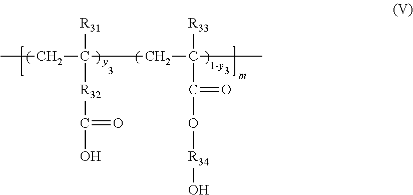

wherein R₃₁ and R₃₃ are hydrogen or a methyl group; R₃₂ and R₃₄ are an alkylene or benzene ring; and y₃ is a whole number greater than or equal to 0; and the remaining constituents are as defined above.

In an embodiment, there is provided a fluorine-containing bi-functional microsphere of Formula (I), wherein FL has the structure of Formula (III):

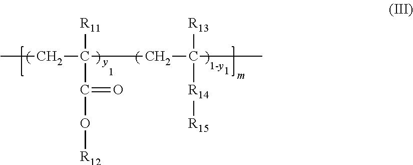

wherein R₁₁ and R₁₃ are hydrogen or a methyl group; R₁₂ and R₁₅ are a fluorine-containing alkyl or a fluorine-containing benzene ring; R₁₄ is an alkylene; and y₁ is a whole number greater than or equal to 0; and G has the structure of Formula (IV):

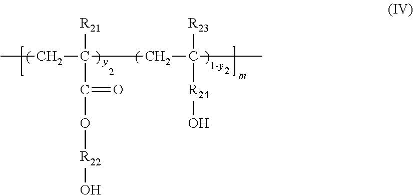

wherein R₂₁ and R₂₃ are hydrogen or a methyl group; R₂₂ and R₂₄ are an alkylene or benzene ring; and y₂ is a whole number greater than or equal to 0; and A has the structure represented by Formula (V):

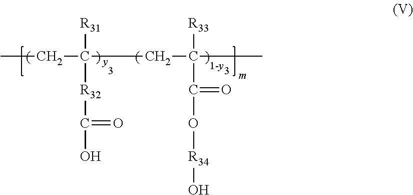

wherein R₃₁ and R₃₃ are hydrogen or a methyl group; R₃₂ and R₃₄ are an alkylene or benzene ring; and y₃ is a whole number greater than or equal to 0; and the remaining constituents are as defined above. In an embodiment, R₁₂ and R₁₅ are heptadecafluoro octyl; R₁₄ is ethylene; R₂₂ and R₂₄ are ethylene; and R₃₂ and R₃₄ are ethylene.

In yet another embodiment, there is provided a fluorine-containing bi-functional microsphere of Formula (I), wherein FL is 2-(perfluorooctyl)ethyl acrylate (FOEA); G is 2-hydroxyethyl acrylate; A is 2-hydroxyethyl acrylate or 2-hydroxyethyl methacrylate; and the remaining constituents are as defined above for the first aspect. In an embodiment, the 2-(perfluorooctyl)ethyl acrylate is obtained from reaction between 2-hydroxyethyl acrylate and heptadecafluorononanoyl chloride.

In a second aspect of the invention, there are provided herein applications of fluorine-containing bi-functional microspheres of the invention in preparing amphiphobic coatings.

In an embodiment, a method for preparing an amphiphobic coating is provided, comprising the steps of: A) pretreating a material surface by washing and cleaning the material surface at room temperature to remove oil contaminants; uniformly coating the material surface with an adhesive; and then curing the same at room temperature for 10 to 40 minutes; B) preparing a coating solution or formulation by dispersing fluorine-containing bifunctional microspheres into α,α,α-trifluorotoluene to obtain a solution of fluorine-containing bi-functional microspheres; and uniformly spray coating the adhesive surface with the solution of the fluorine-containing bi-functional microspheres; and C) continuing to cure at 50° C. to 70° C. for one to three hours; and annealing at 90° C. to 120° C. for 10 to 60 minutes.

In embodiment, the material in step (A) is glass, steel, wood, or cement; the adhesive in step (A) is an epoxy resin adhesive or isocyanate adhesive; and/or the concentration of the solution of fluorine-containing bi-functional microparticles in step (B) is 5 mg/mL.

In a third aspect of the invention there is provided a multifunctional microsphere comprising at least one polymer chain having a first portion and a second portion, wherein the first portion is anchored to the surface of the multifunctional microsphere via grafting, crosslinking or a combination thereof, and the second portion comprises at least one fluorinated group and at least one reactive functional group capable of forming a covalent bond with an adhesive. The at least one polymer chain may project from the surface of the microsphere, i.e., the polymer chains are in the corona of a CSC structure.

In a fourth aspect of the invention there is provided a multifunctional microsphere comprising a first polymer chain and a second polymer chain, each of said polymer chains having a first portion and a second portion, wherein the first portion of each polymer chain is anchored to the surface of the multifunctional microsphere via grafting, crosslinking or a combination thereof, and wherein the second portion of the first polymer chain comprises at least one fluorinated group, and the second portion of the second polymer chain comprises at least one reactive functional group capable of forming a covalent bond with an adhesive; optionally comprising one or more additional polymer chain(s), each additional polymer chain having a first portion and a second portion, wherein the first portion is anchored to the surface of the multifunctional microsphere via grafting, crosslinking or a combination thereof. The first polymer chain, the second polymer chain and the optional additional polymer chain(s) may project from the surface of the microsphere, i.e., the polymer chains are in the corona of a CSC structure.

In some embodiments of the fourth aspect, the first polymer chain further comprises at least one reactive functional group capable of forming a covalent bond with an adhesive.

In some embodiments of the third and fourth aspects, the multifunctional microsphere further comprises a polymer chain which is poly(ethylene glycol) (PEG), poly(dialkyl siloxane), poly(alkyl methacrylate), or poly(alkyl acrylate). In some embodiments the multifunctional microsphere comprises a silica particle, a nanoparticle, a metal oxide particle, a clay particle, a metal particle, wood dust, a cement particle, a salt particle, a ceramic particle, a sand particle, a mineral particle, or a polymer particle. In some embodiments the multifunctional microsphere has a core-shell-corona (CSC) structure. In some embodiments the multifunctional microsphere comprises a crosslinked polymer microsphere, e.g., as the core of a CSC structure. In some embodiments the multifunctional microsphere comprises a silicon dioxide microsphere, an aluminum(III) trioxide microsphere, or an iron(III) trioxide microsphere, e.g., as the core of a CSC structure.

In some embodiments of the third and fourth aspects, the at least one fluorinated group comprises 2-(perfluorooctyl)ethyl methacrylate (FOEMA), 2-(perfluorooctyl)ethyl acrylate (FOEA) or both. In some embodiments the at least one fluorinated group comprises 2-(perfluorohexyl)ethyl methacrylate, 2-(perfluorohexyl)ethyl acrylate or both. In some embodiments the at least one fluorinated group comprises fluorinated poly(alkyl acrylate), fluorinated poly(alkyl methacrylate), fluorinated poly(aryl acrylate), fluorinated poly(aryl methacrylate), fluorinated polystyrene, fluorinated poly(alkyl styrene), fluorinated poly(α-methyl styrene), fluorinated poly(alkyl α-methyl styrene), poly(tetrafluoroethylene), poly(hexafluoropropylene), fluorinated poly(alkyl acrylamide), fluorinated poly(vinyl alkyl ether), fluorinated poly(vinyl pyridine), fluorinated polyether, fluorinated polyester or fluorinated polyamide. In some embodiments the at least one reactive functional group comprises a hydroxyl group, an amino group, a carboxyl group, or an epoxy group. In some embodiments the polymer chain comprises at least one reactive functional group is poly(2-hydroxyethyl)methacrylate (PHEMA), polyacrylic acid (PAA), or 2-hydroxyethyl acrylate.

In some embodiments of the third and fourth aspects, the at least one reactive functional group is capable of bonding covalently with a polyurethane adhesive, an isocyanate adhesive, or an epoxy adhesive. In some embodiments the at least one reactive functional group is capable of bonding covalently with an adhesive selected from a polyurethane glue, a thermo-setting glue, a thermo-plastic glue, an epoxy resin, a polyurethane, a resorcinol-formaldehyde resin, a urea-formaldehyde resin, a rubber cement, a silicone resin, and a polymer adhesive.

In some embodiments of the third and fourth aspects, the at least one polymer chain, the first polymer chain, and/or the second polymer chain further comprises an end group at its terminus. In some embodiments the end group is fluorinated alkyl, CF₃(CF₂)₇CH₂CH₂, CF₃(CF₂)₅CH₂CH₂, C₈F₁₇(CH₂)₂—O—(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aliphatic (e.g., alkyl), ester, aldehyde, an adamantane group, a cyclodextrin group, an azobenzene group, Br, Cl, amino or carboxyl.

In some embodiments of the third and fourth aspects, the at least one polymer chain, the first polymer chain and/or the second polymer chain further comprises an anchoring monomer unit, wherein the anchoring monomer unit comprises a crosslinking group, a grafting group, and/or a sol-gel forming group, and said polymer chain is anchored to the surface of the microsphere via grafting, crosslinking or a combination thereof of the anchoring monomer unit to the surface of the microsphere. In some embodiments the anchoring monomer unit comprises a grafting unit capable of covalently grafting with the surface of the microsphere. In some embodiments the anchoring monomer unit comprises a sol-gel forming unit capable of undergoing inter-polymer crosslinking and covalently grafting with the surface of the microsphere. In some embodiments the anchoring monomer unit comprises a crosslinkable unit which is photocrosslinkable, crosslinkable by sol-gel formation, thermo crosslinkable, redox crosslinkable and/or UV-crosslinkable. In some embodiments the crosslinkable unit requires an additive for crosslinking.

In some embodiments of the third and fourth aspects, the multifunctional microsphere is nano-sized or micro-sized. In some embodiments the multifunctional microsphere comprises a bump or a lobe. In some embodiments the multifunctional microsphere is amphiphobic. In some embodiments the multifunctional microsphere is capable of forming an amphiphobic coating on a material surface.

In a fifth aspect of the invention there is provided a multifunctional microsphere comprising at least one first polymer chain having a first portion and a second portion, wherein the first portion is anchored to the surface of the multifunctional microsphere via grafting, crosslinking or a combination thereof, and the second portion has the structure of formula (X):

FLₓ-GL1_{100%-x}ₘE1 (X)

wherein FL is a fluorinated monomer unit; GL1 is a reactive functional group capable of forming a covalent bond with an adhesive; E1 is an optional end group; x is from 1% to 100%; and m is 1 or greater than 1.

In some embodiments, wherein when x is 100%, E1 is present and comprises a reactive functional group capable of forming a covalent bond with an adhesive. In some embodiments the multifunctional microsphere comprises a silica particle, a nanoparticle, a metal oxide particle, a clay particle, a metal particle, wood dust, a cement particle, a salt particle, a ceramic particle, a sand particle, a mineral particle, or a polymer particle. In some embodiments the multifunctional microsphere comprises a crosslinked polymer microsphere. In some embodiments the multifunctional microsphere comprises a silicon dioxide microsphere, an aluminum(III) trioxide microsphere, or an iron(III) trioxide microsphere. In some embodiments the multifunctional microsphere has a core-shell-corona (CSC) structure.

In some embodiments of the fifth aspect, the multifunctional microsphere further comprises at least one second polymer chain having a first portion and a second portion, wherein the first portion of the at least one second polymer chain is anchored to the surface of the multifunctional microsphere via grafting, crosslinking or a combination thereof, wherein the second portion of the at least one second polymer chain has the structure of formula (Xa):

GL2ₙE2 (Xa)

wherein GL2 is a reactive functional group capable of forming a covalent bond with an adhesive; GL1 and GL2 are the same or different; E2 is an optional end group; E1 and E2 are the same or different; and n is 0, 1 or greater than 1; wherein, when n is 0, E2 is present and E2 comprises a reactive functional group capable of forming a covalent bond with an adhesive.

In a sixth aspect of the invention there is provided a multifunctional microsphere comprising at least one first polymer chain having a first portion and a second portion, wherein the first portion is anchored to the surface of the multifunctional microsphere via grafting, crosslinking or a combination thereof, wherein the at least one first polymer chain has the structure of formula (XI):

A_{P}FLₓ-GL3_{100%-x}ₘE3 (XI)

wherein FL is a fluorinated monomer unit; GL3 is a reactive functional group capable of forming a covalent bond with an adhesive; E3 is an optional end group; x is from 1% to 100%; A represents the first portion of the at least one first polymer chain and is an anchoring monomer unit anchored to the surface of the multifunctional microsphere via grafting, crosslinking or a combination thereof; p is 1 or greater than 1; and m is 1 or greater than 1.

In some embodiments of the sixth aspect, wherein when x is 100%, E3 is present and comprises a reactive functional group capable of forming a covalent bond with an adhesive. In some embodiments the multifunctional microsphere further comprises at least one second polymer chain having a first portion and a second portion, the first portion of the at least one second polymer chain anchored to the surface of the multifunctional microsphere via grafting, crosslinking or a combination thereof, wherein the second portion of the at least one second polymer chain has the structure of formula (Xa) as defined above, wherein GL3 and GL2 are the same or different and E3 and E2 are the same or different.

In some embodiments the multifunctional microsphere comprises the at least one first polymer chain according to the fifth aspect of the invention, and at least one second polymer chain having a first portion and a second portion, wherein the first portion of the at least one second polymer chain is anchored to the surface of the multifunctional microsphere via grafting, crosslinking or a combination thereof, and wherein the at least one second polymer chain comprises:

a) a polymer chain having the structure of formula (XIa):

AₚFLₓ₂-GL3_{100%-x2}ₘE3 (XIa)

wherein FL2 is a fluorinated monomer unit; GL3 is a reactive functional group capable of forming a covalent bond with an adhesive; E3 is an optional end group; x2 is from 1% to 100%; A is an anchoring monomer unit anchored to the surface of the multifunctional microsphere via grafting, crosslinking or a combination thereof; p is 1 or greater than 1; and m is 1 or greater than 1; and/or

b) a polymer chain having the structure of formula (Xa):

GL2ₙE2 (Xa)

wherein GL2 is a reactive functional group capable of forming a covalent bond with an adhesive, E2 is an optional end group, and n is 0, 1 or greater than 1; wherein, when n is 0, E2 is present and comprises a reactive functional group capable of forming a covalent bond with an adhesive; and/or

c) a polymer chain which is poly(ethylene) glycol (PEG), poly(dialkyl siloxane), poly(alkyl methacrylate), or poly(alkyl acrylate);

wherein any of GL1, GL2, and GL3 are the same or different, FL and FL2 are the same or different, and any of E1, E2 and E3 are the same or different;

wherein at least one of FL and FL2 is present;

wherein, if at least one of GL1, GL2 or GL3 is not present, then at least one of E1, E2 or E3 is present and comprises a reactive functional group capable of forming a covalent bond with an adhesive.

In one embodiment of a multifunctional microsphere according to any one of the fifth and sixth aspects, the fluorinated monomer unit comprises FOEMA. In some embodiments the fluorinated monomer unit comprises 2-(perfluorooctyl)ethyl methacrylate (FOEMA), 2-(perfluorooctyl)ethyl acrylate (FOEA), 2-(perfluorohexyl)ethyl methacrylate, and/or 2-(perfluorohexyl)ethyl acrylate. In some embodiments the fluorinated monomer unit comprises fluorinated poly(alkyl acrylate), fluorinated poly(alkyl methacrylate), fluorinated poly(aryl acrylate), fluorinated poly(aryl methacrylate), fluorinated polystyrene, fluorinated poly(alkyl styrene), fluorinated poly(α-methyl styrene), fluorinated poly(alkyl α-methyl styrene), poly(tetrafluoroethylene), poly(hexafluoropropylene), fluorinated poly(alkyl acrylamide), fluorinated poly(vinyl alkyl ether), fluorinated poly(vinyl pyridine), fluorinated polyether, fluorinated polyester or fluorinated polyimide. In some embodiments the reactive functional group comprises a hydroxyl group, an amino group, a carboxyl group, or an epoxy group.

In some embodiments of the fifth and sixth aspects, the polymer chain comprising a reactive functional group is poly(2-hydroxyethyl)methacrylate (PHEMA), polyacrylic acid (PAA), or 2-hydroxyethyl acrylate. In some embodiments the reactive functional group is capable of bonding covalently with a polyurethane adhesive, an isocyanate adhesive, or an epoxy adhesive. In some embodiments the reactive functional group is capable of bonding covalently with an adhesive selected from a polyurethane glue, a thermo-setting glue, a thermo-plastic glue, an epoxy resin, a polyurethane, a resorcinol-formaldehyde resin, a urea-formaldehyde resin, a rubber cement, a silicone resin, and a polymer adhesive. In some embodiments the end group is fluorinated alkyl, CF₃(CF₂)ₙCH₂CH₂, CF₃(CF₂)₅CH₂CH₂, C₈F₁₇(CH₂)₂—O—(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aliphatic (e.g., alkyl), ester, aldehyde, an adamantane group, a cyclodextrin group, an azobenzene group, Br, Cl, amino or carboxyl.

In some embodiments of the sixth aspect, the anchoring monomer unit has the structure of formula (XII):

(X_{q}-G_{100%-q}) (XII)

wherein X denotes a monomer unit that can undergo inter-polymer crosslinking; G denotes a grafting unit grafted to the surface of the multifunctional microsphere; and q is from 0% to 100%. In some embodiments q is 100%. In some embodiments, q is 0%. In some embodiments G is maleic anhydride, glycidyl methacrylate or glycidyl acrylate. In some embodiments G is selected from the group consisting of anhydrides, acrylates, methacrylates, acid chlorides, glycidyl groups, silyl halide groups, triazole groups, epoxide groups, isocyanate groups and succinimide groups. In some embodiments G is selected from: (I) aldehyde and ketone-functional polymers such as polyacetal polymers, polyacrolein polymers, poly(methyl isopropenyl ketone) polymers, poly(vinyl methyl ketone) polymers, aldehyde-terminated poly(ethylene glycol) polymers, carbonylimidazole-activated polymers, and carbonyldiimidazole-terminated poly(ethylene glycol) polymers; (ii) carboxylic acid anhydride-functional polymers such as poly(acrylic anhydride) polymers, poly(alkalene oxide/maleic anhydride) copolymers, poly(azelaic anhydride) polymers, poly(butadienelmaleic anhydride) copolymers, poly(ethylene/maleic anhydride) copolymers, poly(maleic anhydride) polymers, poly(maleic anhydride/1-octadecene) copolymers, poly(vinyl methyl ether/maleic anhydride) copolymers, and poly(styrene/maleic anhydride) copolymers; (iii) carboxylic acid chloride-functional polymers such as poly(acrylolyl chloride) polymers and poly(methacryloyl chloride) polymers; and (iv) chlorinated polymers such as chlorine-terminated polydimethylsiloxane polymers, chlorinated polyethylene polymers, chlorinated polyisoprene polymers, chlorinated polypropylene polymers, poly(vinyl chloride) polymers, epoxy-terminated polymers, epoxide-terminated poly(ethylene glycol) polymers, isocyanate-terminated polymers, isocyanate-terminated poly(ethylene glycol) polymers, oxirane functional polymers, poly(glycidyl methacrylate) polymers, hydrazide-functional polymers, poly(acrylic hydrazide/methyl acrylate) copolymers, succinimidyl ester polymers, succinimidyl ester-terminated poly(ethylene glycol) polymers, tresylate-activated polymers, tresylate-terminated poly(ethylene glycol) polymers, vinyl sulfone-terminated polymers and vinyl sulfone-terminated poly(ethylene glycol) polymers.

In some embodiments of the sixth aspect, the anchoring monomer unit has the structure of formula (XIIa):

S^{I1}_{q}—S^{I2}_{100%-q} (XIIa)

wherein S^{I1} and S^{I2} denote different sol-gel forming monomer units, and q is from 0% to 100%.

In some embodiments S^{I1}_{q}—S^{I2}_{100%-q} has the following structure:

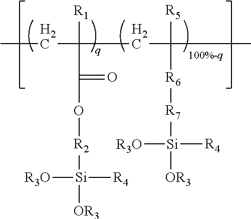

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring, or methylene; and q is 1% or greater than 1%.

In some embodiments of the sixth aspect, the anchoring monomer unit is a sol-gel forming monomer unit. In some embodiments the anchoring monomer unit has the structure shown in Formula (Id):

S^{I}ₖ—Xₗ (Id)

wherein S^{I} and X denote different monomer units that can undergo inter-polymer crosslinking, and S^{I} denotes a sol-gel forming monomer unit; l is 0, 1 or greater than 1; k is 0, 1 or greater than 1; and l and k are not both zero. In some embodiments 1<k<200. In some embodiments 1<l<200. In some embodiments p is 10, x is 10, or both p and x are 10.

In some embodiments of the sixth aspect, the anchoring monomer unit is anchored to the surface of the multifunctional microsphere via photocrosslinking, crosslinking by sol-gel formation, thermo crosslinking, redox crosslinking and/or UV-crosslinking. In some embodiments the S^{I} is a trialkoxysilane-containing unit, a dialkoxysilane-containing unit, or an IPSMA (3-(triisopropyloxysilyl)propyl methacrylate) unit. In some embodiments X is 2-cinnamoyloxyethyl methacrylate (CEMA) or 2-cinnamoyloxyethyl acrylate (CEA).

In some embodiments of the fifth and sixth aspects, the multifunctional microsphere comprises PIPSMA-b-PFOEMA, PCEMA-b-PFOEMA and/or PIPSMA-b-PCEMA-b-PFOEMA. In some embodiments the multifunctional microsphere comprises poly(3(triisopropyloxysilyl))propyl methacrylate-block-poly(heptadecaperfluorooctyl)ethyl methacrylate, wherein the number of repeat units of both monomers is 10.

In some embodiments of the third and fifth aspects, the multifunctional microsphere is a poly(meth)acrylate polymer microsphere having a surface grafted with a random copolymer of FOEMA and hydroxyethylmethacrylate (HEMA); a poly(meth)acrylate polymer microsphere having a surface grafted with 2-(perfluorooctyl)ethyl acrylate (FOEA) and polyacrylic acid (PAA); a silicon dioxide sphere having a surface grafted with a random copolymer of FOEMA and HEMA; a silicon dioxide sphere having a surface grafted with PFOEMA and PAA; a silicon dioxide sphere having a surface grafted with a random copolymer of PF8AEG and HEMA; or a silicon dioxide sphere having a surface grafted with poly PF8AEG and PAA.

In some embodiments of the fifth and sixth aspects, the multifunctional microsphere is nano-sized or micro-sized. In some embodiments multifunctional microsphere has a diameter of from about 350 nm to about 650 nm, or from about 50 nm to about 5000 nm, or from about 100 nm to about 1000 nm. In some embodiments the multifunctional microsphere comprises a bump or a lobe. In some embodiments the multifunctional microsphere is amphiphobic. In some embodiments the multifunctional microsphere is capable of forming an amphiphobic coating on a material surface.

In a seventh aspect of the invention there is provided an amphiphobic coating on a material surface comprising a multifunctional microsphere as described herein, optionally further comprising an adhesive that has formed a bond with the reactive functional group of the multifunctional microsphere.

In some embodiments the amphiphobic coating has a water contact angle that is greater than about 90°, about 100°, about 110°, about 120°, about 130°, about 140°, about 150°, about 160°, about 165°, about 170°, or about 175°, when measured at 18° C. to 23° C. In some embodiments the amphiphobic coating has an oil contact angle that is greater than about 90°, about 100°, about 110°, about 120°, about 130°, about 140°, about 150°, about 160°, about 165°, about 170°, or about 175°, when measured at 18° C. to 23° C. In some embodiments the amphiphobic coating has a thickness of about 1 to about 200 micrometers. In some embodiments the amphiphobic coating has anti-wetting properties, anti-icing properties, anti-chemical adhesion properties, anti-corrosion properties, anti-bacterial properties, anti-fingerprint marking properties, and/or self-cleaning properties. In some embodiments the amphiphobic coating is resistant to spills, stains, soiling, and/or etching. In some embodiments the amphiphobic coating retains amphiphobicity after about 20, about 30, about 40, about 50, about 60, about 100, about 200, or more cycles of washing. In some embodiments the amphiphobic coating is a powder coating.

In an eighth aspect of the invention there is provided an article coated with a multifunctional microsphere as described herein or an article comprising an amphiphobic coating as described herein.

In some embodiments the article is a metal plate, a metal sheet, a metal ribbon, a wire, a cable, a box, an insulator for electric equipment wires or cables, a roofing material, a shingle, insulation, a pipe, cardboard, glass shelving, glass plates, printing paper, metal adhesive tape, plastic adhesive tape, paper adhesive tape, or fiber glass adhesive tape.

In some embodiments the article is a canvas, a tablecloth, a napkin, a kitchen apron, a lab coat, an insignia, a tie, a sock, hosiery, underwear, a garment, a jacket, a coat, a shirt, a pair of pants, a bathing suit, a shoe, upholstery, a curtain, a drapery, a handkerchief, a flag, a parachute, a backpack, a bedding item, a bedsheet, a bedspread, a comforter, a blanket, a pillow, a pillow covering, a fabric for outdoor furniture, a tent, car upholstery, a floor covering, a carpet, an area rug, a throw rug, or a mat.

In some embodiments the article's breathability, flexibility, softness, feel and/or hand is substantially the same as that of an uncoated article. In some embodiments the article has improved cleanability, durability, resistance to soiling and/or resistance to stains, compared to an uncoated article.

In a ninth aspect of the invention there is provided a composition for applying an amphiphobic coating to a material surface comprising a multifunctional microsphere as described herein and a solvent, and optionally a plasticizer and/or another additive.

In some embodiments the solvent is an organic solvent. In some embodiments the solvent is trifluorotoluene (TFT) or tetrahydrofuran (THF). In some embodiments the solvent is an alkane, an alkene, an aromatic, an alcohol, an ether, a ketone, an ester, a halogenated alkane, a halogenated alkene, a halogenated aromatic, a halogenated alcohol, a halogenated ether, a halogenated ketone, a halogenated ester, or a combination thereof. In some embodiments the solvent is an aqueous solvent. In some embodiments the solvent is water.

In some embodiments the composition comprises a plasticizer. In some embodiments the composition comprises a coloring agent. In some embodiments the composition is a water-based paint, an oil-based paint, a varnish, a finish, a resin, a polish, a paste, a wax or a gel. In some embodiments the plasticizer is not water soluble and the composition is in an aqueous solution.

In some embodiments of the composition, the multifunctional microsphere comprises about 0.1% to about 5%, about 1% to about 15%, about 1% to about 30%, about 5% to about 30%, about 10% to about 30%, about 15% to about 25%, about 15% to about 20%, about 10 wt % to about 95 wt %, about 40 wt % to about 95 wt %, about 50 wt % to about 80 wt %, about 60 wt % to about 80 wt %, about 70 wt % to about 80 wt %, about 40 wt % to 80 wt %, about 50 wt % to about 70 wt %, about 90 to about 100%, or about 100% of the composition on a weight basis.

In a tenth aspect of the invention there is provided a kit comprising a composition as described herein and instructions for use thereof to apply an amphiphobic coating to a material surface. In some embodiments the kit comprises a composition as described herein and an adhesive, or one or more adhesive precursors or components.

In an eleventh aspect of the invention there is provided a fabric, fiber or textile comprising an amphiphobic coating as described herein. In some embodiments the fabric, fiber or textile is superhydrophobic and/or superoleophobic. In some embodiments the fabric, fiber or textile has improved resistance to soiling, improved resistance to stains, improved cleanability, improved alkaline resistance, improved acid resistance, and/or improved durability, compared to an uncoated fabric, fiber or textile. In some embodiments the fabric, fiber or textile's breathability, flexibility, softness, feel, and/or hand is substantially the same as that of an uncoated fabric, fiber or textile.

In a twelfth aspect of the invention there is provided an article comprising a fabric, fiber or textile as described herein. In some embodiments the article is a canvas, a tablecloth, a napkin, a kitchen apron, a lab coat, an insignia, a tie, a sock, hosiery, underwear, a garment, a jacket, a coat, a shirt, a pair of pants, a bathing suit, a shoe, upholstery, a curtain, a drapery, a handkerchief, a flag, a parachute, a backpack, a bedding item, a bedsheet, a bedspread, a comforter, a blanket, a pillow, a pillow covering, a fabric for outdoor furniture, a tent, car upholstery, a floor covering, a carpet, an area rug, a throw rug, or a mat. In some embodiments of the fabric, fiber or textile described herein or the article described herein, the fabric, fiber or textile or the article retains amphiphobicity after 30 or more or 100 or more cycles of washing. In some embodiments the fabric, fiber, or textile or article repels oil or grease; resists soiling; resists wrinkling; has increased durability to dry cleaning and laundering compared to an uncoated fabric, fiber or textile or article; requires less cleaning than an uncoated fabric, fiber or textile or article; and/or dries faster than an uncoated fabric, fiber or textile or article. In some embodiments the fabric, fiber or textile or article is or comprises cotton, wool, polyester, linen, ramie, acetate, rayon, nylon, silk, jute, velvet, army fabric or vinyl.

In a thirteenth aspect of the invention there is provided a paint comprising a multifunctional microsphere as described herein or a composition as described herein. In some embodiments the paint is latex-based, water-based, or alcohol-based. In some embodiments the paint is oil-based.

In a fourteenth aspect of the invention there is provided a method for preparing an amphiphobic coating on a material surface, comprising:

(a) optionally pretreating a material surface by washing and cleaning the material surface to remove contaminants (e.g., oil contaminants);

(b) coating the material surface with an adhesive or a precursor or first component of an adhesive, and optionally curing the adhesive;

(c) dispersing the multifunctional microsphere of any one of claims 1 to 70 into a solvent, optionally in the presence of a plasticizer and/or a different additive, to obtain a solution of multifunctional microspheres;

(d) applying the solution of multifunctional microspheres, and optionally a second component of the adhesive, to the adhesive or the precursor or first component of the adhesive on the material surface; and

(e) curing the solution plus the adhesive, so that an amphiphobic coating is prepared on the material surface.

In some embodiments of the method, the solvent is an organic solvent. In some embodiments the organic solvent is an alkane, an alkene, an aromatic, an alcohol, an ether, a ketone, an ester, a halogenated alkane, a halogenated alkene, a halogenated aromatic, a halogenated alcohol, a halogenated ether, a halogenated ketone, a halogenated ester, or a combination thereof. In some embodiments the organic solvent is trifluorotoluene (TFT), tetrahydrofuran (TI-IF), methanol or perfluorinated cyclohexane. In some embodiments the organic solvent is α,α,α-trifluorotoluene.

In some embodiments of the method, the adhesive is cured at room temperature. In some embodiments the adhesive is cured by heating. In some embodiments the adhesive is cured at room temperature for about 10 to about 40 minutes, or until fully cured. In some embodiments the adhesive is an epoxy resin adhesive, a polyurethane adhesive, or an isocyanate adhesive.

In some embodiments of the method, in step (d), the solution of multifunctional microspheres is applied to the surface of the adhesive by spray coating or spin coating. In other embodiments, in step (d), the solution of multifunctional microspheres is applied to the surface of the adhesive by spraying, brushing, painting, printing, stamping, rolling, dipping, spin-coating or electrostatic spraying, or wherein the material surface is dipped or soaked in the solution of multifunctional microspheres.

In some embodiments of the method, the concentration of the solution of multifunctional microspheres is about 2 mg/mL, about 3 mg/mL, about 5 mg/mL, about 10 mg/mL, about 50 mg/mL, about 100 mg/mL, about 250 mg/mL, about 500 mg/mL, or about 5 mg/mL to about 500 mg/mL. In some embodiments the material surface is metal, ceramic, glass, masonry, stone, wood, wood composite, wood laminate, cardboard, paper, printing paper, plastic, rubber, steel or cement. In some embodiments the material surface is a fabric, fiber or textile.

In some embodiments of the method, the multifunctional microsphere is dispersed in part (c) in the presence of a plasticizer. In some embodiments the plasticizer is dimethyl phthalate.

In some embodiments of the method, the multifunctional microsphere is dispersed in part (c) in the presence of a different additive. In some embodiments the additive is a thermo-initiator, a photo-initiator, a fluorinated initiator, a dihalogenated hydrocarbon, a diamine, a UV-absorber, a softener, a surfactant, an acid, a base or an anti-static compound.

In some embodiments of the method, in step (c), the multifunctional microsphere is dispersed in the presence of a polymer glue or a polymer binder.

In a fifteenth aspect of the invention there is provided a method for preparing an amphiphobic coating on a material surface, comprising:

(a) dispersing a multifunctional microsphere as described herein into a solvent, optionally in the presence of a plasticizer and/or a different additive, to obtain a solution of multifunctional microspheres;

(b) applying the solution of multifunctional microspheres to the material surface; and

(c) curing the solution, such that an amphiphobic coating is prepared on the material surface.

In a sixteenth aspect of the invention there is provided a method for preparing an amphiphobic coating on a material surface, comprising:

(a) optionally pretreating the material surface by washing and cleaning the material surface at room temperature to remove contaminants;

(b) optionally coating the material surface with an adhesive, and curing the adhesive;

(c) spraying a preparation comprising the multifunctional microsphere of any one of claims 1 to 70 onto the material surface, wherein the preparation is in solid form; and

(d) curing the sprayed preparation, such that an amphiphobic coating is prepared on the material surface.

In some embodiments of the sixteenth aspect, in (d), the sprayed preparation is cured by heating.

In some embodiments of the fifteenth and sixteenth aspects, the preparation is a dry powder.

In a seventeenth aspect of the invention there is provided a method for preparing a multifunctional microsphere as described herein, comprising the steps of:

(a) anchoring at least one chain initiator monomer onto a microsphere via crosslinking and/or grafting, wherein the at least one chain initiator monomer comprises: (i) a polymerizing unit that crosslinks around the microsphere and/or a grafting unit that grafts onto the microsphere; and (ii) an chain initiating moiety; and

(b) polymerizing additional monomers onto the crosslinked and/or grafted at least one chain initiator monomer obtained in (a), wherein the additional monomers comprise at least: (i) fluorinated monomers; and (ii) reactive functional group-containing monomers capable of bonding covalently with an adhesive, such that the multifunctional microsphere is prepared.

In some embodiments of the seventeenth aspect, the additional monomers are polymerized onto the crosslinked and/or grafted at least one chain initiator monomer via copolymerization of fluorinated monomers and reactive functional group-containing monomers. In some embodiments the additional monomers are polymerized onto the crosslinked and/or grafted at least one chain initiator monomer via derivatization of a polymer chain comprising at least one fluorinated monomer and at least one reactive functional group. In some embodiments the additional monomers are polymerized onto the crosslinked and/or grafted at least one chain initiator monomer via derivatization of at least one first polymer chain comprising at least one fluorinated monomer and at least one second polymer chain comprising at least one reactive functional group.

In an eighteenth aspect of the invention there is provided a method for preparing a multifunctional microsphere as described herein, comprising the steps of:

(a) preparing the at least one polymer chain or the at least two polymer chains; and

(b) anchoring the at least one polymer chain or the at least two polymer chains onto the surface of a microsphere via crosslinking and/or grafting.

In some embodiments of the eighteenth aspect, a mixture of two polymer chains is anchored to the microsphere in (b), and a bifunctional microsphere is prepared. In some embodiments a mixture of three polymer chains is anchored to the microsphere in (b), and a trifunctional microsphere is prepared.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 shows a schematic diagram of an approach for core-shell-corona (CSC) microsphere preparation (A). A schematic diagram of an approach for simultaneous coating of silica particles by two diblock copolymers is shown in (B). Only halves of spheres are shown to reveal internal structures of the spheres.

FIG. 2 shows a nuclear magnetic resonance spectrum of fluorinated polymer spheres.

FIG. 3 shows AFM 3-D topography images of C (a) and CS (b) particles that were prepared by emulsion polymerization and sprayed on mica surfaces.

FIG. 4 shows a TEM image of CS particles stained with CF₃SO₃Ag and sprayed from methanol. HEA-Cl in the outer layer reacted with CF₃SO₃Ag to produce AgCl.

FIG. 5 shows AFM 3-D topography images of CSC-1 (a), CSC-2 (b), CSC-3 (c) and CSC-3F (d) particles that were sprayed on mica surfaces.

FIG. 6 shows a schematic illustration of bump (above) and lobe (bottom) formation from less polydisperse and more polydisperse surface chains.

FIG. 7 shows a ¹H NMR spectrum of CSC-3F particles in trifluorotoluene and CDCl₃ at v/v=3/1.

FIG. 8 shows XPS spectra of CSC-3 particles before fluorination (bottom spectrum) and of CSC-3F particles obtained after fluorination (top spectrum).

FIG. 9 shows photographs of water (A and B) and diiodomethane droplets (C and D) on films made of CSC-3 particles (A and C) and CSC-3F particles (B and D).

FIG. 10 shows AFM topography images of trifluorotoluene-extracted CSC-2F/epoxy glue (left) and CSC-2F/PCEMA (right) composite coatings.

FIG. 11 shows an SEC trace for PIPSMA-b-PtBA.

FIG. 12 shows an ¹H NMR spectrum and peak assignments for PIPSMA-b-PtBA.

FIG. 13 shows AFM height (a) and phase (b) images of bare silica particles.

FIG. 14 shows variation in the dynamic light scattering (DLS) dₕ values of uncoated silica particles and of silica particles coated at f₁=50% as a function sin²(θ/2). The solvents used for the uncoated and coated samples were methanol and trifluorotoluene, respectively.

FIG. 15 shows a comparison of TGA curves (a) of silica particles, sol-gelled P1, sol-gelled P2, and silica particles coated by P1 and P2 at f₁=50%. In part (b), differential TGA curves of silica particles coated by P1, P2, and a mixture of P1 and P2 at f₁=50% are compared.

FIG. 16 shows variation in the determined grafted P1 (▪) and P2 (•) weight fractions in coated silica samples as a function of P1 feed weight ratio f₁. Dark lines show the best fits to the experimental data, and gray lines show how the amounts of grafted P1 and P2 would change with f₁ if they were quantitatively grafted.

FIG. 17 shows AFM topography (a) and phase (b) images of silica particles coated at f₁=50% and sprayed from C₇H₅F₃.

FIG. 18 shows AFM height images of silica particles that were coated at f₁=25% (a), f₁=50% (b), and f₁=0% (c), and cast from methanol. Also shown is an AFM image of a silica sample coated at f₁=50% and cast from C₇F₁₄ (d).

FIG. 19 shows an XPS spectrum of silica coated at f₁=50% and cast from C₇F₃H₅.

FIG. 20 shows photographs of water (a) and diiodomethane (b-d) droplets on films of silica particles coated at f₁=75%. The casting solvents for the particulate films were CH₃OH (a and b), C₇F₃H₅ (c), and C₇F₁₄ (d).

FIG. 21 shows a plot of variation in the H₂O (a) and CH₂I₂ (b) droplet contact angles on silica particulate films with various particle coating f₁ values and spraying solvents, as indicated.

FIG. 22 shows a comparison of XPS spectra of silica coated at f₁=50% and cast from C₇F₃H₅, C₇F₁₄, and CH₃OH.

FIG. 23 shows FTIR spectra of PtBA and PFOEMA chain-bearing silica particles before and after treatment with (CH₃)₃SiI and methanol. (CH₃)₃SiI and methanol treatment hydrolyzes PtBA to PAA.

FIG. 24 shows AFM height images of silica particles coated at f₁=50% (a) and 90% (b) after PtBA hydrolysis. Particles were sprayed from methanol.

FIG. 25 shows contact angles of water on PAA-bearing particulate film under indicated feeding weight ratios of P2:P1, at the indicated stages.

FIG. 26 shows SEM images of an epoxy film (a) and a film topped with PAA-bearing silica particles coated at f₁=80%.

FIG. 27 shows contact angles of water on bi-functional particle-coated epoxy film, before and after extraction with TFT for 3 d.

FIG. 28 shows SEM images of epoxy glue films coated with bi-functional silica particles after extraction with TFT for three days. Feeding weight ratios of f₁ were 80%, 98% and 100% in images a, b and c, respectively.

FIG. 29 shows SEM images of epoxy glue films coated with bi-functional silica particles after a vortex test for 30 min. Feeding weight ratios (f₁) were 80%, 98% and 100% in images a, b and c, respectively.

FIG. 30 shows contact angles of water on bi-functional silica particles after different amounts of vortex time. Feeding weight ratios (f₁) were 80%, 98% and 100%, as indicated.

FIG. 31 shows four exemplary types of multifunctional microspheres provided according to the invention.

### DETAILED DESCRIPTION OF THE INVENTION

We report herein the preparation and use of multifunctional microspheres comprising polymer chains that possess surface fluorinated groups and surface reactive functional groups capable of forming a covalent bond with an adhesive. Reactive functional groups, e.g., hydroxyl groups, bond covalently with adhesives, e.g., polyurethane or epoxy glues. Multifunctional microspheres provided herein form amphiphobic and durable coatings on a wide range of material surfaces. We also report herein amphiphobic coatings comprising such multifunctional microspheres and an adhesive which is bonded to the multifunctional microspheres.

Multifunctional microspheres are microspheres that bear more than one type of functionality on their surface. In many embodiments, multifunctional microspheres are bi-functional microspheres, i.e., microspheres bearing two types of functionality on their surface. In some embodiments, multifunctional microspheres are tri-functional microspheres, i.e., microspheres bearing three types of functionality on their surface. Functionalities can be provided by, e.g., small molecules or polymers. Microspheres or particles can be, e.g., spherical, cylindrical, or other shapes.

In general, multifunctional microspheres of the invention bear at least two functionalities: fluorinated groups for providing amphiphobic properties, and reactive functional groups for covalent bonding to an adhesive. Other functionalities may be included, such as, for example, anchoring groups for anchoring polymer chains to microspheres (e.g., crosslinking groups, grafting groups, sol-gel forming groups), bio-conjugating groups (e.g., carboxyl groups, amino groups), protein-repelling groups (e.g., poly(ethylene glycol) (PEG)), and softeners (e.g., poly(dialkyl siloxanes), poly(alkyl methacrylate), poly(alkyl acrylate)). A softener (see U.S. Pat. No. 6,380,336) is a polymer that is typically rubbery and has a low glass transition temperature. Poly(alkyl methacrylates) and poly(alkyl acrylates) with long (>6 C) alkyl groups are examples. It should be understood that the distribution of functionalities on multifunctional microspheres will vary depending on several factors, such as, e.g., how the multifunctional microspheres are made, intended use, polymer chains used, etc. For example, in some embodiments, two or more functionalities are included on one type of polymer chain extending from the surface of a multifunctional microsphere. In some embodiments, two or more different types of polymer chains extend from the surface of a multifunctional microsphere, each polymer chain bearing one or more particular functionalities.

In an embodiment, a multifunctional microsphere bears two polymer chains extending from its surface, one polymer chain comprising at least one fluorinated monomer unit, and the other polymer chain comprising at least one reactive functional group. In another embodiment, a multifunctional microsphere bears two polymer chains extending from its surface, one polymer chain comprising at least one fluorinated monomer unit and at least one reactive functional group, and the second polymer chain comprising at least one reactive functional group. In an embodiment, a multifunctional microsphere bears three polymer chains extending from its surface, one polymer chain comprising at least one fluorinated monomer unit, the second polymer chain comprising at least one reactive functional group, and the third polymer chain comprising at least one additional functional group.

It should be understood that polymer chains described herein comprise two portions, a first portion anchored to the surface of the multifunctional microsphere via grafting, crosslinking or a combination thereof, and a second portion comprising a functionality, e.g., a fluorinated group, a reactive functional group capable of forming a covalent bond with an adhesive, and/or an additional functionality. Generally, the first portion of a polymer chain serves to anchor the polymer chain to the surface of the multifunctional microsphere, e.g., to the core of the microsphere, while the second portion provides desired functionalities, such as fluorinated groups for providing amphiphobic properties, and/or reactive functional groups for covalent bonding to an adhesive.

In an embodiment, a multifunctional microsphere comprises at least one polymer chain having a first portion and a second portion, wherein the first portion is anchored to the surface of the multifunctional microsphere via grafting, crosslinking or a combination thereof, and the second portion comprises at least one fluorinated group and at least one reactive functional group capable of forming a covalent bond with an adhesive.

In another embodiment, a multifunctional microsphere comprises a first polymer chain and a second polymer chain, each of said polymer chains having a first portion and a second portion, wherein the first portion of each polymer chain is anchored to the surface of the multifunctional microsphere via grafting, crosslinking or a combination thereof, and wherein the second portion of the first polymer chain comprises at least one fluorinated group, and the second portion of the second polymer chain comprises at least one reactive functional group capable of forming a covalent bond with an adhesive; the multifunctional microsphere optionally comprising additional polymer chains, each additional polymer chain having a first portion and a second portion, wherein the first portion is anchored to the surface of the multifunctional microsphere via grafting, crosslinking or a combination thereof, and the second portion bears a functionality. In an embodiment, the first polymer chain further comprises at least one reactive functional group capable of forming a covalent bond with an adhesive.

In an embodiment, multifunctional microspheres bear polymer chains extending from their surfaces, wherein the polymer chains comprise at least one fluorinated monomer unit and at least one reactive functional group. In another embodiment, multifunctional microspheres bear more than one type of polymer chain extending from their surfaces, e.g., polymer chains comprising at least one fluorinated monomer unit, and polymer chains comprising at least one reactive functional group capable of binding to an adhesive, optionally with additional polymer chains comprising at least one additional functionality (e.g., poly(ethylene glycol) polymer chains, poly(dimethyl siloxane) polymer chains, poly(alkyl acrylate) chains). It should be understood that many different combinations of polymer chains bearing one or more functionalities are possible and are encompassed by the multifunctional microspheres provided herein.

Multifunctional microspheres provided herein can be produced using a variety of approaches. In an embodiment, a copolymer bearing two or more types of functional groups is grafted onto particles. In another embodiment, particles that bear two or more types of coronal polymer chains are produced. In this case, the particles, depending on their surface chain distribution, can be further divided into, e.g., Janus particles, patched particles, and normal multi- or bi-functional particles. In a Janus particle, two types of functionalities occupy opposite sides of a spherical particle. In a patched particle, one type of functional polymer chain forms patched domains surrounded by the other type of functional polymer chain. In a normal multi-functional particle, two or more types of polymer chains are uniformly distributed. In a normal bi-functional particle, two types of polymer chains are uniformly distributed. In an embodiment, a multifunctional particle comprises two or more types of polymer chains which are randomly distributed on the particle surface.

Multifunctional microspheres provided herein, e.g., microspheres decorated by one or more, or two or more, surface polymers, may have many applications. Particles covered by a fluorinated polymer with a low surface energy are generally highly oil and water repellent, but do not adhere well to each other or to any surface, leading to difficulty in producing durable amphiphobic coatings. We report herein that this difficulty in achieving durable amphiphobic coatings can be overcome by using particles bearing two or more functionalities. In general, fluorinated polymer chains provide water and oil repellency, while surface reactive functional groups provide, for example, adhesion via bond formation with an adhesive, e.g., a glue, that binds to a material surface.

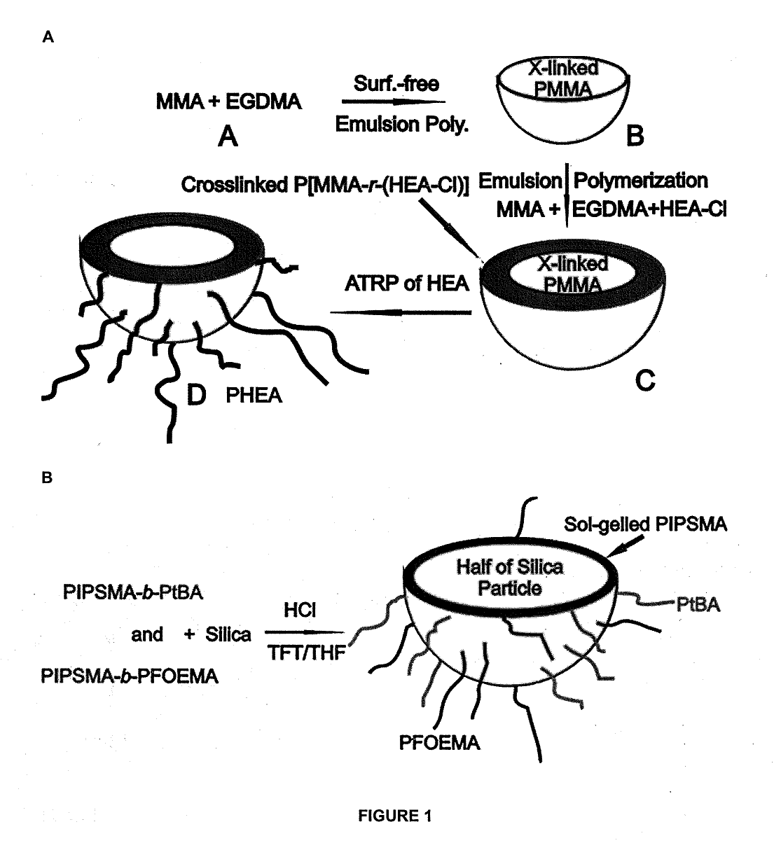

In an embodiment, there are provided herein multifunctional particles, e.g., silica particles, decorated by at least two types of polymer chains, e.g., at least a first polymer chain and a second polymer chain. In one example, particles were obtained from simultaneous coating of silica particles by two diblock copolymers, PIPSMA-b-PFOEMA (P1) and PIPSMA-b-PtBA (P2), where PIPSMA, PFOEMA, and PtBA denote poly[3-(triisopropyloxysilyl)propyl methacrylate], poly(perfluorooctylethyl methacrylate), and poly(tert-butyl acrylate), respectively. (In certain notation, PFOEMA is written as PF₈AEG or as PF₈H₂MA.) Diblock copolymers have been used to coat silica particles previously, forming a unimolecular diblock copolymer layer known as a brush layer (Milner, S. T., Science, 1991, 251, 905-914; Ding, J. F. et al., Macromolecules, 1996, 29, 5398-5405; Tao, J. et al., Macromolecules, 1998, 31, 172-175; Parsonage, E. et al., Macromolecules, 1991, 24, 1987-1995). Here, we report use of an advantageous chemical “graft to” method to prepare particles bearing different polymer chains. In the approach depicted in FIG. 1B, two diblock copolymers are simultaneously grafted to a particle to yield a particle bearing two types of polymer chains, i.e., a bifunctional microsphere. It is also possible to attach triblock copolymers via grafting, crosslinking or a combination of grafting and crosslinking of the middle block onto or around the particle, leaving terminal blocks exposed on the surface of the particle. In an embodiment, bi-functional particles, e.g., bi-functional silica particles, formed from two diblock copolymers are provided. In an embodiment, tri-functional particles, e.g., tri-functional silica particles, bearing surface poly(acrylic acid), PEG, and fluorinated chains are provided. In some embodiments, multifunctional particles bear softener polymer chains.

FIG. 1 shows schematic diagrams illustrating exemplary approaches to preparation of particles with multifunctional, e.g., bi-functional surfaces. The general approaches are denoted herein as “graft from” method and “graft to” method. For example, in an embodiment, the diblock copolymers poly[3-(triisopropyloxysilyl)propyl methacrylate]-blockpoly[2-(perfluorooctyl)ethyl methacrylate] (also called PIPSMA-b-PFOEMA or P1), and poly[3-(triisopropyloxysilyl)propyl methacrylate]-block-poly(tert-butyl acrylate) (also called PIPSMA-b-PtBA or P2), are used. In an example of the “graft to” method (FIG. 1B), under acidic conditions, the PIPSMA blocks of the two copolymers co-condensed via sol-gel reactions. These reactions yielded silica particles with a mixed monolayer of P1 and P2 on their surfaces. The relative amounts of the two polymers grafted in this monolayer depended on the feed ratio of the polymers used. The chemical structures of PIPSMA-b-PFOEMA (top), PIPSPMA-b-PtBA (middle), and PEG (bottom) are shown here:

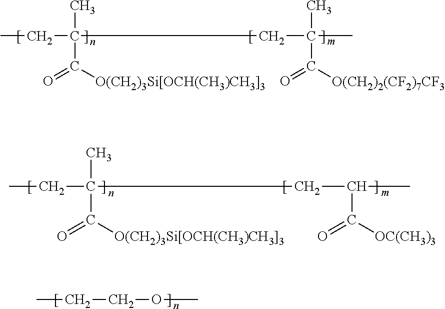

wherein m and n are 1 or greater than 1.

In this example, after preparation of the silica particles, the tBA units of P2 were hydrolyzed to poly(acrylic acid) or PAA chains, yielding bi-functional particles bearing PAA and PFOEMA chains. The grafting of only 5 wt % of P2 relative to P1 and the subsequent hydrolysis of the tBA units yielded sufficient carboxyl groups to allow these particles to be incorporated covalently into epoxy films. These resultant films were mechanically robust and wear resistant and also amphiphobic.

In an embodiment, bi-functional particles, e.g., bi-functional silica particles, formed from two diblock copolymers are provided, wherein the diblock copolymers poly[3-(triisopropyloxysilyl)propyl methacrylate]-block-poly[2-(perfluorohexyl)ethyl methacrylate], are used.

In another embodiment, a diblock copolymer PEG-b-PIPSMA (or P3) is made and used to form multifunctional particles. For example, the PIPSMA blocks of P1, P2, and P3 are co-condensed to yield mixed P1, P2, and P3 monolayers on particle, e.g., silica particle, substrates. After PtBA hydrolysis to PAA, tri-functional microspheres are obtained which can be used to prepare rugged and robust films, e.g., particulate films, attached to an epoxy resin layer.

In general, the “graft to” method employs the following:
1) A particle or sphere.
   In some embodiments, the particle can be a crosslinked polymer sphere, a silica particle, a titania particle, an alumina particle, sand, a clay particle, wood dust, or any of the other particles described elsewhere herein.
2) Block copolymer or different block copolymers.
   In an embodiment where only one block copolymer is used, it can have the following structure:

Aₚ-(FLₓ-GL_{y}-SG_{100%-x-y})ₘ-E
where A is an anchoring group capable of grafting, crosslinking or both grafting and crosslinking; FL is a fluorinated monomer unit, GL is a reactive functional group capable of forming a covalent bond with an adhesive; SG is an optional group with a desired functionality or use (e.g., a PEG-bearing unit, a softener-bearing unit, an extender unit); E is an optional end group, p is 1 or greater than 1, and m is 1 or greater than 1. In an embodiment where E is not itself a reactive group or a fluorinated group, then x and y are both larger than >1%. 100%−x−y can be 0% or larger than 0% depending on whether the multifunctional spheres are bi-functional or tri-functional. For bi-functional sphere, 100%−x−y=0%. For a tri-functional sphere, 100%−x−y>0%.
In an embodiment where different block copolymers are used, they can have structures such as

AₚFL2ₓ₂-GL3_{100%-x2}ₘE3

or Aₚ-(GL₂)ₙ-E2.
In another embodiment, triblock copolymers are grafted to and/or crosslinked around particles to yield multifunctional microspheres. In this embodiment, the middle block can graft to and/or crosslink around the particle. In an embodiment, the triblock copolymer can have the following structure:

GLₘ-Aₚ-FLₙ-E
where GL, A, FL, E, p, and m have the values set forth above, and where n is 1 or greater than 1. If E is a reactive functional group capable of forming a covalent bond with an adhesive, the GL block can be omitted.
3) Grafting of the block copolymer(s) to particle surfaces via the anchoring group A.

FIG. 1A depicts a “graft from” approach to preparation of multifunctional microspheres. Particles having a core-shell-corona (CSC) structure are shown. A core emerged from surfactant-free emulsion polymerization of a monomer methyl methacrylate (MMA) and a crosslinker ethylene glycol dimethacrylate (EGDMA) (FIG. 1A, A→B). A shell grew on the core from semi-continuous seeded emulsion polymerization of MMA, EGDMA, and HEA-Cl [2-(2′-chloropropionato)ethyl acrylate] (FIG. 1A, B→C). Incorporated HEA-Cl groups then initiated atom transfer radical polymerization (ATRP) of 2-hydroxyethyl acrylate (HEA) to spring up a PHEA corona (FIG. 1A, C→D). A bi-functional corona was obtained after reacting ˜80% of the PHEA hydroxyl groups with perfluorononanoyl chloride. This represents the first report of the use of emulsion polymerization, ATRP and surface functionalization in combination to prepare fluorinated particles.

In general, the “graft from” method employs the following:
1) A particle or sphere that is structurally stable and does not disintegrate during polymer grafting/crosslinking step.
   In an example provided herein, the particle was a crosslinked poly(methyl methacrylate) (PMMA) sphere. In some embodiments, the particle can be another crosslinked polymer sphere, a silica particle, a titania particle, an alumina particle, sand, a clay particle, wood dust, or any of the other particles described elsewhere herein.
2) Anchoring of at least one chain initiator monomer to the particle.
   In an embodiment, the at least one chain initiator monomer can be anchored onto the particle by crosslinking a polymerizing unit of the chain initiator monomer around the microsphere using a cross linker and/or by grafting a grafting unit of the Chain initiator monomer onto the microsphere. An example provided herein involved the crosslinking of 2-(2′-chloropropionato)ethyl acrylate (CH₂═CHCOO(CH₂)₂OOCCHClCH₃, HEA-Cl) with the help of ethylene glycol dimethacrylate (EGDMA) around a crosslinked PMMA particle.
   In an embodiment, at least one chain initiator monomer that has a grafting unit and a chain initiating moiety can be grafted onto the particle. An example is 2-bromopropionoyl bromide (CH₃CHBrCOBr). The propionyl bromide part or the COBr part of this molecule grafts to hydroxyl-bearing surfaces such as, for example, silica or alumina; and the bromopropinoyl part initiates chain polymerization.
   In an embodiment, at least one chain initiator monomer that has a sol-gel forming unit (i.e, can both crosslink and graft) and an initiating moiety can be anchored to the particle. An example is 2-(m,p-chloromethylphenyl)ethyltrichlorosilane (CH₂ClC6H₄CH₂CH₂SiCl₃). While the —SiCl₃ portion undergoes sal-gel chemistry and grafts and crosslinks around the particle, the CH₂Cl— part can initiate polymerization.
3) Multifunctional chain production using the anchored at least one chain initiator monomer.
   The anchored at least one chain initiator monomer is used to initiate polymerization or copolymerization. In an embodiment of copolymerization, fluorinated monomers, monomers comprising a reactive functional group capable of forming a covalent bond with an adhesive, and optionally other monomers (e.g., an alkyl acrylate softener, PEG) are polymerized in “one pot” by growing the polymer chains starting from the particle surface. In an embodiment, homopolymerization is provided. For example, a PHEA chain can be grown and then derivatized to make a bi- or tri-functional polymer sphere. In an example provided herein, we derivatized PHEA by labelling only 80% of the PHEA hydroxyl groups with perfluorononanoyl chloride to yield spheres bearing surface hydroxyl groups and fluorinated groups.

Methods provided herein for preparing multifunctional particles may have certain advantages. For example, in some embodiments it is possible to tune surface segregation patterns of the grafted polymer chains, based on the method of preparation used. In an embodiment, switchable wetting properties of films cast from dispersions of multifunctional particles can also be tuned based on the structure of the multifunctional particles and/or methods used for their preparation.

In an embodiment, there are provided herein particles, e.g., nano- or micro-sized particles, comprising both at least one fluorine group and at least one reactive functional group capable of forming a covalent bond with an adhesive, and applications thereof for preparing amphiphobic coatings on material surfaces. This represents the first report of nano- or micro-particles possessing a variety of functional groups and which can result in a coated material surface containing more than merely a fluorine-containing compound. Without wishing to be bound by theory, it is believed that additional reactive functional groups permit a reaction with a material surface, e.g., with adhesive on a material surface, to form covalently bonded groups, providing amphiphobic coatings which are durable.

In an embodiment, fluorine-containing bi-functional microspheres and applications thereof to provide amphiphobic coatings on material surfaces are provided herein. In another embodiment, fluorine-containing tri-functional microspheres and applications thereof to provide amphiphobic coatings on material surfaces are provided herein.

In an embodiment, there is provided herein a multifunctional microsphere comprising at least one polymer chain having a first portion and a second portion, wherein the first portion is anchored to the surface of the multifunctional microsphere via grafting, crosslinking or a combination thereof, and the second portion has the structure of formula (X):

FLₓ-GL1_{100%-x}ₘE1 (X)

wherein FL is a fluorinated monomer unit; GL1 is a reactive functional group capable of forming a covalent bond with an adhesive; E1 is an optional end group; x is from 1% to 100%; and m is 1 or greater than 1. In an embodiment, when x is 100%, E1 is present and comprises a reactive functional group capable of forming a covalent bond with an adhesive.

In an embodiment, a multifunctional microsphere further comprises at least one additional polymer chain (e.g., at least a second polymer chain) having a first portion and a second portion, the first portion of the at least one additional polymer chain anchored to the surface of the multifunctional microsphere via grafting, crosslinking or a combination thereof, wherein the second portion of the at least one additional polymer chain has the structure of formula (Xa):

GL2ₙE2 (Xa)

wherein GL2 is a reactive functional group capable of forming a covalent bond with an adhesive; GL1 and GL2 are the same or different; E2 is an optional end group; E1 and E2 are the same or different; and n is 0, 1 or greater than 1. In an embodiment, when n is 0, E2 is present and E2 comprises a reactive functional group capable of forming a covalent bond with an adhesive.

In an embodiment, there is provided a multifunctional microsphere having at least one first polymer chain having a first portion and a second portion, the first portion of the at least one first polymer chain anchored to the surface of the multifunctional microsphere via grafting, crosslinking or a combination thereof, wherein the at least one first polymer chain has the structure of formula (XI):

AₚFLₓ-GL3_{100%-x}ₘE3 (XI)

wherein, FL is a fluorinated monomer unit; GL3 is a reactive functional group capable of forming a covalent bond with an adhesive; E3 is an optional end group; x is from 1% to 100%; A is an anchoring monomer unit anchored to the surface of the multifunctional microsphere via grafting, crosslinking or a combination thereof; p is 1 or greater than 1; and m is 1 or greater than 1. Thus, A represents the first portion of the at least one polymer chain, and the rest of formula (XI) represents the second portion of the at least one polymer chain. In an embodiment, x is 100%, and E3 is present and comprises a reactive functional group capable of forming a covalent bond with an adhesive. In an embodiment, the multifunctional microsphere further comprises at least one second polymer chain having a first portion and a second portion, the first portion of the at least one second polymer chain anchored to the surface of the multifunctional microsphere via grafting, crosslinking or a combination thereof, wherein the second portion of the at least one second polymer chain has the structure of formula (Xa) as defined above, wherein GL3 and GL2 are the same or different and E3 and E2 are the same or different.

In an embodiment, there is provided herein a multifunctional microsphere comprising at least one polymer chain as set forth above, and at least one additional polymer chain having a first portion and a second portion, the first portion of the polymer chain anchored to the surface of the microsphere via grafting, crosslinking or a combination thereof, wherein the at least one additional polymer chain comprises:

a) a polymer chain having the structure of formula (X):

FLₓ-GL1_{100%-x}ₘE1 (X)

wherein FL is a fluorinated monomer unit; GL1 is a reactive functional group capable of forming a covalent bond with an adhesive; E1 is an optional end group; x is from 1% to 100%; m is 1 or greater than 1; and optionally wherein, when x is 100%, E1 is present and comprises a reactive functional group capable of forming a covalent bond with an adhesive; and/or
b) a polymer chain having the structure of formula (XIa):

AₚFL2ₓ₂-GL3_{100%-x2}ₘE3 (XIa)

wherein FL2 is a fluorinated monomer unit; GL3 is a reactive functional group capable of forming a covalent bond with an adhesive; E3 is an optional end group; x2 is from 1% to 100%; A is an anchoring monomer unit anchored to the surface of the multifunctional microsphere via grafting, crosslinking or a combination thereof; p is 1 or greater than 1; and m is 1 or greater than 1; and/or
c) a polymer chain having the structure of formula (Xa):

GL2ₙE2 (Xa)

wherein GL2 is a reactive functional group capable of forming a covalent bond with an adhesive, E2 is an optional end group, and n is 0, 1 or greater than 1; and optionally wherein, when n is 0, E2 is present and comprises a reactive functional group capable of forming a covalent bond with an adhesive; and/or
d) a polymer chain which is poly(ethylene) glycol (PEG);
wherein any of GL1, GL2, and GL3 are the same or different, FL and FL2 are the same or different, and any of E1, E2 and E3 are the same or different; wherein at least one of FL and FL2 is present; wherein, if at least one of GL1, GL2 or GL3 is not present, then at least one of E1, E2 or E3 is present and comprises a reactive functional group capable of forming a covalent bond with an adhesive.

Non-limiting examples of particles include silica particles, nanoparticles, metal oxide particles, titanium dioxide particles, clay particles, metal particles, wood dust, cement particles, salt particles, ceramic particles, sand particles, mineral particles, polymer particles and microspheres. In an embodiment, particles have a Core-Shell-Corona (CSC) structure. In an embodiment, a particle is a crosslinked polymer microsphere, a silicon dioxide microsphere, an aluminum(III) trioxide microsphere, or an iron(III) trioxide microsphere. In an embodiment, a particle is a crosslinked polymer microsphere, a silicon dioxide microsphere, an aluminum(III) trioxide microsphere, an iron(III) trioxide microsphere, a titanium dioxide microsphere or a clay particle.

The terms “particle” and “microsphere” are used interchangeably herein to refer to spheres, beads, cubes, and other three-dimensional structures of generally regular or irregular shape, and the like. Particles are generally commercially available, although modifications may be made before use. Particles may comprise a substrate of materials such as metals, metal oxides, such as iron oxide, inorganic oxides, silica, alumina, titania and zirconia, chemically bonded inorganic oxides, such as organosiloxane-bonded phases, hydrosilanization/hydrosilation bonded phases, polymer coated inorganic oxides or metal oxides, porous polymers, such as styrene-divinylbenzene copolymer, polyolefins, such as polyacrylates, polymethacrylates, and polystyrene. Particles may include, for example, octadecyl silane (ODS) particles, agarose beads, fluorinated beads, and silica based particles. Particles may be porous, mesoporous, or non-porous, or a combination. Porous or mesoporous particles may have pores of less than about 100 angstroms in diameter, in the range of about 100 to about 300 angstroms in diameter, or greater than about 300 angstroms in diameter, or a combination.

As used herein, the term “substrate” is generally used to refer to a particle or microsphere used to make a multifunctional microsphere of the invention. Substrate is also sometimes used to refer to the material(s) of which a particle or microsphere is composed. Accordingly, for clarity, “material surface” is the term generally used herein for a surface being coated, to distinguish from the general use herein of “substrate”.

Many types of particles are known in the art, and any particles suitable for use to make a multifunctional microsphere of the invention may be used. Particles may optionally bear substituents that confer desirable chemical properties to the particles so that, e.g., particles are suitable for use to make a multifunctional microsphere of the invention, particles produce multifunctional micropheres possessing desirable functionalities, particles provide coatings possessing desirable properties, etc. Substituents may include, e.g., ketone groups, aldehyde groups, carboxyl groups, such as carboxylic acid, ester, amide, and acid halide groups, chloromethyl groups, cyanuric groups, polyglutaraldehyde groups, epoxide groups, thiol groups, amine groups, silanol groups, hydroxyl groups, sulphonic acid groups, phosphonic acid groups, and/or unsubstituted or substituted aliphatic or aromatic hydrocarbons.

Particles may be modified chemically and/or physically in order to be suitable for use in a multifunctional microsphere. Particles may be used without modification if they already have chemical and/or physical properties desirable for use in a multifunctional microsphere. It will be understood that different properties may be demonstrated by the same particles in different conditions, such as different solvent conditions.

In certain embodiments, particle diameters are in the range of about 0.01 to about 100 micrometers, or in the range of about 0.05 to about 30 micrometers, or in the range of about 0.1 to about 10 micrometers. In some embodiments, particle diameters are about 100 nanometers.

In an embodiment, a fluorinated monomer unit (FL) is 2-(perfluorooctyl)ethyl methacrylate (FOEMA), also called (heptadecafluorooctyl)ethyl methacrylate. In another embodiment, FL is 2-(perfluorohexyl)ethyl methacrylate. In an embodiment, FL is 2-(perfluorooctyl)ethyl acrylate (FOEA). In another embodiment, FL is perfluorononanoyloxyethyl acrylate or PF8AEG.

In another embodiment, FL is fluorinated poly(alkyl acrylate) (for example, poly[2-(perfluorohexyl)ethyl acrylate]), fluorinated poly(alkyl methacrylate) (for example, poly[2-(perfluorohexyl)ethyl methacrylate]), fluorinated poly(aryl acrylate), fluorinated poly(aryl methacrylate), fluorinated polystyrene, fluorinated poly(alkyl styrene), fluorinated poly(α-methyl styrene), fluorinated poly(alkyl α-methyl styrene), poly(tetrafluoroethylene), poly(hexafluoropropylene), fluorinated poly(alkyl acrylamide), fluorinated poly(vinyl alkyl ether), fluorinated polyvinyl pyridine), fluorinated polyether, fluorinated polyester or fluorinated polyamide.

In one embodiment, when FL is fluorinated poly(alkyl acrylate) or fluorinated poly(alkyl methacrylate), the alkyl groups have the following structure: CF₃(CF₂)ₙCH₂CH₂—, where 0≦n≦20, 0≦n≦7 or 1≦n≦5. In another embodiment, the alkyl groups of FL have the structure: (CF₃)₂CF(CF₂)ₙCH₂CH₂—, where 0≦n≦20, 0≦n≦7 or 1≦n≦3.

In an embodiment, FL is a fluorinated monomer unit selected from the groups consisting of fluorinated acrylates, fluorinated diacrylates, fluorinated methacrylates, fluorinated dimethacrylates, fluorinated allyls, fluorinated vinyls, fluorinated maleates, and fluorinated itaconates.

In an embodiment, fluorinated polymer blocks in multifunctional microspheres of the invention comprise fluorinated polyacrylates. Fluorinated polyacrylates may comprise monomers such as, for example, fluorohexyl acrylate, fluoroaryl acrylate, 2-(perfluorooctyl)ethyl acrylate, heptafluorobutyl acrylate, 1H,1H,9H-hexadecafluorononyl acrylate, 2,2,3,4,4,4-hexafluorobutyl acrylate, hexafluoroisopropyl acrylate, 1H,1H,5H-octafluoropentyl acrylate, pentafluorobenzyl acrylate, pentafluorophenyl acrylate, perfluorocyclohexyl methyl acrylate, perfluoroheptoxypoly(propyloxy) acrylate, perfluorooctyl acrylate, 1H,1H-perfluorooctyl acrylate, 2,2,3,3-tetrafluoropropyl acrylate, 2,2,2-trifluoroethyl acrylate, 3-(trifluoromethyl)benzyl acrylate, 2-(N-butylperfluorooctanesulfamido) ethyl acrylate, 1H,1H,7H-dodecafluoroheptyl acrylate, 1H,1N,11H-eicosafluoroundecyl acrylate, trihydroperfluoroundecyl acrylate, trihydroperfluoroheptyl acrylate, and/or 2-(N-ethylperfluorooctane sulfamido) ethyl acrylate.

In another embodiment, fluorinated polymer blocks in multifunctional microspheres of the invention comprise fluorinated polymethacrylates. Fluorinated polymethacrylates may comprise monomers such as, for example, 2-(perfluoroodyl)ethyl methacrylate (FOEMA), fluorohexyl methacrylate, fluoroaryl methacrylate, 1H,1H,7H-dodecafluoroheptyl methacrylate, trihydroperfluoroheptyl methacrylate, trihydroperfluoroundecyl methacrylate, 2-(N-ethylperfluorooctane sulfamido) ethyl methacrylate, tetrahydroperfluorodecyl methacrylate, 1H,1H-heptafluoro-n-butyl methacrylate, 1H,1H,9H-hexadecafluorononyl methacrylate, 2,2,3,4,4,4-hexafluorobutyl methacrylate, hexafluoroisopropyl urethane of isocyanatoethyl methacrylate, 1H,1H,5H-octafluoropentyl methacrylate, pentafluorobenzyl methacrylate, pentafluorophenyl methacrylate, perfluorocyclohexylmethyl methacrylate, perfluoroheptoxypoly(propyloxy)methacrylate, 1H,1H-perfluorooctyl methacrylate, 2,2,3,3-tetrafluoropropyl methacrylate, 2,2,2-trifluoroethyl methacrylate, 3-(trifluoromethyl)benzyl methacrylate, and/or hexafluoroisopropyl methacrylate.

In another embodiment, fluorinated polymer blocks in multifunctional microspheres of the invention comprise fluorinated polydiacrylates. Fluorinated polydiacrylates may comprise monomers such as, for example, hexafluoro bisphenol diacrylate, 2,2,3,3,4,4,5,5-octafluoro-1,6-hexanediol diacrylate, polyperfluoroethylene glycol diacrylate, and/or 2,2,3,3-tetrafluoro-1,4-butanediol diacrylate.

In another embodiment, fluorinated polymer blocks in multifunctional microspheres of the invention comprise fluorinated polydimethacrylates. Fluorinated polydimethacrylates may comprise monomers such as, for example, hexafluoro bisphenol a dimethacrylate, 2,2,3,3,4,4,5,5-octafluoro-1,6-hexanediol dimethacrylate, perfluorocyclohexyl-1,4-dimethyl dimethacrylate, polyperfluoroethylene glycol dimethacrylate, and/or 2,2,3,3-tetrafluoro-1,4-butanediol dimethacrylate.

In another embodiment, fluorinated polymer blocks in multifunctional microspheres of the invention comprise fluorinated allyl polymer blocks. Fluorinated allyl polymer blocks may comprise monomers, such as, for example, allyl heptafluorobutyrate, allyl heptafluoroisopropyl ether, allyl 1H,1H-pentadecafluorooctyl ether, allylpentafluorobenzene, allyl perfluoroheptanoate, allyl perfluorononanoate, allyl perfluorooctanoate, allyl tetrafluoroethyl ether, and/or allyl trifluoroacetate.

In another embodiment, fluorinated polymer blocks in multifunctional microspheres of the invention comprise fluorinated itaconate polymer blocks. Fluorinated itaconate polymer blocks may comprise monomers such as, for example, bis(hexafluoroisopropyl) itaconate, bis(perfluorooctyl)itaconate, bis(trifluoroethyl) itaconate, mono-perfluorooctyl itaconate, trifluoroethyl acid itaconate, and/or hexafluoroisopropylitaconate.

In another embodiment, fluorinated polymer blocks in multifunctional microspheres of the invention comprise fluorinated maleate polymer blocks. Fluorinated maleate polymer blocks may comprise monomers such as, for example, bis(perfluorooctyl)maleate, bis(hexafluoroisopropyl) maleate, bis(2,2,2-trifluoroethyl) maleate, mono-hexafluoroisopropyl maleate, mono-perfluorooctyl maleate, and/or mono-trifluoroethyl acid maleate.

In another embodiment, fluorinated polymer blocks in multifunctional microspheres of the invention comprise fluorinated polystyrene blocks. Fluorinated polystyrene blocks may comprise monomers such as, for example, fluoroalkyl styrene, fluoro-(α-methyl styrene), fluoroalkyl-α-methyl styrene, m-fluorostyrene, o-fluorostyrene, p-fluorostyrene, and/or pentafluorostyrene.

In another embodiment, fluorinated polymer blocks in multifunctional microspheres of the invention comprise fluorinated polyvinyl blocks. Fluorinated polyvinyl blocks may comprise monomers such as, for example, 1-(trifluoromethyl) vinyl acetate, 4-vinylbenzyl hexafluoroisopropyl ether, 4-vinylbenzyl perfluorooctanoate, 4-vinylbenzyl trifluoroacetate, vinyl heptafluorobutyrate, vinyl perfluoroheptanoate, vinyl perfluorononanoate, vinyl perfluorooctanoate, and/or vinyl trifluoroacetate.

In an embodiment, FL is a fluorinated monomer unit selected from 1H,1H-heptafluorobutylmethacrylamide, 2-N-heptafluorobutyrylamino-4,6-dichlorotriazine, epifluorohydrin, perfluorocyclopentene, tridecafluoro-1,1,2,2-tetrahydrooctyl-1,1-methyl dimethoxy silane, and tridecafluoro-1,1,2,2-tetrahydrooctyl-1-dimethyl methoxy silane.

In some embodiments of multifunctional microspheres of the invention, a fluorinated monomer unit FL comprises alkyl groups as defined herein. For example, fluorinated monomer units may comprise one or more alkyl groups having C₅ to C₂₀ alkyl, C₅ to C₁₀ alkyl, C₅ to C₆ alkyl, C₅ to C₁₅ alkyl, C₈ to C₂₀ alkyl, C₅ alkyl, C₆ alkyl, C₇ alkyl, C₈ alkyl, C₉ alkyl, or C₁₀ alkyl. Such alkyl groups may be substituted or unsubstituted. One or more hydrogen atoms of an alkyl group may be replaced by halogen atoms, such as fluorine, bromine or chlorine atoms. Alkyl groups may be “fluoroalkyl” groups, i.e., alkyl groups in which some or all of the hydrogen atoms have been replaced by fluorine atoms, or “perfluoroalkyl” groups, i.e., alkyl groups in which fluorine atoms have been substituted for each hydrogen atom. In a particular embodiment, a fluorinated monomer unit FL comprises a C₆ alkyl. In another particular embodiment, a fluorinated monomer unit FL comprises a C₈ alkyl. It should be understood that, as used herein, “unsubstituted” refers to any open valence of an atom being occupied by hydrogen.

When GL1 and GL2 are both present, they may be the same or different. In an embodiment, GL1 and/or GL2 comprises a hydroxyl group, an amino group, a carboxyl group, or an epoxy group. Non-limiting examples of reactive functional groups include hydroxyl groups, hydroxide groups, alcohol groups, alkyl oxide groups, phenol groups, phenoxide groups, ketone groups, aldehyde groups, acid chloride groups, carboxyl groups, carboxylate groups, amino groups, imine groups, anhydride groups, alkyl anions, anhydride groups, azide groups, isocyanate groups, phosphate groups, epoxide groups, and thiol groups.

A reactive functional group is chosen by a skilled artisan based on several factors, such as adhesive being used, material surface to be coated, etc. It should be understood that certain reactive functional groups react preferentially with certain adhesives, and reactive functional groups and adhesives are chosen accordingly. For example, polyurethane glues generally contain isocyanate groups, which can react with a wide range of functional groups including, but not limited to, hydroxyl groups, alkyl oxide groups, phenol groups, phenoxide groups, carboxyl groups, carboxylate groups, amino groups, imine groups, alkyl anions, azide groups, epoxide groups, phosphate groups, and thiol groups. Thermo-setting glues generally react with reactive functional groups including, but not limited to, hydroxyl groups, alkyl oxide groups, phenol groups, phenoxide groups, carboxyl groups, carboxylate groups, anhydride groups, amino groups, imine groups, alkyl anions, azide groups, epoxide groups, phosphate groups, and thiol groups. Custom-designed polymer adhesives such as poly(glycidyl methacrylate), poly(glycidyl acrylate), poly(vinyl alcohol) and poly(ethylene imine) generally react with reactive functional groups including, but not limited to, ketone groups, aldehyde groups, and acid chloride groups. It should be understood that any functional group capable of reacting with an adhesive and bonding covalently to the adhesive is encompassed for use in multifunctional microspheres of the invention.

In an embodiment, a reactive functional group is poly(2-hydroxyethyl methacrylate) or PHEMA. In an embodiment, a reactive functional group is poly(tert-butyl acrylate) (PtBA), which hydrolyzes to poly(acrylic acid) (PAA).

End groups, e.g., E1 and E2, may be fluorinated or not fluorinated. In an embodiment, end groups are fluorinated and are a CF₃(CF₂)₇CH₂CH₂— or a C₈F₁₇(CH₂)₂—O—(CH₂)₃ unit. In an embodiment, end groups are a fluorinated alkyl, e.g., fluorinated C₄ to C₁₂ alkyl, C₆ alkyl, C₈ alkyl or C₁₀ alkyl. In another embodiment, end groups are not fluorinated and are aliphatic (e.g., alkyl, e.g., C₄ to C₁₂ alkyl, C₆ alkyl, C₈ alkyl or C₁₀ alkyl), H, Br or Cl. In a further embodiment, end groups are CF₃(CF₂)₇CH₂CH₂, CF₃(CF₂)₅CH₂CH₂, C₈F₁₇(CH₂)₂—O—(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aldehyde, aliphatic (e.g., alkyl), ester, an adamantane group, a cyclodextrin group, an azobenzene group, Br, or Cl. In an embodiment, an end group is an amino group or a carboxyl group. When more than one end group is present, they may be the same or different.

It should be understood that, in some embodiments, an end group comprises at least one reactive functional group capable of forming a covalent bond with an adhesive. Reactive functional groups may therefore be present on an end group of a polymer chain. Thus in some embodiments, x is 100% and/or n is 0 (i.e., GL is not present), and an end group is present and comprises at least one reactive functional group capable of forming a covalent bond with an adhesive.

In an embodiment, an anchoring monomer unit anchored to the surface of a multifunctional microsphere is anchored via grafting, crosslinking or a combination thereof. Thus, anchoring monomer units may comprise crosslinking anchoring units, grafting anchoring units, or both.

In an embodiment, an anchoring monomer unit A in a polymer chain used to form a multifunctional microsphere of the invention has the structure of formula (XII):

(X_{q}-G_{100%-q}) (XII)

wherein X denotes a monomer unit that can undergo inter-polymer crosslinking; G denotes a grafting unit that can undergo a grafting reaction with a substrate and/or a material surface; and q is from 0% to 100%. In some embodiments, both X and G units are present. In some embodiments, only X units or only G units are present.

In an embodiment, a grafting unit G is maleic anhydride, glycidyl methacrylate or glycidyl acrylate. In another embodiment, a grafting unit G is selected from the group consisting of anhydrides, acrylates, methacrylates, acid chlorides, glycidyl groups, silyl halide groups, triazole groups, epoxide groups, isocyanate groups and succinimide groups. In yet another embodiment, a grafting unit G is selected from: (i) aldehyde and ketone-functional polymers such as polyacetal polymers, polyacrolein polymers, poly(methyl isopropenyl ketone) polymers, poly(vinyl methyl ketone) polymers, aldehyde-terminated poly(ethylene glycol) polymers, carbonylimidazole-activated polymers, and carbonyldiimidazole-terminated poly(ethylene glycol) polymers; (ii) carboxylic acid anhydride-functional polymers such as poly(acrylic anhydride) polymers, poly(alkalene oxide/maleic anhydride) copolymers, poly(azelaic anhydride) polymers, poly(butadiene/maleic anhydride) copolymers, poly(ethylene/maleic anhydride) copolymers, poly(maleic anhydride) polymers, poly(maleic anhydride/1-octadecene) copolymers, poly(vinyl methyl ether/maleic anhydride) copolymers, and poly(styrene/maleic anhydride) copolymers; (iii) carboxylic acid chloride-functional polymers such as poly(acrylolyl chloride) polymers and poly(methacryloyl chloride) polymers; and (iv) chlorinated polymers such as chlorine-terminated polydimethylsiloxane polymers, chlorinated polyethylene polymers, chlorinated polyisoprene polymers, chlorinated polypropylene polymers, poly(vinyl chloride) polymers, epoxy-terminated polymers, epoxide-terminated poly(ethylene glycol) polymers, isocyanate-terminated polymers, isocyanate-terminated poly(ethylene glycol) polymers, oxirane functional polymers, poly(glycidyl methacrylate) polymers, hydrazide-functional polymers, poly(acrylic hydrazide/methyl acrylate) copolymers, succinimidyl ester polymers, succinimidyl ester-terminated poly(ethylene glycol) polymers, tresylate-activated polymers, tresylate-terminated poly(ethylene glycol) polymers, vinyl sulfone-terminated polymers and vinyl sulfone-terminated poly(ethylene glycol) polymers. In an embodiment, a grafting unit G is a sol-gel forming unit. In other embodiments, grafting to metal substrates or material surfaces is provided. Suitable groups that complex with metals include, without limitation, triazole groups, carboxyl groups, and amine groups.

In an embodiment, an anchoring monomer unit in a polymer chain used to form a multifunctional microsphere of the invention comprises a sol-gel forming monomer unit, which possesses both a crosslinking function and a grafting function. In this embodiment, an anchoring block in a polymer chain used to form a multifunctional microsphere of the invention has the structure shown in Formula (XIIa):

S^{I1}_{q}—S^{I2}_{100%-q} (XIIa)

wherein S^{I1} and S^{I2} denote different sol-gel forming monomer units, and q is as defined above. (S^{I1}_{q}—S^{I2}_{100%-q}) can, for example, have the following notation:

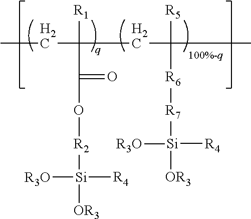

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring, or methylene; and q is 1% or greater than 1%.

In an embodiment, S^{I1} is the same as S^{I2}, and anchoring monomer units in a polymer chain used to form a multifunctional microsphere of the invention have the structure shown in Formula XIIb:

S^{I} (XIIb)

wherein S^{I} denotes a sol-gel forming monomer unit.

Sol-gel processes are wet-chemical techniques widely used in the fields of materials science and ceramic engineering. Such methods are used primarily for the fabrication of materials starting from a colloidal solution (sol) that acts as the precursor for an integrated network (or gel) of either discrete particles or network polymers. In a sol-gel process, a fluid suspension of a colloidal solid (sol) gradually evolves towards the formation of a gel-like diphasic system containing both a liquid phase and a solid phase whose morphologies range from discrete particles to continuous polymer networks (for review, see Brinker, C. J. and Scherer, G. W., 1990, Sol-Gel Science: The Physics and Chemistry of Sol-Gel Processing, Academic Press, ISBN 0121349705; Hench, L. L. and West, J. K., 1990, The Sol-Gel Process, Chemical Reviews 90: 33). As used herein, “sol-gel forming” blocks or monomer units are blocks or monomer units which can undergo a sol-gel process to form a sol-gel state.

In another embodiment, anchoring blocks in polymer chains used to form multifunctional microspheres of the invention comprise different crosslinkable monomer units. In this embodiment, anchoring monomer units used to form multifunctional microspheres of the invention have the structure shown in Formula (Id):

S^{I}ₖ—Xₗ (Id)

wherein S^{I} and X denote different monomer units that can undergo inter-polymer crosslinking, and S^{I} denotes a sol-gel forming monomer unit; l is 0, 1 or greater than 1; k is 0, 1 or greater than 1; and l and k are not both zero. When S^{I} and X are both present, an anchoring block may comprise an S^{I} and X random copolymer, block, or two separate S^{I} and X blocks. Such copolymers may provide high stability under basic or acidic conditions in the presence of moisture; since Si—O—Si bonds are known to be labile towards hydrolysis under basic or acidic conditions in the presence of moisture, crosslinked X units may provide extra resistance to hydrolysis. In an embodiment, 1<k<200. In an embodiment, 1<l<200.

In an embodiment, crosslinkable units can be crosslinked by themselves without need for additives such as, for example, acids, bases, catalysts and/or initiators. Non-limiting examples include photocrosslinkable or UV-crosslinkable polymers that can be crosslinked when subject to photolysis. These polymers may contain, for example, cinnamate, coumarin, chalcone, diacetylene, anthracene, or maleimide pendant groups. 2-Cinnamoyloxyethyl methacrylate (CEMA) and 2-cinnamoyloxyethyl acrylate (CEA) are examples of such units. CEMA and CEA units in a polymer can absorb light and dimerize via a biradical mechanism. Dimerization of two CEMA or CEA units of different polymer chains leads to chain coupling, and the coupling of multiple chains leads eventually to a crosslinked polymer network. Polymers that bear pendant double bonds can also be crosslinked thermally. Heating a polymer can lead to radical formation, and the generated radicals can polymerize pendant double bonds of the polymer chains, resulting in polymer crosslinking. For example, a reaction between hydroxyl groups of poly(2-hydroxyethyl acrylate) and acryloyl chloride will introduce acrylate pendant groups. These acrylate pendant double bonds are very active and can be crosslinked readily by thermally-generated free radicals. These pendant groups can be crosslinked thermally at temperatures such as, for example, 120° C. without need for radical initiators. Therefore, it is expected that any polymer containing active pendant acrylate, methacrylate, and/or styryl units can be thermally crosslinkable. In an embodiment, a crosslinkable unit is crosslinked by UV light. In another embodiment, a crosslinkable unit is crosslinked thermally.

In another embodiment, crosslinkable units include polymers that require additive(s), e.g., acids, bases, catalysts, and/or initiators, for crosslinking. For example, PIPSMA can be crosslinked via sol-gel chemistry after the addition of an acid or base as the catalyst. Pendant double bonds of polybutadiene and polyisoprene are not as reactive as the double bonds of pendant acrylate or methacrylate units, and therefore to crosslink these double bonds, a thermo-initiator such as, for example, benzoyl peroxide or a photo-initiator such as, for example, 1-hydroxycyclohexyl phenyl ketone will need to be added before these polymers can be crosslinked thermally or photochemically. Another example is polyvinyl pyridine), which can be crosslinked thermally in the presence of dihalogenated hydrocarbons such as, for example, 1,4-dibromobutane. Poly(acrylic acid) can be crosslinked using diamines such as, for example, 1,6-hexamethylene diamine via amidization. In some embodiments, crosslinkable units are redox-crosslinkable. For example, free radicals can be generated from a redox reaction and used to crosslink polymers such as polybutadiene and polyisoprene. A non-limiting example of such an initiating system is TEMED and ammonium persulfate.

In an embodiment, a crosslinkable unit is a trialkoxysilane-containing unit, a dialkoxysilane-containing unit, or an IPSMA (3-(triisopropyloxysilyl)propyl methacrylate) unit.

Non-limiting examples of grafting (G) monomer units include maleic anhydride, glycidyl methacrylate, and glycidyl acrylate units. Other examples include anhydrides, acrylates, methacrylates, acid chlorides, glycidyl groups, silyl halide groups, epoxide groups, isocyanate groups and succinimide groups.

In an embodiment, S^{I} is 3-(triisopropyloxysilyl)propyl methacrylate.

Many different anchoring polymer blocks may be used in polymer chains used to form multifunctional microspheres of the invention. Without wishing to be limited by theory, anchoring blocks can be attached to a substrate via three mechanisms: (a) a grafting reaction between an anchoring block and a substrate; (b) a crosslinking of an anchoring block around a substrate; and (c) a combination of both (a) and (b). Anchoring polymer blocks may thus comprise crosslinkable polymer blocks, grafting polymer blocks, and/or polymer blocks which comprise both crosslinking and grafting functions, such as sol-gel forming polymer blocks.

Choice of anchoring blocks to be used in polymer chains used to form a multifunctional microsphere according to the invention varies depending on properties of the desired substrate, e.g., a particle, or material surface, e.g., a glass plate. For example, in the case of substrates or material surfaces bearing hydroxyl, amino, thiol and/or carboxylic acid groups, anchoring blocks can attach to a substrate via a grafting reaction between anchoring blocks and substrate. Non-limiting examples of such anchoring blocks which can graft onto a substrate using mechanism (a) include: (i) aldehyde and ketone-functional polymers such as polyacetal polymers, polyacrolein polymers, poly(methyl isopropenyl ketone) polymers, poly(vinyl methyl ketone) polymers, aldehyde-terminated poly(ethylene glycol) polymers, carbonylimidazole-activated polymers, and carbonyldiimidazole-terminated poly(ethylene glycol) polymers; (ii) carboxylic acid anhydride-functional polymers such as poly(acrylic anhydride) polymers, poly(alkalene oxide/maleic anhydride) copolymers, poly(azelaic anhydride) polymers, poly(butadiene/maleic anhydride) copolymers, poly(ethylene/maleic anhydride) copolymers, poly(maleic anhydride) polymers, poly(maleic anhydride/1-octadecene) copolymers, poly(vinyl methyl ether/maleic anhydride) copolymers, and poly(styrene/maleic anhydride) copolymers; (iii) carboxylic acid chloride-functional polymers such as poly(acrylolyl chloride) polymers and poly(methacryloyl chloride) polymers; and (iv) chlorinated polymers such as chlorine-terminated polydimethylsiloxane polymers, chlorinated polyethylene polymers, chlorinated polyisoprene polymers, chlorinated polypropylene polymers, poly(vinyl chloride) polymers, epoxy-terminated polymers, epoxide-terminated poly(ethylene glycol) polymers, isocyanate-terminated polymers, isocyanate-terminated poly(ethylene glycol) polymers, oxirane functional polymers, poly(glycidyl methacrylate) polymers, hydrazide-functional polymers, poly(acrylic hydrazide/methyl acrylate) copolymers, succinimidyl ester polymers, succinimidyl ester-terminated poly(ethylene glycol) polymers, tresylate-activated polymers, tresyiate-terminated poly(ethylene glycol) polymers, vinyl sulfone-terminated polymers and vinyl sulfone-terminated poly(ethylene glycol) polymers. Other non-limiting examples of such anchoring blocks include polymers bearing maleic anhydride, other anhydrides, acrylates, methacrylates, acid chlorides, glycidyl groups, silyl halide groups, epoxide groups, isocyanate groups, and/or succinimide groups. These functional groups react with, for example, substrate or surface hydroxyl and amino groups. Crosslinking may be done with the aid of an additive, e.g., a bi-functional additive, that reacts with pendant groups.

In other embodiments, anchoring blocks may crosslink around a substrate (mechanism (b)). In this case, an anchoring block forms an integral crosslinked wrapping layer around, e.g., a substrate. In general, the larger a substrate to be coated, the larger the area of this wrapping layer is, and also the higher the probability of defect formation. These methods are therefore particularly well-suited for coating nanoparticles such as silica and surfaces such as nanofibers.

In an embodiment, anchoring blocks used for forming integral crosslinked wrapping layers around a substrate are crosslinkable polymers, as described above. Crosslinkable polymers include polymers that can be crosslinked themselves without additives as well as polymers that require additives for crosslinking. In an embodiment, a crosslinkable polymer block is a trialkoxysilane-bearing block or trialkoxysilane. In other embodiments, a crosslinkable polymer block comprises 2-cinnamoyloxyethyl methacrylate (CEMA) and/or 2-cinnamoyloxyethyl acrylate (CEA).

In other embodiments, anchoring blocks attach to a substrate via both a grafting reaction between anchoring blocks and substrate and crosslinking of anchoring blocks around a substrate (mechanism (c)). Any polymers that undergo sol-gel chemistry can be used on substrates bearing hydroxyl groups and can attach to these substrates via both a grafting reaction between anchoring blocks and substrate and crosslinking of anchoring blocks around a substrate. Such polymers are encompassed for use as crosslinkable components of polymer chains used to form multifunctional microspheres of the invention. Alternatively, two types of functional units can be incorporated into an anchoring block to provide the desired properties. For example, an anchoring block can include both units which can graft onto a substrate using mechanism (a) and units which crosslink around a substrate using mechanism (b).

In an embodiment, an anchoring block comprises a sol-gel forming block. In another embodiment, a crosslinkable block is a sol-gel forming block.

It should be appreciated that crosslinkable polymer blocks contain functional groups which can undergo a crosslinking reaction among units of the crosslinkable block (i.e., crosslinking to each other), forming a network. In some cases, these functional groups can also undergo a grafting reaction to a substrate, or crosslinkable polymer blocks may contain additional functional groups which graft or attach onto a substrate. In some embodiments therefore, a crosslinkable polymer block contains both types of functional groups, i.e., crosslinkable groups and grafting groups.

As described above, non-limiting examples of functional groups which covalently graft or attach onto a substrate include anhydrides, acrylates, methacrylates, acid chlorides, glycidyl groups, silyl halide groups, epoxide groups, isocyanate groups, and succinimide groups. Any group capable of grafting onto a substrate is encompassed for use in multifunctional microspheres of the invention. In an embodiment, a functional group which covalently grafts or attaches onto a substrate is introduced as an end group to a crosslinkable polymer block in a multifunctional microsphere of the invention.

In an embodiment, S^{I} has the structure shown in Formula VI:

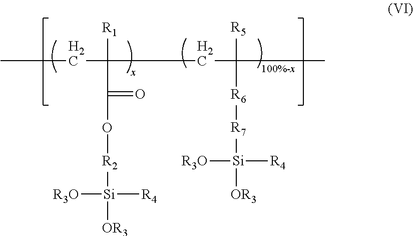

wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring or methylene; and x is from 0% to 100%.

In an embodiment, a multifunctional microsphere of the invention comprises an amphiphobic block copolymer which is PIPSMA-b-PFOEMA. In another embodiment, PFOEMA is replaced by 2-(perfluorohexyl)ethyl methacrylate.

In an embodiment, a multifunctional microsphere of the invention comprises an amphiphobic block copolymer which is PCEMA-b-PFOEMA. In another embodiment, PFOEMA is replaced by 2-(perfluorohexyl)ethyl methacrylate.

In an embodiment, a multifunctional microsphere of the invention comprises an amphiphobic block copolymer which is PIPSMA-b-PtBA.

In an embodiment, a multifunctional microsphere of the invention comprises one or more than one amphiphobic block copolymer. In an embodiment, a multifunctional microsphere of the invention comprises at least two amphiphobic block copolymers. In an embodiment, a multifunctional microsphere of the invention comprises a first amphiphobic block copolymer which is PIPSMA-b-PFOEMA and a second hydrophobic block copolymer which is PIPSMA-b-PtBA. In another embodiment, in the first amphiphobic block copolymer PFOEMA is replaced by 2-(perfluorohexyl)ethyl methacrylate.

In an embodiment, a multifunctional microsphere of the invention comprises an amphiphobic block copolymer which is a diblock copolymer. In an embodiment, a multifunctional microsphere of the invention comprises an amphiphobic block copolymer which is a triblock copolymer. In an embodiment, a multifunctional microsphere of the invention comprises an amphiphobic triblock copolymer which is PIPSMA-b-PCEMA-b-PFOEMA. In another embodiment, PFOEMA in such amphiphobic triblock copolymer is replaced by 2-(perfluorohexyl)ethyl methacrylate. In another embodiment, a multifunctional microsphere of the invention comprises an amphiphobic block copolymer which has the structure of PIPSMA-b-PFOEMA:

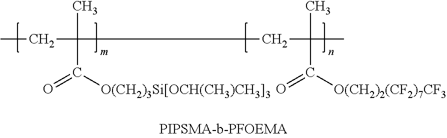

wherein m is 1 or greater than 1 and n is 1 or greater than 1.

In another embodiment, a multifunctional microsphere of the invention comprises an amphiphobic block copolymer which is poly(3(triisopropyloxysilyl))propyl methacrylate-block-poly(heptadecaperfluorooctyl)ethyl methacrylate, wherein the number of repeat units of both monomers is 10.

Amphiphobic block copolymers have been described, for example in U.S. application Ser. No. 13/445,430, filed Apr. 12, 2012, the entire contents of which are hereby incorporated by reference. It is provided that any such amphiphobic block copolymer having the desired properties may be used in multifunctional microspheres of the invention. For example, the following amphiphobic block copolymers may all be used in multifunctional microspheres of the invention, or may be used to form multifunctional microspheres of the invention: amphiphobic block copolymers comprising at least one fluorinated polymer block and at least one anchoring polymer block, wherein the at least one anchoring polymer block is capable of undergoing inter-polymer crosslinking and/or capable of covalently grafting with a substrate; amphiphobic diblock copolymers; amphiphobic triblock copolymers; and amphiphobic block copolymers described in U.S. application Ser. No. 13/445,430. It is noted that intra-polymer crosslinking may also occur in amphiphobic block copolymers used in microfunctional microspheres of the invention.

In an embodiment, there is provided herein a fluorine-containing bi-functional microsphere, the fluorine-containing bi-functional microsphere having the structure of Formula (I):

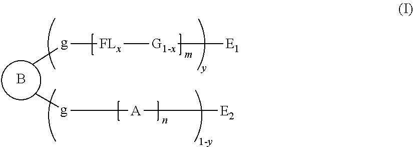

wherein B is a crosslinked polymer microsphere, silicon dioxide microsphere, aluminum(III) trioxide microsphere, or iron(III) trioxide microsphere; g represents a graft; FL is a structural unit containing fluorine; G is a structural unit containing a hydroxyl group, an amino group, a carboxyl group, or an epoxy group; A is a structural unit containing a hydroxyl group, an amino group, a carboxyl group, or an epoxy group; E₁ and E₂ are hydrogen, a halogen, or a thiol group; x is 0 or 1; y is 0 or 1; m is a whole number greater than or equal to 0; and n is a whole number greater than or equal to 0. In an embodiment, x is 1. In an embodiment, y is 1. In an embodiment, m is 1. In an embodiment, x is not 1 when n is 0. In an embodiment, x is 1, y is 1, m is 1, and x is not 1 when n is 0.

In an embodiment, there is provided herein a fluorine-containing bi-functional microsphere, the fluorine-containing bi-functional microsphere having the structure of Formula

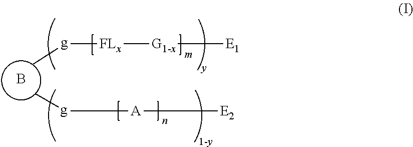

wherein B is a crosslinked polymer microsphere, silicon dioxide microsphere, aluminum(III) trioxide microsphere, or iron(III) trioxide microsphere; g represents a graft; FL is a structural unit containing elemental fluorine; G is a structural unit containing a hydroxyl group, an amino group, a carboxyl group, or an epoxy group; A is a structural unit containing a hydroxyl group, an amino group, a carboxyl group, or an epoxy group; E₁ and E₂ are hydrogen, a halogen, or a thiol group; x is 1 or greater than 1; y is 1 or greater than 1; m is 1 or greater than 1; and n is a whole number greater than or equal to 0, wherein x is not 1 when n is 0. In an embodiment, 50<m<200. In an embodiment, 50<n<200. In an embodiment, y denotes the number fraction of the polymer chains.

In another embodiment, 0≦x≦1. In another embodiment, 0≦y≦1. In an embodiment, x is 0.8. In an embodiment, y is 0.1.

In another embodiment, there is provided herein a fluorine-containing bi-functional microsphere, the fluorine-containing bi-functional microsphere having the structure of Formula (I), wherein B is a poly(methyl methacrylate) microsphere having the structure of Formula (II):

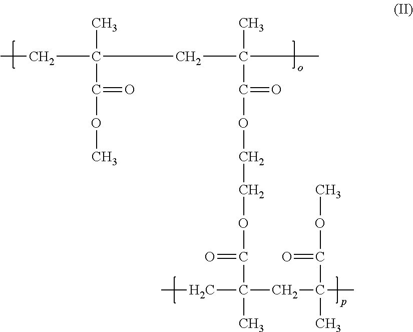

wherein o is a whole number greater than or equal to 0; p is a whole number greater than or equal to 0; m is a value taken from the range 100≦m≦1000; and n is a value taken from the range 100≦n≦1000. In an embodiment, p and o are not both 0.

In another embodiment, there is provided herein a fluorine-containing bi-functional microsphere, the fluorine-containing bi-functional microsphere having the structure of Formula (I), wherein FL has the structure of Formula (III):

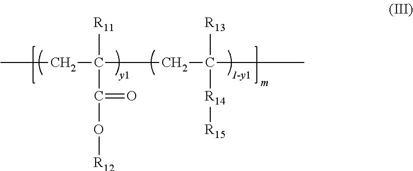

wherein R₁₁ and R₁₃ are hydrogen or a methyl group; R₁₂ and R₁₅ are a fluorine-containing alkyl or a fluorine-containing benzene ring; R₁₄ is an alkylene; and y₁ is a whole number greater than or equal to 0.

In an embodiment, there is provided herein a fluorine-containing bi-functional microsphere, the fluorine-containing bi-functional microsphere having the structure of Formula (I), wherein G has the structure of Formula (IV):

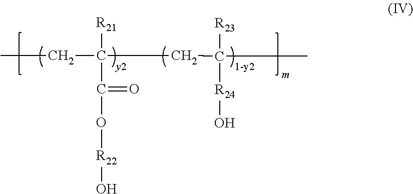

wherein R₂₁ and R₂₃ are hydrogen or a methyl group; R₂₂ and R₂₄ are an alkylene or benzene ring; and y₂ is a whole number greater than or equal to 0.

In an embodiment, there is provided herein a fluorine-containing bi-functional microsphere, the fluorine-containing bi-functional microsphere having the structure of Formula (I), wherein A has the structure of Formula (V):

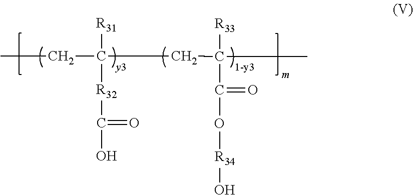

wherein R₃₁ and R₃₃ are hydrogen or a methyl group; R₃₂ and R₃₄ are an alkylene or benzene ring, and y₃ is a whole number greater than or equal to 0.

In another embodiment, there is provided herein a fluorine-containing bi-functional microsphere, the fluorine-containing bi-functional microsphere having the structure of Formula (I), wherein FL has the structure of Formula (III):

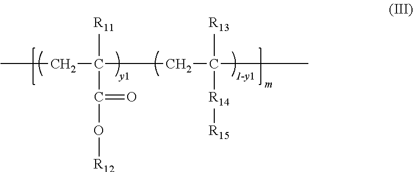

wherein R₁₁ and R₁₃ are hydrogen or a methyl group; R₁₂ and R₁₅ are a fluorine-containing alkyl or a fluorine-containing benzene ring; R₁₄ is an alkylene; and y₁ is a whole number greater than or equal to 0; and wherein G has the structure of Formula (IV):

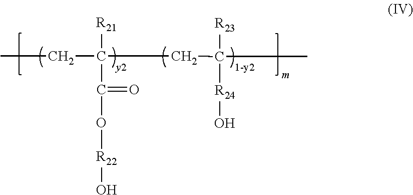

wherein R₂₁ and R₂₃ are hydrogen or a methyl group; R₂₂ and R₂₄ are an alkylene or benzene ring; and y₂ is a whole number greater than or equal to 0; and wherein A has the structure of Formula (V):

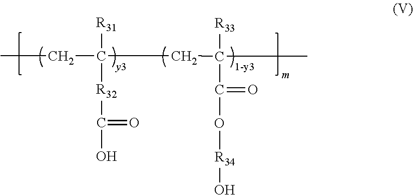

wherein R₃₁ and R₃₃ are hydrogen or a methyl group; R₃₂ and R₃₄ are an alkylene or benzene ring, and y₃ is a whole number greater than or equal to 0. In some embodiments, R₁₂ and R₁₅ are heptadecafluoro octyl; R₁₄ is ethylene; R₂₂ and R₂₄ are ethylene; and/or R₃₂ and R₃₄ are ethylene.

In some embodiments, FL is 2-(perfluorooctyl)ethyl acrylate (FOEA); G is 2-hydroxyethyl acrylate; and/or A is 2-hydroxyethyl acrylate or 2-hydroxyethyl methacrylate. In one embodiment, 2-(perfluorooctyl)ethyl acrylate (FOEA) is obtained from a reaction between 2-hydroxyethyl acrylate and heptadecafluoro nonanoyl chloride.

In an embodiment, a multifunctional microsphere is a poly(meth)acrylate polymer microsphere having a surface grafted with a random copolymer of FOEMA and hydroxyethylmethacrylate (HEMA); a poly(meth)acrylate polymer microsphere having a surface grafted with 2-(perfluorooctyl)ethyl acrylate (FOEA) and polyacrylic acid (PAA); a silicon dioxide sphere having a surface grafted with a random copolymer of PFOEA and HEMA; or a silicon dioxide sphere having a surface grafted with poly PFOEA and PAA.

Multifunctional microspheres of the invention can be used to modify a material surface and prepare amphiphobic coatings. For example, an amphiphobic coating can be prepared on a material surface as follows:

Optionally, a material surface is first pretreated by washing and cleaning the material surface, as may be necessary, to remove contaminants. In an embodiment, oil contaminants are removed. A material surface may be washed at room temperature or under conditions which are determined based on the nature of contaminants to be removed. The material surface is then coated with an adhesive (e.g., in some cases, both components of a two component adhesive such as an epoxy) and the adhesive is allowed to cure onto the material surface. Multifunctional microspheres of the invention are combined with (e.g., painted on) the adhesive on the material surface. Curing conditions will vary depending on the adhesive being used and the material surface being coated. For example, heating may be required, or curing may occur at room temperature. In an embodiment, adhesive is cured at room temperature for about 10 to about 40 minutes. In some embodiments, an adhesive is applied uniformly to a material surface.

Many adhesives are known in the art and may be used in methods provided herein. Any adhesive suitable chemically for reaction with multifunctional microspheres may be used. For example, an adhesive can be any polymer that binds well with a material surface, and can also form covalent bonds with reactive functional groups of multifunctional microspheres of the invention. Adhesive polymers can be pre-made, such as poly(vinyl alcohol), or can be prepared in situ after a precursor and multifunctional microspheres of the invention have been place in contact. An example of the latter category is a superglue consisting initially of a cyanoacrylate monomer that polymerizes in air due to water uptake by the monomer.

Non-limiting examples of adhesives include epoxy resin adhesives, isocyanate adhesives, and polyurethane adhesives.

In an embodiment, an adhesive is a commercially available glue. Structurally, commercially available glues can be divided into two types, thermo-setting and thermo-plastic. Thermo-setting glues generally consist of two parts, each bearing different functional groups which can react together; after mixing, functional groups in the two parts react and yield a crosslinked network between two objects to be joined. Even stronger binding can be obtained if the glue components contain functional groups that react with functional groups on the surfaces of objects to be joined. Examples of thermo-setting glues include, without limitation, epoxy resins, polyurethanes, resorcinol-formaldehyde resins, urea-formaldehyde resins, rubber cements, and silicone resins. Examples of thermo-plastic glues include, but are not limited to, cyanoacrylate glues, poly(vinyl alcohol) glues, poly(vinyl acetate) glues, and polyvinylpyrrolidone glues. Adhesives can also be thermo-plastic glues, which hold objects together primarily via physical interactions.

In an embodiment, an epoxy resin is used as adhesive. Epoxy resins generally contain epoxide groups, which can react with a wide range of reactive functional groups including, but not limited to, hydroxyl groups, hydroxide groups, alcohol groups, alkyl oxide groups, phenol groups, phenoxide groups, carboxyl groups, carboxylate groups, amino groups, imine groups, anhydride groups, alkyl anions, azide groups, isocyanate groups, phosphate groups, and thiol groups.

In an embodiment, a polyurethane glue is used as adhesive. Polyurethane glues generally contain isocyanate groups, which can react with a wide range of reactive functional groups including, but not limited to, hydroxyl groups, alkyl oxide groups, phenol groups, phenoxide groups, carboxyl groups, carboxylate groups, amino groups, imine groups, alkyl anions, azide groups, epoxide groups, phosphate groups, and/or thiol groups.

In an embodiment, durable thermo-setting amphiphobic particulate coatings are prepared. In this embodiment, multifunctional microspheres of the invention are embedded in a thermo-setting glue and generally have reactive functional groups including, but not limited to, hydroxyl groups, alkyl oxide groups, phenol groups, phenoxide groups, carboxyl groups, carboxylate groups, anhydride groups, amino groups, imine groups, alkyl anions, azide groups, epoxide groups, phosphate groups, and thiol groups.

In an embodiment, custom-designed polymers are used as adhesives. For example, poly(glycidyl methacrylate), poly(glycidyl acrylate), poly(vinyl alcohol) and poly(ethylene imine) can be used as adhesives. These adhesives react with reactive functional groups such as ketone groups, aldehyde groups, and acid chloride groups.

In an embodiment of a method of making an amphiphobic coating on a material surface, a selected adhesive is applied to a material surface. In some cases, the adhesive derives from multiple components, and these components are mixed together prior to said application to the material surface. A coating solution is prepared. Multifunctional microspheres are dispersed in a solvent to obtain a solution (i.e., a fine suspension or dispersion). The solution of multifunctional microspheres is then coated onto the pretreated material surface, i.e., onto the surface of the adhesive. The combination is then cured and/or annealed to form a coating on the material surface. Curing and annealing conditions will vary depending on reaction conditions such as the adhesive, the material surface, the particles, the solvent, etc., and will be determined by the skilled artisan. In some embodiments, heating is required to cure and/or anneal particles to a material surface. In one embodiment, curing takes place at about 50° C. to about 70° C. for, e.g., about one to about three hours, and/or annealing takes place at about 90° C. to about 120° C. for, e.g., about 10 to about 60 minutes.

In another embodiment, the adhesive and the multifunctional microspheres of the invention are combined, and then applied to the material surface together, after which curing and/or annealing is/are allowed to take place. In another embodiment, the material surface is treated with a precursor or a first component of an adhesive, and the multifunctional microspheres and a second component of the adhesive, an additive and/or an initiator are applied together to the treated surface. Curing and/or annealing follow.

In another embodiment, the material surface is treated with a precursor or a first component of an adhesive, the multifunctional microspheres are applied to the treated surface, and then a second component of the adhesive, an additive and/or an initiator is applied to the mixture on the surface. Curing and/or annealing follow. In another embodiment, a precursor or first component of an adhesive is mixed with the multifunctional microspheres and the resulting mixture is applied to the material surface, followed by application to the surface of a second component of the adhesive, an additive and/or an initiator. Curing and/or annealing follow. However, in these last two embodiments, there is some risk that the multifunctional microspheres will not be exposed, or will not be optimally or maximally exposed on the surface of the coating so formed. If the multifunctional microspheres are partially or completely covered by the adhesive, roughness will be decreased or in the worst case eliminated, and amphiphobicity will also be decreased or in the worst case eliminated. Thus, these last two embodiments are generally not preferred.

In some embodiments, the concentration of a solution of multifunctional microspheres is 5 mg/mL. In some embodiments, the concentration of a solution of multifunctional microspheres is between about 1 mg/mL and about 300 mg/mL.

In certain embodiments, multifunctional microspheres can be used to modify a material surface and prepare amphiphobic coatings directly, without use of an adhesive layer. In these embodiments, a material surface may be pretreated by washing and cleaning the material surface, if necessary, to remove contaminants. A coating solution is prepared. Multifunctional microspheres may be dispersed in a solvent to obtain a solution (i.e., suspension or dispersion). The solution of multifunctional microspheres is then applied or coated directly onto the material surface. The solution may then be dried, cured and/or annealed to form a coating layer on the material surface. However, in general, such a coating would only be temporary, and a more durable coating is obtained when the multifunctional microspheres and adhesive are applied to a material surface.

Drying, curing and annealing conditions will vary depending on reaction conditions such as the material surface, the multifunctional microspheres, the solvent, etc., and will be determined by the skilled artisan. In some embodiments, heating is required. In other embodiments, drying occurs at room temperature. In other embodiments, a solution is air-dried.

In certain embodiments, the multifunctional microspheres can be used to modify a material surface and prepare amphiphobic coatings directly, without use of solvent. In these embodiments, a material surface may be pretreated by washing and cleaning the material surface, if necessary, to remove contaminants. The multifunctional microspheres are then applied directly onto the material surface, e.g., the adhesive-coated material surface, as a powder coating, e.g., by aerosol application. Curing and/or annealing follows. In certain other embodiments, dry glue or powder glue is mixed with the multifunctional microspheres in the absence of solvent, and it is this mixture which is applied to a material surface and then cured and/or annealed.

Coating preparations or formulations may be applied to a material surface using conventional techniques, such as brushing, painting, printing, stamping, rolling, dipping, spin-coating, spraying, or electrostatic spraying. In an embodiment, solutions of multifunctional microspheres are uniformly spray coated on a material surface, which may be a material surface to which an adhesive or an adhesive precursor has been applied.

Polymer microsphere substrates may be prepared via a soap-free emulsion or emulsion polymerization. Silicon dioxide microspheres may be prepared using conventional methods, such as the Stober method (Stober, W. et al., J. Colloid. Interf. Sci., 1968, 26: 62). In an embodiment, nano silica spheres of a certain particle size are obtained through hydrolysis of tetraethyl siloxane in isopropyl alcohol, catalyzed by ammonia, followed by washing three times with isopropyl alcohol after centrifugal separation of product to remove catalyst, unreacted reactants, and byproducts. In an embodiment, a white powder is then obtained after vacuum drying.

In an embodiment, there is provided a method for preparing fluorine-containing multifunctional microspheres, e.g., bi-functional microspheres, as follows:

(1) Modification process of polymer microspheres begins with emulsion polymerization. At room temperature, 4.8 g methyl methacrylate (MMA), 0.4 g ethylene glycol dimethacrylate (EGDMA), 41 mg sodium persulfate, and 130 mL water are added in succession to a 500-mL three-neck flask, stirred for 15 minutes, and then heated to 90° C. and reacted for two hours, after which the flask is returned to room temperature and 5 to 20 mg azobisisobutyronitrile (AIBN) is added, followed by 10 to 20 minutes of stirring. The reaction system is then transferred to an 80° C. to 100° C. oil bath, where a mixture of 1 to 2 g (2-acryloyloxy)ethyl 2-chloropropionate (a substance that can be obtained through a method of reacting 2-chloropropionyl chloride with 2-hydroxyethyl acrylate, as described in Jayachandran, K. N. et al., Macromolecules, 2002, 35, pp. 4247-4257), 100 μL to 150 μL EGDMA, and 2 g to 2.5 g MMA is introduced slowly at a rate of 1.5 mg/hr to 3 mg/hr. Once dropwise addition of monomers is complete, the reaction continues for three to five hours; after centrifugal separation of products and three rounds of washing with distilled water, the same are dried in a vacuum oven. In so doing, an initiator that can initiate atom transfer radical polymerization (ATRP) is introduced to the surface of the polymer microspheres. Under the catalytic action of cuprous chloride (or cuprous bromide) and N,N,N′,N″,N″-pentamethyl diethylene triamine, the initiator on the surfaces of the polymer microspheres can initiate hydroxyethyl acrylate polymerization and graft a PHEA chain onto the surfaces of the microspheres. The polymer chain of the polymer microsphere surfaces can be converted to a fluorine-containing polymer chain through a reaction between hydroxyl groups on the PHEA chain and heptadecafluorocarbonyl chloride.

(2) Surfaces of silicon dioxide microspheres have many hydroxyl groups, and reaction between these hydroxyl groups and an alkoxy silicon-based compound can cause the hydroxyl groups to join to the silica sphere surfaces through a covalent bond. Under the catalytic action of hydrochloric acid, triisopropyloxysilyl groups in the backbones of the two polymers poly[3-(triisopropyloxysilyl)propyl methacrylate]-b/ock-poly[2-(heptadecafluoro)ethyl methacrylate] (PIPSMA-b-PFOEMA) and poly[3-(triisopropyloxysilyl)propyl methacrylate]-block-poly(tert-butyl acrylate) (PIPSMA-b-PtBA) are hydrolyzed and undergo a condensation reaction with silica sphere surfaces to cause the two polymers to be grafted onto the silica sphere surfaces. At room temperature, 2.0 to 4.0 mL α,α,α-trifluorotoluene and 4.0 to 6.0 mg silica nanospheres are placed in a 20-mL flask, and the flask is brought into an ultrasonic cleansing device, where 40 to 80 seconds of ultrasound causes silica spheres to be dispersed into the α,α,α-trifluorotoluene. Block copolymers P(IPSMA)₁₀-b-PtBA₇₀ and P(IPSMA)₁₀-(PFOEMA)₁₀ are each separately formulated into 5 to 10 mg/mL tetrahydrofuran solutions and each separately mixed at a volume ratio of 1:3 to 1:5 to obtain mixed polymer solutions. A 4.0 mol/L hydrochloric acid-dioxane solution is diluted with tetrahydrofuran to a 0.1 mol/L to 0.3 mol/L solution. Under stirring, 0.05 mL to 0.10 mL of the mixed polymer solutions, 0.10 mL to 0.16 mL tetrahydrofuran, 0.05 mL to 0.10 mL hydrochloric acid solution, and 0 μL to 10 μL water are gradually added to the solution of silica nanospheres, and then reacted for seven to ten hours at 22° C. to obtain a crude product of modified silica nanospheres. After centrifugal separation of crude product, two rounds of washing with 2 to 4 mL α,α,α-trifluorotoluene are used to remove unreacted polymer, catalyst, and by-products. Product is dried for one to two hours in a 90° C. to 120° C. oven to obtain a white powder, i.e., modified silica nanospheres.

In an embodiment, multifunctional microspheres of the present invention are a white powder at room temperature, and have a density that varies between 1.2 g/cm³ and 2.2 g/cm³ depending on differences in composition. Multifunctional microspheres are generally insoluble in water, methanol, ethanol, and other non-fluorine-containing organic solvents, but can be dispersed in fluorinated organic solvents such as α,α,α-trifluorotoluene and perfluorinated cyclohexane.

Multifunctional microspheres of the invention can be used to provide amphiphobic material surface coatings. In an embodiment, multifunctional microspheres are applied during a process of curing an adhesive, e.g., an epoxy resin or isocyanate adhesive. Without wishing to be bound by theory, it is believed that portions of contact between multifunctional microspheres and adhesive contain small amounts of reactive functional groups, e.g., hydroxyl groups and carboxyl groups, that participate in a curing reaction, which causes multifunctional microspheres to join to the surface of the adhesive through covalent bonding, thus increasing durability and/or wear resistance of a coating. During a high-temperature annealing process, fluorinated chains of multifunctional microspheres not in contact with adhesive, due to the relatively low surface energy of fluorine, will migrate to the exterior of a microsphere coating while some reactive functional groups, e.g., hydroxyl groups and carboxyl groups, remain on the interior of the coating, endowing the coating with favorable amphiphobic properties. The proportion of fluorinated chains to reactive functional group-containing chains (e.g., hydroxyl group- or carboxyl group-containing chains) of a microsphere surface can be adjusted in accordance with different needs. In general, increasing the proportion of fluorinated chains is advantageous in terms of increasing amphiphobic properties of a coating, while increasing the proportion of reactive functional group-containing chains, e.g., hydroxyl group- or carboxyl group-containing chains, is advantageous in terms of increasing durability and wear resistance of a microsphere coating on a material surface.

Amphiphobic material surface coatings prepared with multifunctional microspheres as described herein provide certain advantages in comparison to other coatings available in the art. For example, a multifunctional microsphere described herein may have one or more of the following properties: 1) it may be able to endow materials with excellent amphiphobic properties; 2) it may be used to modify a variety of different materials; 3) it may provide amphiphobic coatings which are highly stable and durable, e.g., do not readily come off or degenerate, since covalent bonds between adhesive and residual reactive functional groups, e.g., hydroxyl groups and carboxyl groups, on multifunctional microspheres can act to affix microspheres to a material surface, thus increasing stability of a coating, wear resistance of a coating, durability of a coating, and/or preventing a coating from falling off a material surface or deforming; 4) its production may be controlled to provide microsphere surfaces with a precise structure, which can be used to endow a material with precision performance parameters (For example, controlled radical polymerization and living anionic polymerization can be used to prepare polymers for modifying microspheres, allowing precise control of length of polymer chains, number of polymer chains, and other parameters, and also allowing preparation of a microsphere surface to produce a multifunctional microsphere having an exact structure.); and/or (5) it may provide a coating which is more cost-effective than existing coatings.

As used herein, the term “material surface” is used to refer to the surface of a material which is to be coated with, or which is coated with, multifunctional microspheres of the invention, i.e., for which it is desired to provide an amphiphobic coating or amphiphobic properties. It is expected that any material surface can be turned water and oil repellent using multifunctional microspheres, i.e., fluorine-containing multifunctional microspheres, of the invention.

Contact angle of water on a surface, e.g., a material surface, is the angle of the leading edge of a water droplet on the surface as measured from the center of the droplet. A surface with a contact angle of 180 degrees would mean that water sits on it as a perfect sphere. Hydrophobic surfaces are generally measured between about 90 degrees and 180 degrees. As used herein, a “hydrophobic” material or surface is one that results in a water droplet forming a surface contact angle of about 90° or greater at room temperature (about 18° C. to about 23° C.). A “superhydrophobic” material or surface is one that results in a water droplet forming a surface contact angle of about 150° or greater, at room temperature. Hydrophobic behavior is thus considered to include superhydrophobic behavior; as used herein, the term hydrophobic includes superhydrophobic, unless stated otherwise.

As used herein, an “oleophobic” or “lipophobic” material or surface is one that results in a droplet of oil (e.g., mineral oil, diiodomethane) forming a surface contact angle of about 90° or greater, at room temperature. The terms “oleophobic” and “lipophobic” are used interchangeably herein. “Superoleophobicity” means that an oil or diiodomethane droplet contact angle is about 150° or greater. In general, superoleophobicity is not as well-defined as superhydrophobicity because there are many different organic compounds such as diiodomethane, hexadecane, and cooking oil that can be called oils.

As used herein, an “amphiphobic” material or material surface is one that is both hydrophobic and oleophobic or lipophobic. When the amphiphobic material or material surface is superhydrophobic and superoleophobic, the material or material surface is considered to be “superamphiphobic”. As used herein, amphiphobic behavior is considered to include superamphiphobic behavior, and the term amphiphobic includes superamphiphobic, unless stated otherwise.

In an embodiment, a material or material surface, is considered to be superamphiphobic when oil and water drops roll readily off the material or material surface when the material or material surface is tilted from the horizontal position at an angle of 10° or less.

It should be understood that the term “amphiphobic” is not limited to repelling only water and oil. In certain embodiments, an amphiphobic material or surface will repel not only water and oil but also other substances, such as fingerprints, salt, acid, base, bacteria, dirt, biological fluids, etc.

As used herein, “oil” refers to any substance that is liquid at ambient temperatures and does not mix with water but may mix with other oils and organic solvents. This general definition includes vegetable oils, plant oils, cooking oils, organic oils, mineral oils, volatile essential oils, petrochemical oils, petroleum-based oils, crude oils, naturally-occurring oils, synthetic oils and mixtures thereof. Oils may be clean or dirty. Oils may be found in a formulation with other substances, or may be pure or substantially pure.

“Alkyl” as used herein denotes a linear straight-chain, branched, or cyclic alkyl (cycloalkyl) radical. Alkyl groups may be independently selected from C₅ to C₂₀ alkyl, C₅ to C₁₀ alkyl, C₅ to C₈ alkyl, C₅ to C₁₅ alkyl, C₈ to C₂₀ alkyl, C₅ alkyl, C₆ alkyl, C₇ alkyl, C₈ alkyl, C₉ alkyl or C₁₀ alkyl. One or more hydrogen atoms of an alkyl group may be replaced by halogen atoms, such as fluorine, bromine or chlorine atoms. An alkyl group may be substituted or unsubstituted. In an embodiment, an alkyl group may be a “fluoroalkyl” group, i.e., an alkyl group in which some or all of the hydrogen atoms have been replaced by fluorine atoms, or a “perfluoroalkyl” group, i.e., an alkyl group in which fluorine atoms have been substituted for each hydrogen atom.

As used herein, the term “unsubstituted” refers to any open valence of an atom being occupied by hydrogen. Also, if an occupant of an open valence position on an atom is not specified, then it is hydrogen.

As used herein, when content is indicated as being present on a “weight basis” or at a “weight percent (wt %),” the content is measured as the percentage of the weight of component(s) indicated, relative to the total weight of all components present in a coating or composition, e.g., a coating solution or formulation. In some embodiments, multifunctional microspheres are typically present in a range selected from about 10 wt % to about 95 wt %, from about 40 wt % to about 95 wt %, from about 50 wt % to about 80 wt %, from about 60 wt % to about 80 wt %, from about 70 wt % to about 80 wt %, from about 40 wt % to about 80 wt %, or from about 50 wt % to about 70 wt %.

Weight percent of multifunctional microspheres in compositions or coating solutions will vary depending on numerous factors, such as for example, the intended mode of application, the material surface to be coated, the size of the microspheres, etc. In an embodiment, weight percent is less than 1 wt %. Such compositions may be advantageous for coating certain material surfaces such as, for example, fabrics. In another embodiment, weight percent is 100 wt %; in this embodiment, multifunctional microspheres are in solid form, e.g., provided as a dry powder. Dry powders may be used, e.g., to provide powder coatings. Powder coatings are generally applied electrostatically as free-flowing, dry powders, and then cured (e.g., by heating). Such coatings can create a hard finish that is more durable than conventional paint and are often used to coat metals, such as, e.g., household appliances, aluminum, automobile parts, and bicycle parts.

Amphiphobic coatings may be applied using any methods known in the art. Methods of application are selected by a skilled artisan based on, for example, form of an amphiphobic coating (e.g., solid, liquid, aerosol, paste, emulsion, dispersion, etc.), material surface to be coated, intended use, etc. For example, coatings may be sprayed, brushed, painted, printed, stamped, wiped (e.g., applied to a cloth or a wipe which is used to wipe a coating onto a material surface), sponged, rolled, spin-coated or electrostatically sprayed onto a material surface, or a material surface may be dipped, submerged or soaked in a solution containing multifunctional microspheres of the invention, and so on. Coatings may also be applied by soaking a material surface, e.g., particles, fabric, cotton, etc., in a coating solution containing multifunctional microspheres of the invention, and then removing solvent, for example by distillation or rota-evaporation. Coatings may also be applied in solid form, for example as a dry powder.

Amphiphobic coatings prepared using multifunctional microspheres and methods described herein can have a broad range of thicknesses, depending for example on microspheres or compositions employed and application processes used. In some embodiments, amphiphobic coatings have a thickness in a range of hundreds of nanometers to millimeters. In an embodiment, average thickness of an amphiphobic coating is from micrometers to tens of micrometers. In an embodiment, average size of a multifunctional microsphere of the invention is from about 100 nm to about 1000 nm in diameter. In an embodiment, average size of a multifunctional microsphere of the invention is from about 50 nm to about 5000 nm in diameter. In an embodiment, average thickness of an amphiphobic coating comprising a multifunctional microsphere of the invention is from about 1 to about 200 micrometers.

In some embodiments, multiple coatings may be applied to a material surface, e.g., multiple coating layers of multifunctional microspheres may be applied.

Performance of amphiphobic coatings described herein may be measured by any of a variety of tests, which are relevant to a coating's ability to perform under a variety of circumstances. In an embodiment, amphiphobic coatings described herein provide water- and oil-repellency and/or water- and oil-resistance. In some embodiments, coatings described herein can resist loss of amphiphobicity when challenged in a mechanical abrasion test. Mechanical durability of coatings described herein may be assessed using either manual or automated tests (e.g., Taber Abraser testing). In other embodiments, coatings described herein can withstand laundry washing cycles. Coatings described herein may also be UV-resistant in some embodiments. In other embodiments, coatings described herein are stable and/or durable to environmental conditions such as low temperatures, wetting, salt, ice formation, or the like, indicating that they can be employed in a variety of harsh environments for purposes such as prevention of ice formation and accumulation.

Amphiphobic coatings of the invention may be tested for performance, stability, durability, resistance to washing, acid and base-resistance, etc. using methods described herein (e.g., in the examples) as well as methods known in the art. Appropriate performance testing and parameters are selected by a skilled artisan based on several factors, such as desired properties, material surface to be coated, application, use, etc. In some embodiments, properties of amphiphobic coatings are determined using standardized techniques known in the art, such as ASTM tests or techniques described in Example 9. In an embodiment, amphiphobic coatings provide performance parameters given in Example 9.

The terms “robust” and “durable” are used interchangeably herein to refer to amphiphobic coatings which do not readily come off a material surface. These terms are used to refer to coatings which do not generally degenerate or deteriorate, i.e., which do not readily undergo a progressive impairment in quality, functioning or physical condition. Sometimes the words “stable” and “stability” are also employed herein in this context. Requirements for robustness and durability vary depending on application. Performance parameters are generally set and tested based on industry standards and using conventional techniques. In one embodiment, robustness and durability refer to ability to withstand washing, e.g., laundry washing cycles. In other embodiments, robustness and durability refer to ability to withstand environmental conditions, such as abrasion, cold, ice, salt, and/or wind, which may generally cause coatings to peel, crack, fall off or otherwise deteriorate. In a particular embodiment, durability refers to ability to retain at least 90%, 80%, 70%, 50%, or 10% functionality after 3000 hours at a temperature of 85° C. In another embodiment, durability or other parameters are determined based on results in an ASTM (ASTM International) test.

The terms “resistance” and “repellence” are used interchangeably herein to refer to ability of a coating to resist or repel a substance.

In some embodiments, coatings provided herein are flexible, allowing use to coat materials such as cables, flexible tapes, and so on.

To coat a material surface, a multifunctional microsphere of the invention may be used in a solvent, e.g., an organic solvent or an aqueous solvent (e.g., water), optionally in combination with additives. Multifunctional microspheres may be used in any of the forms described herein, e.g., in a solvent (e.g., an organic solvent), in aqueous solution, as an emulsion, a dispersion, in combination with a plasticizer and/or other additives, in coating formulations (e.g., a paste or a paint), etc. Non-limiting examples of solvents which may be used to solubilize or disperse a multifunctional microsphere include alkanes, alkenes, aromatics, alcohols, ethers, ketones, esters, aldehydes, halogenated alkanes, halogenated alkenes, halogenated aromatics, halogenated alcohols, halogenated ethers, halogenated ketones, halogenated esters, or combinations thereof. In an embodiment, a solvent is trifluorotoluene (TFT, i.e., C₇H₅F₃ or C₇F₃H₅), tetrahydrofuran (THF), methanol or perfluorinated cyclohexane. In another embodiment, a solvent is an aqueous solvent, e.g., water. A solvent is chosen by a skilled artisan based on multifunctional microspheres used, desired reaction conditions, substrates or material surfaces to be coated, and so on.

In an embodiment, multifunctional microspheres are used with an additive, such as, e.g., a plasticizer. Many plasticizers are known in the art. Plasticizers may be naturally occurring or man-made. Non-limiting examples of plasticizers for use with multifunctional microspheres described herein include THF, amyl acetate, dimethyl phthalate, dibutyl phthalate, butyl acetate, glyceryl triacetate, dibutyl oxylate, diethyl oxylate, triethyl phosphate, tributyl phosphate, xylene, chloroform, 1,2-dichlorethane, and bromoform. In one embodiment, a phthalate-based plasticizer is used, such as bis(2-ethylhexyl) phthalate (DEHP), diisononyl phthalate (DINP), bis(n-butyl)phthalate (DnBP, DBP), butyl benzyl phthalate (BBzP), diisodecyl phthalate (DIDP), di-n-octyl phthalate (DOP or DnOP), diisooctyl phthalate (DIOP), diethyl phthalate (DEP), diisobutyl phthalate (DIBP), di-n-hexyl phthalate or dimethyl phthalate.

A plasticizer is chosen by a skilled artisan based on the multifunctional microspheres used, desired reaction conditions (e.g., organic solvent vs. aqueous solution), etc. It should be understood that a chosen plasticizer should solubilize multifunctional microspheres. In a particular embodiment, a plasticizer is miscible with water. In another embodiment, a plasticizer is immiscible with water.

In some embodiments, multifunctional microspheres are used with an additive. Additives may be used, for example, to stabilize an emulsion, to stabilize a formulation, to provide additional functional properties, to facilitate grafting to a substrate or material surface, etc. Non-limiting examples of additives include thermo- or photo-initiators, redox initiators, fluorinated initiators, catalysts, dihalogenated hydrocarbons, diamines, UV-absorbers, particles, softeners, surfactants, anti-static compounds, and dyes. In some embodiments, multifunctional microspheres are used with both a plasticizer and an additional additive. In certain embodiments, one or more than one additive is used.

Multifunctional microspheres may be provided in many different forms for use to prepare an amphiphobic coating on a material surface. For example, multifunctional microspheres may be provided in solid form, e.g., as a powder. Alternatively, coated particles may be provided in a suspension in a liquid or in aerosol form, with or without a plasticizer and/or other additives. In some embodiments, multifunctional microspheres are provided in an emulsion, a dispersion, a solution and/or a paste. Multifunctional microspheres according to the invention may be provided in coating formulations, such as water-based paints, oil-based paints, varnishes, finishes, resins, polishes, pastes, wax forms, gel forms, etc. In an embodiment, multifunctional microspheres are provided in an aqueous solution in presence of a plasticizer, with or without other additives. Typically, multifunctional microspheres provided in solid form (e.g., as a powder), are combined with a solvent or liquid before use to prepare an amphiphobic coating on a material surface. In an embodiment, multifunctional microspheres are used in solid form to provide a powder coating on a material surface.

In an embodiment, multifunctional microspheres are provided in a Volatile Organic Compound (VOC)-free aqueous solution, emulsion or suspension comprising about 80% water, multifunctional microspheres, a plasticizer and a surfactant. In some embodiments, multifunctional microspheres are provided in a Volatile Organic Compound (VOC)-free aqueous solution, emulsion or suspension comprising about 80% water, about 90% water, about 95% water, about 80% to about 95% water, about 90% to about 98% water, or about 95% to about 99% water; multifunctional microspheres; a plasticizer; and a surfactant.

In certain embodiments, multifunctional microspheres are used in a suspension or emulsion. In some embodiments, multifunctional microspheres are used in combination with latex paint, water-based paint, alcohol-based paint or oil-based paint. In further embodiments, multifunctional microspheres are dispersed in a solvent for use, optionally in the presence of additives.

A variety of substrates can be used to form multifunctional microspheres described herein and a variety of material surfaces can be coated using multifunctional microspheres described herein. These include but are not limited to metal oxides, semi-conductor oxides, metals, metalloids, metal oxides, concretes, clay particles, sand particles, cement particles, saw dust, semiconductors, particles, glasses, ceramics, papers and textile fibers, or material surfaces comprising these materials. In some embodiments, material surfaces to be coated will be in the form of plates (e.g., metal plates), sheets (e.g., metal sheets) or ribbons (e.g., metal ribbons).

Many applications are possible for amphiphobic material surfaces and coatings. For example, buildings (e.g., skyscrapers) with amphiphobic walls would require no or minimal cleaning. Ice would not likely form or build up on amphiphobic surfaces of power cables, which can minimize damage from freezing rain or ice storms. Amphiphobic coatings on metal surfaces can reduce metal rusting and corrosion. Amphiphobic coatings can be used to produce paper and paperboard for food-contact applications, such as pizza boxes and sandwich wraps. Amphiphobic coatings may be used to prepare glasses and ceramics that are self-cleaning, or to provide arc-resistant coatings on insulators used in electrical transmission systems where dirt or salt deposits, alone or in combination with water, can allow arcing with significant electrical energy losses. For cement and masonry products, amphiphobic coatings can provide products and material surfaces resistant to damage in freezing weather from water that has penetrated the material surfaces. As another example, amphiphobic coatings can be used to prepare paper products and fabrics which are resistant to water and moisture, including, but not limited to: paper and, fabric moisture barriers used for insulation and under shingles or roofing; cardboard tubes or pipes, for example used to cast concrete pillars (water penetrating the seams of such tubes can leave seams and other defects in the pillars that need to be fixed by grinding operations); and water-resistant paper and cardboard packaging. Amphiphobic coatings can be used to prepare products which are salt water-resistant, for example for underwater applications such as ship hulls, submarines, and other marine applications.

In some embodiments, amphiphobic coatings described herein can be used to prepare material surfaces which are anti-wetting, anti-icing, anti-corrosion, anti-rust, anti-scratching, anti-staining, anti-bacterial, abrasion resistant, anti-fingerprint marking, anti-smudging, anti-graffiti, acid-resistant, base-resistant, resistant to chemicals, resistant to organic solvents, resistant to etching and/or self-cleaning. Material surfaces coated with multifunctional microspheres described herein may resist spills, resist stains, resist soiling, release stains, have improved cleanability, have improved alkaline resistance, have improved acid resistance, have improved resistance to organic solvents, have improved resistance to chemical penetration (e.g., improved resistance to organic chemicals), have improved resistance to corrosion, and/or have improved durability compared to uncoated material surfaces.

In some embodiments, amphiphobic coatings described herein can be used to prepare plastic or glass surfaces which are smudge-resistant, scratch resistant and/or stain resistant. Such plastic and glass surfaces may be found, for example, on electronic devices. Electronic devices can be portable (e.g., cellular phones; smartphones (e.g., iPhone™, Blackberry™); personal data assistants (PDAs); tablet devices (e.g., iPad™); game players (e.g., PlayStation Portable (PSP™), Nintendo™ DS); laptop computers; etc.), or not portable (e.g., computer monitors; television screens; kitchen appliances; etc.).

In some embodiments, amphiphobic coatings described herein provide material surfaces which are highly water- and oil-repellent. Contact angle of water and/or oil on a coated material surface may be about 90 degrees or greater, about 100 degrees or greater, about 110 degrees or greater, about 120 degrees or greater, about 130 degrees or greater, about 150 degrees or greater, about 90 degrees, about 110 degrees, about 120 degrees, about 150 degrees, about 160 degrees, or about 170 degrees. It should be understood that contact angles cannot be greater than 180 degrees, which is the theoretical maximum angle possible.

In further embodiments, amphiphobic coatings described herein provide material surfaces which resist adhesion of biological materials. For example, anti-adherent material surfaces comprising multifunctional microspheres of the invention are provided which repel proteins, bacteria, dirt, grime, soil, fungi, viruses, microbes, yeast, fungal spores, bacterial spores, gram negative bacteria, gram positive bacteria, molds and/or algae. Such material surfaces may also resist adherence of biological or bodily fluids such as blood, sputum, urine, feces, saliva, and/or perspiration/sweat. In a particular embodiment, amphiphobic coatings reduce or prevent microscopic animals such as dust mites and bedbugs from colonizing in mattresses, bedding, upholstery and/or carpeting.

Amphiphobic coatings described herein can be applied to any material surface to which a multifunctional microsphere of the invention can adhere, optionally with adhesive, either temporarily or permanently. Material surfaces may be flexible or rigid. In some embodiments a material surface can be made from a material which is fabric, glass, metal, metalloid, metal oxide, ceramic, wood, plastic, resin, rubber, stone, concrete, a semiconductor, or a combination thereof. In some embodiments, material surfaces may comprise metalloids (e.g., B, Si, Sb, Te and Ge).

Any glass can be employed as a material surface for amphiphobic coatings according to the invention, including, without limitation: soda lime glass, borosilicate glass, sodium borosilicate glass, aluminosilicate glass, aluminoborosilicate glass, optical glass, fiberglass, lead crystal glass, fused silica glass, germania glass, germanium selenide glass, and combinations thereof.

Any metal can be employed as a material surface for amphiphobic coatings according to the invention, including, without limitation: iron, nickel, chrome, copper, tin, zinc, lead, magnesium, manganese, aluminum, titanium silver, gold, platinum, and combinations thereof, or alloys comprising those metals. Metal oxides may also be present in substrates or material surfaces. In one embodiment, a metal forming a material surface comprises steel or stainless steel. In another embodiment, a metal used for a material surface is chromium, is plated with chromium, or comprises chromium or a chromium coating.

Any ceramic can be employed as a material surface for amphiphobic coatings according to the invention, including, without limitation: earthenware (typically quartz and feldspar), porcelain (e.g., made from kaolin), bone china, alumina, zirconia, and terracotta. For the purpose of this disclosure, a glazing on a ceramic may be considered either as a ceramic or a glass.

Any wood can be employed as a material surface for amphiphobic coatings according to the invention, including, without limitation, hard and soft woods. In some embodiments, woods may be selected from alder, poplar, oak, maple, cherry, apple, walnut, holly, boxwood, mahogany, ebony, teak, luan, and elm. In other embodiments, woods may be selected from ash, birch, pine, spruce, fir, cedar, and yew.

Any plastic or resin can be employed as a material surface for amphiphobic coatings according to the invention, including, without limitation, polyolefins (such as a polypropylene and polyethylene), polyvinylchloride plastics, polyamides, polyimides, polyamideimides, polyesters, aromatic polyesters, polycarbonates, polystyrenes, polysulfides, polysulfones, polyethersulfones, polyphenylenesulfides, phenolic resins, polyurethanes, epoxy resins, silicon resins, acrylonitrile butadiene styrene resins/plastics, methacrylic resins/plastics, acrylate resins, polyacetals, polyphenylene oxides, polymethylpentenes, melamines, alkyd resins, polyesters or unsaturated polyesters, polybutylene terephthlates, combinations thereof, and the like.

Any rubber can be employed as a material surface for amphiphobic coatings according to the invention, including, without limitation: natural rubber, styrene-butadiene rubber, butyl rubber, nitrile rubber, chloroprene rubber, polyurethane rubber, silicon rubber, and the like.

Any type of stone, concrete, or combination thereof can be employed as a material surface for amphiphobic coatings according to the invention, including, without limitation, igneous, sedimentary and metamorphic stone (rock). In one embodiment the stone is selected from granite, marble, limestone, hydroxylapatite, quartz, quartzite, obsidian and combinations thereof. Stone may also be used in the form of a conglomerate with other components such as concrete and/or epoxy to form an aggregate that may be used as a material surface upon which an amphiphobic coating may be applied.

Amphiphobic coatings, i.e., multifunctional microsphere coatings, described herein can be applied to material surfaces using any means known in the art, including but not limited to, brushing, painting, printing, stamping, rolling, dipping, spin-coating, spraying, or electrostatic spraying. Generally, material surfaces will be rigid or semi-rigid, but material surfaces can also be flexible, for example in the instance of wire and tapes or ribbons.

Non-limiting examples of types of amphiphobic coatings which may be prepared using multifunctional microspheres and methods described herein include: fabric coatings, textile coatings, decorative coatings, transportation coatings, wood finishes, powder coatings, coil coatings, packaging finishes, general industrial finishes, automotive paint (including refinishing paint), industrial maintenance and protective coatings, marine coatings, and other industrial coatings.

Non-limiting examples of applications of these types of coatings include: furniture (e.g., wood and metal furniture, outdoor furniture, office or commercial furniture, fixtures, casual furniture); motor vehicles; metal building components; industrial machinery and equipment; applicances (e.g., kitchen appliances, laundry appliances); aerospace equipment; packaging (e.g., interior and exterior of metal cans, flexible packaging, paper, paperboard, film and foil finishes); electrical insulation coatings; consumer electronic products (e.g., cell phones, tablet devices, MP3 players, cameras, computers, displays, monitors, televisions); coil coatings (e.g., coils, sheets, strips, and extrusion coatings); automotive refinishing (e.g., aftermarket repair and repainting); industrial settings (e.g., protective coatings for interior and exterior applications); routine maintenance to protect buildings (e.g., protection from corrosive chemicals, exposure to fumes, and temperature extremes); process industries (e.g., protection from corrosive or highly acidic chemicals); roads and bridges; and marine applications (e.g., boats, antifouling, ice resistance, equipment anticorrosion). It is apparent from these examples that coatings may be applied to articles pre-market, i.e., before, during or after manufacturing and before sale, or post-market, e.g., for maintenance and protective uses.

Amphiphobic coatings, i.e., multifunctional microsphere coatings, described herein can be applied to virtually any material or material surface to provide amphiphobic properties. Choice of coating forms and processes for applying coatings are determined by a skilled artisan, based on factors such as chosen material surface, application, use, etc. Amphiphobic coatings may take any desired shape or form, limited only by the manner and patterns in which they can be applied. In some embodiments, an amphiphobic coating completely covers a material surface. In other embodiments, an amphiphobic coating covers only a portion of a material surface, such as one or more of a top, side or bottom of an object. In one embodiment, an amphiphobic coating is applied as a line or strip on a substantially flat or planar material surface. In such an embodiment the line or strip may form a spill-resistant border.

Shape, dimensions and placement of amphiphobic coatings on material surfaces can be controlled by a variety of means including the use of masks which can control not only portions of a material surface that receive an amphiphobic coating, but also portions of a material surface that may receive prior treatments such as application of a primer layer or cleaning by abrasion or solvents. For example, sand blasting or chemical treatment may be used to prepare a portion of a material surface for coating, e.g., to generate desired material surface roughness or to clean a material surface. Where a portion of a material surface is prepared in this way, a mask resistant to those treatments would be selected (e.g., a mask such as a rigid or flexible plastic, resin, or rubber/rubberized material). Masking may be attached to a material surface through use of adhesives, which may be applied to a mask agent, a material surface, or both.

In another embodiment, an amphiphobic coating is applied to a ribbon, tape, or sheet that may then be applied to a material surface by any suitable means including adhesive applied to the material surface, the ribbon, tape, or sheet, or a combination thereof. Ribbons, tapes and sheets bearing an amphiphobic coating may be employed in a variety of applications, including forming spill-proof barriers on material surfaces. Such ribbons, tapes, and sheets can be applied to any type of material surface including metal, ceramic, glass, plastic, or wood surfaces, for a variety of purposes.

In some embodiments, amphiphobic coatings may be used to form a border on a material surface. An amphiphobic “border” is a portion of a material surface forming a perimeter around an area of the material surface that has lower amphiphobicity than the border. Amphiphobic borders can prevent water and other liquids from spilling, spreading or flowing beyond the position of the border. A spill-resistant border could be prepared, for example, by applying an amphiphobic coating to a portion of a material surface (with or without use of a mask), or by applying a tape or a ribbon to a material surface, where one surface of the tape or ribbon is treated with an amphiphobic coating.

In some cases, amphiphobic coatings of the invention are referred to as amphiphobic “particulate” coatings, reflecting the inclusion of multifunctional particles in the coatings. The particulate nature and the roughness of an amphiphobic coating of the invention will vary depending on several factors such as, for example, the size and composition of the particles used.

To improve adherence of amphiphobic coatings to a material surface, a material surface may be treated or primed, such as by abrasion, cleaning with solvents or application of one or more undercoatings or primers. In some embodiments where metals can be applied to surfaces (e.g., by electroplating, vapor deposition, or dipping) and it is deemed advantageous, material surfaces may be coated with metals prior to application of an amphiphobic coating described herein.

Amphiphobic coatings may also be permanent or temporary, depending on methods used for application onto a material surface. In general, curing or, annealing a coating onto a material surface (e.g., by heating or exposing to UV) will provide a permanent coating which is durable, as defined herein. Alternatively, certain coatings applied without curing or annealing may be temporary, removable and/or short-lived, since chains that are not crosslinked or covalently attached to a material surface may be lost due to surface scratching or may be rinsed away by solvents or water.

Amphiphobic coatings prepared using multifunctional microspheres of the invention may have a variety of finishes. A coating finish may be transparent, translucent, or opaque. In an embodiment, a finish is transparent and colorless.

As discussed above, a wide variety of articles may be coated with multifunctional microspheres of the invention. Non-limiting examples of such articles include metal plates, metal sheets, metal ribbons, wires, cables, boxes, insulators for electric equipment, roofing materials, shingles, insulation, pipes, cardboard, glass shelving, glass plates, printing paper, metal adhesive tapes, plastic adhesive tapes, paper adhesive tapes, fiber glass adhesive tapes, boats, ships, boat hulls, ship hulls, submarines, bridges, roads, buildings, motor vehicles, electronic devices, machinery, furniture, aerospace equipment, packaging, medical equipment, surgical gloves, shoe waxes, shoe polishes, floor waxes, furniture polishes, semiconductors, solar cells, solar panels, windmill blades, aircraft, helicopters, pumps, propellers, railings, and industrial equipment.

In some embodiments, a coated article's breathability, flexibility, softness, appearance, feel and/or hand is substantially the same as that of an uncoated article.

In some embodiments, a coated article has improved cleanability, durability, water-repellence, oil-repellence, soil-resistance, biological species-resistance, bodily fluid-resistance, ice-resistance, salt-resistance, salt water-resistance, acid-resistance, base-resistance, stain-resistance, organic solvent-resistance, flame-resistance, anti-fouling properties, anti-bacteria adhesion properties, anti-virus-adhesion properties, anti-adhesion properties (e.g., anti-contaminant adhesion properties), anti-flow resistance (e.g., for underwater uses, swimming), anti-flame properties, self-cleaning properties, anti-rust properties, anti-corrosion properties, anti-etching properties, anti smudge properties, anti-fingerprint properties, and/or ability to control moisture content, compared to an uncoated article.

In some embodiments, highly water and oil repellent textiles can be obtained by depositing an amphiphobic coating on fibers or fabrics. It should be understood that any fibrous surface or fabric which can bind multifunctional microspheres of the invention may be used. Such fibrous surfaces include fibers, woven and non-woven fabrics derived from natural or synthetic fibers and blends of such fibers, as well as cellulose-based papers, leather and the like. They can comprise fibers in the form of continuous or discontinuous monofilaments, multifilaments, staple fibers and/or yarns containing such filaments and/or fibers, and the like, which fibers can be of any desired composition. The fibers can be of natural, manmade or synthetic origin. Mixtures of natural fibers and synthetic fibers can also be used. Included with the fibers can be non-fibrous elements, such as particulate fillers, binders and the like. Fibrous surfaces that can be coated according to the invention include fabrics and textiles, and may be a sheet-like structure comprising fibers and/or structural elements. A sheet-like structure may be woven (including, e.g., velvet or a jacquard woven for home furnishings fabrics) or non-woven, knitted (including weft inserted warp knits), tufted, or stitch-bonded.

Non-limiting examples of natural fibers include cotton, wool, silk, jute, linen, ramie, rayon and the like. Natural fibers may be cellulosic-based fabrics such as cotton, rayon, linen, ramie and jute, proteinaceous fabrics such as wool, silk, camel's hair, alpaca and other animal hairs and furs, or otherwise. Non-limiting examples of manmade fibers derived primarily from natural sources include regenerated cellulose rayon, cellulose acetate, cellulose triacetate, and regenerated proteins. Examples of synthetic fibers include polyesters (including poly(ethylene glycol terephthalate)), polyamides (including nylon, such as Nylon 6 and 6,6), acrylics, polypropylenes, olefins, aramids, azlons, modacrylics, novoloids, nytrils, spandex, vinyl polymers and copolymers, vinal, vinyon, and the like, and hybrids of such fibers and polymers. Leathers and suedes are also included.

Amphiphobic coated textiles may reject most pollutants (e.g., naturally-occurring pollutants, chemical pollutants, biological pollutants, etc.) and are not easily soiled. They may show improved properties such as water resistance, soil resistance, oil resistance, grease resistance, chemical resistance, abrasion resistance, increased strength, enhanced comfort, detergent free washing, permanent press properties such as smoothness or wrinkle resistance, durability to dry cleaning and laundering, minimal requirement for cleaning, and/or quickness of drying. Such textiles can be used to make, for example, contamination-free canvases, tents, parachutes, backpacks, flags, handkerchiefs, tablecloths, napkins, kitchen aprons, bibs, baby clothes, lab coats, uniforms, insignias, rugs, carpets, and ties.

In some embodiments, an advantage of amphiphobic coatings provided herein is that coatings do not affect desirable properties of a fabric such as breathability, flexibility, softness, and/or the feel (hand) of the fabric. Amphiphobic fabrics can thus be used to make clothing and apparel. For example, socks, hosiery, underwear, garments such as jackets, coats, shirts, pants, uniforms, wet suits, diving suits and bathing suits, fabrics for footwear, and shoes can be coated. Home furnishing fabrics for upholstery and window treatments including curtains and draperies, bedding items, bedsheets, bedspreads, comforters, blankets, pillows or pillow coverings, fabrics for outdoor furniture and equipment, car upholstery, floor coverings such as carpets, area rugs, throw rugs and mats, and fabrics for industrial textile end uses may also be coated. Coating of materials such as cotton may, for example, alter properties of the cotton, such as water/soil repellence or permanent press properties. Cotton-containing materials may be coated after procedures such as dyeing of the cotton. Cotton materials may be provided as a blend with other natural and/or synthetic materials.

Amphiphobic fabrics can thus be used to make clothing and apparel. In some embodiments, amphiphobic coatings are used on leather products, such as leather jackets, leather shoes, leather boots, and leather handbags. Amphiphobic coatings may also be used on suede products.

Amphiphobic coatings may be applied to textiles before manufacture of an article, e.g., before manufacture of an article of clothing, or coatings may be applied after an article has been made. In some cases, coatings may be applied by a retailer or by a consumer after purchase.

In an embodiment, amphiphobic coatings provided herein have antifouling properties. Biofouling occurs widely and can have deadly consequences when it occurs on surgical equipment, implant devices, and food packing materials. Biofouling can also occur on ship hulls, and the growth of barnacles, algae, and fungi on ship hulls leads to increased drag, resulting in increased operational and maintenance costs. Such marine organisms often attach to ship hulls by secreting protein and glycoprotein glues. Polymers such as poly(ethylene glycol) (PEG) can repel the deposition of many proteins. It has also been demonstrated that organism deposition is reduced on rugged surfaces (Carman, M. L. et al., Biofouling, 22, 11-21 (2006)). Thus, it is expected that multifunctional microspheres comprising, e.g., PEG and fluorinated polymer blocks, can be used to provide amphiphobic coatings with anti-fouling properties. In an embodiment, there are provided herein multifunctional microspheres, e.g., silica particles, bearing (I) surface carboxyl groups capable of reacting with an adhesive, e.g., an epoxy glue, (ii) PEG, and (iii) fluorinated polymer chains. In an embodiment, tri-functional microspheres, e.g., tri-functional silica particles, bearing (i) surface poly(acrylic acid), (ii) PEG, and (iii) fluorinated polymer chains, are provided herein.

### EXAMPLES

The present invention will be more readily understood by referring to the following examples, which are provided to illustrate the invention and are not to be construed as limiting the scope thereof in any manner.

Unless defined otherwise or the context clearly dictates otherwise, all technical and scientific terms used herein have the same meaning as commonly understood by one of ordinary skill in the art to which this invention belongs. It should be understood that any methods and materials similar or equivalent to those described herein can be used in the practice or testing of the invention.

### Example 1

### Amphiphobic Material Surface Coatings Prepared with Fluorine-Containing Bi-Functional Polymer Microspheres

### A. Preparation of Fluorine-Containing Bi-Functional Polymer Microspheres

The following materials were used: Monomeric hydroxylethyl acrylate (HEA), methyl methacrylate (MMA), and ethylene glycol dimethacrylate (EGDMA) were purchased from Aldrich Inc., and were purified by vacuum distillation prior to use. Monomeric acrylic acid and 2-chloropropionic acid ethylene glycol diester were prepared by the method reported in the literature (Ming, W. et al., Nano Lett., 2005, 5: 2298-2301). Azobisisobutyronitrile (AIBN) was purchased from Fisher Scientific Inc., and purified by recrystallization in ethanol prior to use. Substantially all other ingredients were purchased from Aldrich Inc., and did not undergo any special treatment prior to use.

Steps for preparing fluorine-containing bi-functional polymer microspheres were as follows: Under stirring, a mixture of 130 mL distilled water, 4.80 g (48.0 mmol) methyl methacrylate, and 0.4 g (2.0 mmol) ethylene glycol dimethacrylate was gradually added to a 500-mL three-neck flask, together with 41 mg (0.15 μmol) of an aqueous solution of potassium persulfate (5 mL). The reaction system was left at room temperature for 15 minutes under nitrogen blanketing to eliminate any oxygen in the system. Thereafter, the same was heated in an oil bath to 90° C. and then allowed to react for two hours.

From the reaction system, 43 mL solution was removed and added to a 250-mL three-neck flask filled with nitrogen; also added was 0.5 mL of a tetrahydrofuran solution in which 2.4 mg (14.6 μmol) azobisisobutyronitrile was dissolved. The same was then stirred for 15 minutes at room temperature and thereafter heated to 90° C. Afterwards, a mixture containing 0.4 g (1.9 mmol) 2-chloropropionic acid ethylene glycol ester, 40 μL (0.21 μmol) ethylene glycol dimethacrylate, and 0.67 g (6.7 mmol) methyl methacrylate was added slowly. Once adding was complete, the same was continuously reacted for four hours to obtain polymer microspheres possessing a core-shell structure.

In a 50 mL reaction flask, 13.6 mg of the aforesaid core-shell polymer microspheres was dispersed in a 5 mL mixed solution of ethanol and water at a volume ratio of 1:1. Thereafter, 23 mg (0.16 mmol) cuprous bromide, 2.3 mg (0.010 mmol) copper bromide, 64.5 mg (0.28 mmol) tri-(N,N-dimethylaminoethyl) amine (Me₆TREN), and 0.3728 g (3.21 mmol) hydroxyethylene acrylate were added in succession. The reaction system underwent three rounds of a cycle of freezing, vacuum-pumping, thawing, and nitrogen blanketing, and was then reacted for ten hours at 75° C. Products were passed through aqueous dialysis to remove the catalyst system and other small molecule impurities. After drying, a powder of polymer microspheres having a core-shell structure was obtained.

Core-shell polymer microspheres were dissolved in dry pyridine and formulated so as to attain a 5 mg/mL solution. Under stirring, 25 mg perfluorononanoyl chloride was slowly added to the pyridine solution of microspheres and then reacted for 18 hours at room temperature. The precipitate was separately washed three times with pyridine and ethanol to remove impurities from the system, obtaining fluorine-containing bi-functional polymer microspheres. NMR profile showed that 80% of poly(hydroxyethyl acrylate) on sphere surfaces had reacted with the perfluorononanoyl chloride.

### B. Application of Fluorine-Containing Bi-Functional Polymer Microspheres

Fluorine-containing bi-functional polymer spheres were dispersed in α,α,α-trifluorotoluene at a concentration of 5 mg/mL. A glass surface was wiped clean with ethanol. An epoxy resin adhesive was mixed with a curing agent therefor at a volume ratio of 2:1 and then coated with a spin-coating device onto the clean glass surface and cured in air for 0.5 hours.

The α,α,α-trifluorotoluene solution of polymer spheres was evenly sprayed onto the adhesive surface and then cured for another two hours at 60° C. Afterwards, the adhesive surface was placed in a 100° C. oven for 0.5 hours.

### C. Performance Testing of the Coating Made in (B)

A Krüss surface tensiometer was used to test surface properties of the coating made in (B) above. Results showed that after the epoxy resin adhesive had cured, a water droplet on the surface had a contact angle less than 90°. After coating fluorine-containing bi-functional polymer microspheres on the surface, a water droplet on the surface had a contact angle greater than 160°, and diiodomethane on the surface also had a contact angle greater than 150°. These results indicate that fluorine-containing bi-functional polymer microspheres have excellent properties in terms of rendering a glass surface amphiphobic.

For the sake of comparison, a different polymer thin film of poly(cinnamoyloxyethyl methacrylate) (PCEMA) was also prepared. Double bonds on the surface of the thin film were polymerized by ultraviolet light and converted to saturated carbon-hydrogen bonds, lacking in any active reaction sites, such that no reaction would occur with hydroxyl groups on polymer microsphere surfaces. A spin-coating method was used to prepare the polymer thin film on a glass surface. Once the thin film had dried, ultraviolet light was used first to allow crosslinking for 15 minutes, creating a crosslinked layer on the glass surface (test results have shown that after 15 minutes of crosslinking, 48% of the double bonds in a PCEMA thin film are excited and undergo a crosslinking reaction; crosslinked double bonds are primarily concentrated in the top layer of the thin film). Afterwards, fluorine-containing polymer microspheres were coated thereon and crosslinking was repeated for two hours to cause the entire polymer thin film to cure. Shortly thereafter, the two glass sheets (one having the fluorine-containing bi-functional polymer microspheres coated on a PCEMA surface, the other having the fluorine-containing bi-functional polymer microspheres coated on an adhesive surface) were separately placed in α,α,α-trifluorotoluene and allowed to sit overnight under stirring. Subsequently, atomic force microscopy revealed that polymer microspheres had fallen off the thin film PCEMA surface due to the effects of stirring, while polymer microspheres were favorably retained on the thin film adhesive surface. After drying, the adhesive thin film coated with polymer spheres retained favorable amphiphobic properties, as a water droplet on the surface thereof had a contact angle greater than 160°, and diiodomethane on the surface thereof had a contact angle greater than 150°.

### Example 2

### Amphiphobic Material Surface Coatings Prepared with Fluorine-Containing Bi-Functional Silica Microspheres

### A. Preparation of Block Copolymers

The following materials were used: 3-(triisopropyloxysilyl)propyl methacrylate (IPSMA) was prepared as reported (Ozaki, H. et al., Macromolecules, 1992, 25: 1391-1395). Heptadecafluorooctyl ethyl methacrylate (F₈H₂MA or FOEMA) was purchased from Aldrich Inc., and purified prior to use by a vacuum distillation method as reported (Ishizone, T. et al., Polymer Journal, 1999, 31: 983-988). Tert-butyl acrylate (tBA) was purchased from Aldrich Inc., and purified prior to use by vacuum distillation.

Steps for preparing fluorine-containing bi-functional silica microspheres were as follows: Polymers poly(3-(triisopropyloxysilyl)propyl methacrylate-block-poly(heptadecafluorooctyl ethyl methacrylate) (PIPSMA-b-PFOEMA) and poly[3-(triisopropyloxysilyl)propyl methacrylate]-b/ock-poly(tert-butyl acrylate) (PIPSMA-b-PtBA) were prepared prior to use through an anionic polymerization method.

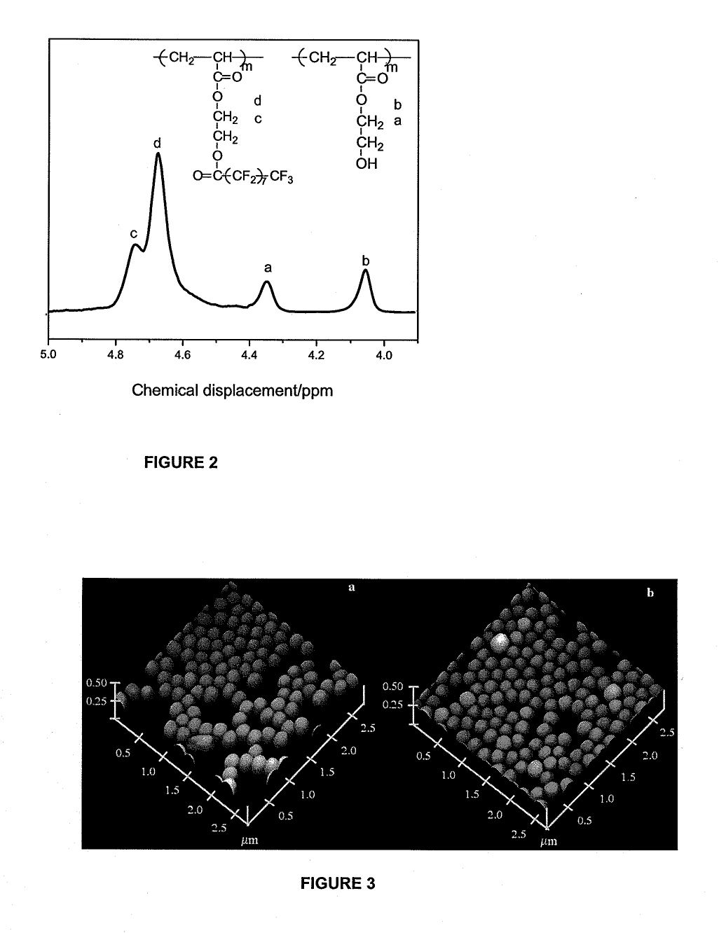

Results of a gel exclusion chromatography run on the PIPSMA-b-PFOEMA showed that the number average molecular weight of the polymer was 8.6×10³ g/mol, and the dispersibility index was 1.16. NMR analysis (FIG. 2) showed that the molar ratio of IPSMA and FOEMA in the polymer was 1.0/1.0. Combining the results from chromatography and NMR, it was verified that polymer structure was (IPSMA)₁₀-(FOEMA)₁₀.

Gel exclusion chromatography on PIPSMA-b-PtBA verified that the number average molecular weight of the polymer was 1.33×10⁴ g/mol, and the dispersibility index was 1.06. NMR spectra results (FIG. 2) demonstrated that the molar ratio of IPSMA and tBA in the polymer was 1.0/7.0. Combining the results from chromatography and NMR, it was verified that structure of the polymer was (IPSMA)₁₀-(tBA)₇₀.

### B. Preparation of Silica Nanospheres

Silica nanospheres were prepared using the Stober method (Stober, W. et al., J. Colloid Interf. Sci., 1968, 26: 62; Sheen, Y. C. et al., Journal Of Polymer Science Part B-Polymer Physics, 2008, 46: 1984-1990). In isopropanol, tetraethyl siloxane was hydrolyzed with an ammonia catalyst to obtain silica nanospheres having a certain particle diameter. Product was separated by centrifuge and then washed three times with isopropyl alcohol to remove catalyst, unreacted reactants, and by-products. After vacuum drying, a white powder was obtained. The white powder was re-dispersed in ethanol, and then dynamic light scattering was used to determine that silica spheres had a hydrodynamic diameter of 328 nm.

C. Modification of Silica Nanospheres with Block Copolymers

Silica nanospheres were modified with block copolymers as follows: 3.0 mL α,α,α-trifluorotoluene and 5.0 mg silica nanospheres were placed in a 20-mL flask, and the flask was placed in an ultrasonic cleaning device, where 60 seconds of ultrasound were used to disperse silica spheres into the α,α,α-trifluorotoluene. Block copolymers PIPSMA₁₀-b-PtBk₇₀ and PIPSMA₁₀-PFOEMA₁₀ were each made up into 5.0 mg/mL tetrahydrofuran solutions and separately mixed at a volume ratio of 1:4 to obtain a mixed polymer solution. Tetrahydrofuran was used to dilute a 4.0 mol/L hydrochloric acid dioxane solution to a 0.2 mol/L solution. Under stirring, 0.08 mL of the mixed polymer solution, 0.14 mL tetrahydrofuran, 0.08 mL hydrochloric acid solution, and 3.0 μL water were added gradually to the solution of silica nanospheres and the same was reacted for ten hours at 22° C. to obtain a crude product of modified silica nanospheres. The crude product was separated out in a 3050 g centrifuge for ten minutes, and then washed twice with 2.0 mL α,α,α-trifluorotoluene to remove the unreacted polymers, catalyst, and by-products. The product was dried for two hours in a 100° C. oven to obtain a white powder, i.e., modified silica dioxide microspheres, the surface formula of which contained PtBA and PFOEMA polymer chains.

### D. Hydrolysis of PtBA

Trimethyl silane iodide was dissolved in dichloromethane and formulated to attain a 0.05 mol/L solution. Under ultrasonic conditions, modified silica spheres were dispersed into this iodine silane solution of dry dichloromethane. After three days of stirring at room temperature. 0.1 mL water was added and then the same was stirred for three hours, followed by centrifugal separation to obtain a white solid. After three rounds of washing with dichloromethane, product was dried for two hours in an oven and set aside for use.

### E. Preparing a Modified Silica Sphere Coating

Modified silica nanoparticles were again dispersed in α,α,α-trifluorotoluene at a concentration of 5.0 mg/mL. A glass surface was wiped clean with ethanol. An epoxy resin adhesive was mixed with a curing agent therefor at a volume ratio of 2:1 and then coated with a spin-coating device onto the dried glass surface and cured in air for 0.5 hours.

The α,α,α-trifluorotoluene solution of the modified silica nanoparticles was evenly sprayed onto the adhesive surface and then continuously cured for two hours at 60° C. Afterwards, the same was placed in a 100° C. oven for 0.5 hours.

### F. Testing the Amphiphobicity of the Coating Made in Part (E)

A Krüss surface tensiometer K12 was used at room temperature to measure the contact angle of a fluid on the coating created in part (E) above; the instrument comes with image acquisition and analysis software. Volume of the fluid droplet was 5 μL. The experiment used deionized water (surface tension of 72.8 mN/m at 20° C.) and diiodomethane (surface tension of 50.8 mN/m at 20° C.). Results showed that water and diiodomethane on the coated surface of the glass had contact angles of 167° and 151°, respectively. Therefore, the coating formed on the glass surface by modified silica spheres possessed amphiphobic properties.

For the sake of comparison, a different polymer thin film of PCEMA was also prepared; double bonds on the surface of the thin film were polymerized by ultraviolet light and converted to saturated carbon-hydrogen bonds, lacking in any active reaction sites, such that no reaction will occur with hydroxyl groups on polymer microsphere surfaces. A spin-coating method was used to prepare the polymer thin film on a glass surface. Once the thin film had dried, ultraviolet light was used first to allow crosslinking for 20 minutes, creating a crosslinked layer on the glass surface. Afterwards, fluorine-containing polymer microspheres were coated thereon and crosslinking was repeated for two hours to cause the entire polymer thin film to cure. Thereafter, the two glass sheets coated with the fluorine-containing bi-functional polymer microspheres were separately placed in α,α,α-trifluorotoluene and allowed to sit overnight under stirring. Subsequently, atomic force microscopy revealed that polymer microspheres had fallen off the thin film PCEMA surface due to effects of stirring, while polymer microspheres were favorably retained on the thin film adhesive surface. After drying, the adhesive thin film coated with polymer spheres retained favorable amphiphobic properties, as a water droplet on the surface thereof had a contact angle greater than 160°, and diiodomethane on the surface thereof had a contact angle greater than 150°.

### Example 3

### Core Particles

Core particles were prepared by surfactant-free emulsion polymerization of MMA and EGDMA. This technique is well established and should yield uniform spheres (Goodwin, J. W. et al., Colloid Polym. Sci., 1979, 257: 61-69; Li, J. Q. and Salovey, R., J. Polym. Sci.: A: Polym. Chem., 2000, 38: 3181-3187). Our success in using this technique was confirmed by AFM and DLS studies of the particles. FIG. 3a shows an AFM topography image of core particles (denoted as C). The sample comprised uniform spheres. A quantitative analysis yielded an AFM diameter (d_{AFM}) and height (h_{AFM}) of 246±12 and 173±9 nm, respectively, where the number after the ± signs denotes standard deviation in the dimension readings. Thus, relative deviations of d_{AFM} and h_{AFM} values were less than 5%, and in agreement with those expected of particles prepared from emulsion polymerization (Gilbert, R. G., Emulsion Polymerization: A Mechanistic Approach, Academic Press: London, 1995). h_{AFM} value was smaller than corresponding d_{AFM} value because the spheres should have flattened somewhat when they plummeted, together with the spraying solvent, on a material surface during specimen preparation. Also d_{AFM} contained a contribution from the finite size of the AFM tip.

Diameter (dₕ) of C particles probed by DLS was 257 nm with a polydispersity index (K₁²/K₂) of 0.001-0.024 (see Table 1). The dₕ value was slightly larger than d_{AFM} because dₕ and d_{AFM} were the z-average and number-average diameters, respectively. Furthermore, dₕ was measured in a solvated state and d_{AFM} was measured in a dry state. Polydispersity index reading varied from run to run because it was difficult to remove trace amounts of dust particles from the system. If dust particles entered the scattering volume during data acquisition, the calculated K₁²1K₂ value increased for that run. Despite this, all recorded K₁²1K₂ values were low, confirming a narrow distribution of particles.

TABLE 1
Characteristics of spheres at different stages.

| | |
|---|---|
| DLS ^{a} | AFM |

| Sample | dₕ (nm) | K₁²/K₂ | d_{AFM} (nm) | h_{AFM} (nm) |
|---|---|---|---|---|
| C | 257 ± 5 | 0.001~0.024 | 246 ± 12 | 173 ± 9 |
| CS | 323 ± 5 | 0.013~0.015 | 287 ± 15 | 199 ± 11 |
| CSC-1 | 360 ± 6 | 0.003~0.007 | 344 ± 17 | 225 ± 14 |
| CSC-2 | 449 ± 3 | 0.005~0.008 | 383 ± 21 | 248 ± 15 |
| CSC-2F | 473 ± 9 | 0.004~0.007 | 432 ± 16 | 257 ± 14 |
| CSC-3 | 606 ± 8 | 0.005~0.014 | 572 ± 37 | 403 ± 24 |
| CSC-3F | 697 ± 17 | 0.005~0.013 | 644 ± 44 | 421 ± 52 |

^{a} DLS analyses of fluorinated particles were done in α,α,α-trifluorotoluene, and those of all other particles were done in water.

### Example 4

### Core-Shell Particles

Core-shell (CS) particles were prepared by seeded emulsion polymerization. FIG. 3b shows an AFM topography image of a CS sample, which was derived from C described in Example 3. The AFM image clearly revealed that particles were uniformly sized and had a narrow size distribution. The d_{AFM} and h_{AFM} values as well as other size characteristics of this sample are listed in Table 1. Low DLS K₁²/K₂ value attests to low polydispersity of particles. Compared to dₕ, d_{AFM}, and h_{AFM} values of C particles, those of CS particles increased by 25%, 17%, and 15%, respectively.

Seeded emulsion polymerization, if done properly, should provide particles that possess low polydispersities. Provided that a monomer is completely consumed and no new nuclei are formed during shell formation, diameters d_{f} and d_{c} of CS and C particles are related by (Gilbert, R. G., Emulsion Polymerization: A Mechanistic Approach, Academic Press: London, 1995):

d_{f}=(V_{f}|V_{c})^{1/3}d_{c} (1)

where V_{c} and V_{f} are volumes of core and final particles, respectively. Neglecting the density difference between shell and core polymers, we calculated V_{c} and V_{f} from the mass of the core particles and that of the secondary monomers that were used to prepare the shell. Inserting this information into eq. 1 yielded a d_{f}/d_{c} value of 1.17. Thus, diameter of CS particles should have increased by ˜17% relative to that of C particles. This value compares well with d_{AFM} and h_{AFM} increases of 17% and 15% for CS relative to C, but was smaller than the 25% increase for CS dₕ value.

Several factors might have contributed to the larger dₕ value increase. First, there might have been some error in measured dₕ values. Second, EGDMA molar feed ratio was 2.2% for the shell but 4.0% for the core. Third, HEA-Cl should be more polar than the other monomers. Because of the latter two reasons, the shell might be more swollen in water than the core.

Seeded emulsion polymerization does not necessarily produce CS particles that have a shell made of monomers added during the second polymerization stage. Depending on the monomers used and their addition mode, resultant particles can have morphologies other than the desired morphology (Dimonie, V. L. et al., Control of Particle Morphology. In Emulsion Polymerization and Emulsion Polymers, Lovell, P. A.; El-Aasser, M. S., Eds. John Wiley & Sons Ltd: New York, 1997; Cho, I. and Lee, K. W., J. Appl. Polym. Sci., 1985, 30: 1903-1926; Sundberg, D. C. and Durant, Y. G., Polymer Reaction Engineering, 2003, 11: 379-432). Despite this, one can target the core-shell structure by controlling either thermodynamics and/or kinetics of a polymerization system. If newly-formed polymer prefers the water/polymer interface, a CS particle will form most likely as a thermodynamic product. Even if a newly-formed polymer has a higher water/polymer interfacial tension than that of a precursor polymer, it is still possible to prepare targeted CS particles as a kinetic product.

To prepare targeted CS particles as a kinetic product, one can, for example, add the second batch of monomer(s) into a polymerizing system dropwise, or perform the seeded emulsion polymerization in a semi-batch mode under monomer-starved conditions. Slow addition of the new monomer(s) serves two purposes. First, it helps minimize new nucleation. Second, it eliminates core particle swelling by secondary monomer(s) and avoids their polymerization inside core particles. Secondary monomer(s) should polymerize preferentially at the water/particle interface as a result of diffusion through the aqueous phase and incorporation into the particles. To ensure that newly formed polymer remains trapped in the shell layer even if this is not its favored position, one can prepare polymers that either have high glass transition temperatures or are crosslinked.

Crosslinker EGDMA was added during formation of both cores and shells of our particles. Also, secondary monomers HEA-Cl, MMA, and EGDMA were slowly pumped into the polymerization flask. Furthermore, HEA-Cl should be more polar than MMA and EDGMA. Thus, we expected shell formation from our secondary monomers. This expectation was confirmed by transmission electron microscopy. This method relied on developing an effective method for staining HEA-Cl groups. Our hypothesis was that CS particles should swell in methanol and thus silver triflate should be able to diffuse into particles if enough time and a driving force were provided for this process. The labile chloride group of HEA-Cl should react with silver triflate and water to produce AgCl at locations where HEA-Cl was present (Slomkowski, S. and Winnik, M. A., Macromolecules, 1986, 19: 500-501):

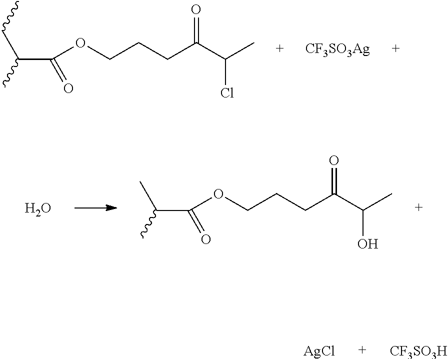

With both Ag and Cl being heavy atoms, AgCl should scatter electrons more effectively than elements found in organic polymers. Thus, locations which originally contained HEA-Cl should appear darker under a microscope.

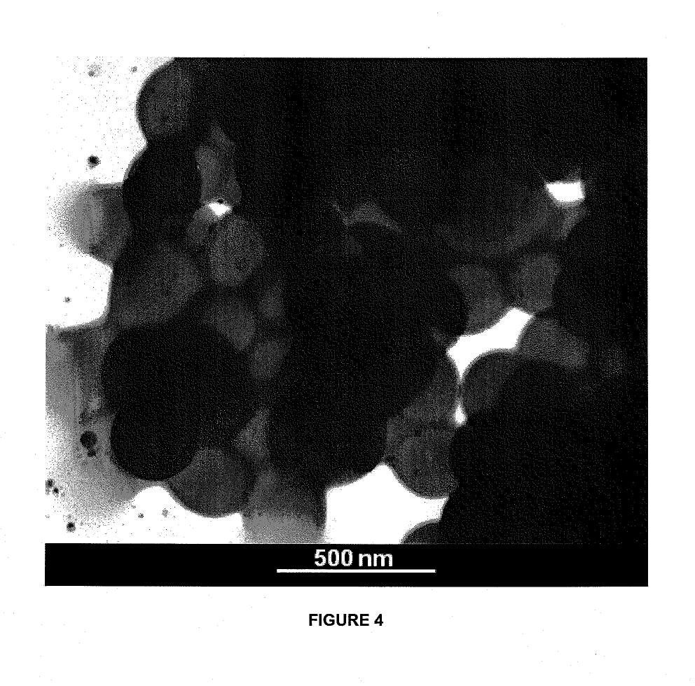

FIG. 4 shows a TEM image of a CS sample thus treated. After CF₃SO₃Ag staining, the particles' outer rim appeared dark. It is plausible that the dark rim had resulted from CF₃SO₃Ag that entered the particles by pure diffusion. However, we ruled out this possibility for the following reasons. First, the molar ratio used between HEA-Cl and CF₃SO₃Ag was close to 1/1. If not for the reaction between HEA-Cl and CF₃SO₃Ag, no particular driving force existed for CF₃SO₃Ag to partition into the particles. Second, the thickness of this dark layer did not increase by prolonging equilibration time between CS particles and silver triflate solution from 2 to 4 d. This contradicted what was expected of the pure silver triflate diffusion mechanism. Third, thickness of this dark layer was 28±3 nm, which agreed with shell thickness of 33 nm calculated from dₕ values for C and CS particles.

In addition to the above experiment, we also performed ¹H NMR analysis of CS particles in pyridine-d₅. Signals for HEA-Cl at 1.7 and 4.5 ppm were clearly observed for the particles, confirming incorporation of HEA-Cl into the particles.

### Example 5

### Core-Shell-Corona Particles

Coronal PHEA chains were grown via ATRP from CS particle surfaces in water/methanol at v/v=1/1. Controlled solution ATRP of HEA was first reported by Matyjaszewski and coworkers (Coca, S. et al., J. Polym. Sci.: A: Polym. Chem., 1998, 36: 1417-1424). Even when done from surfaces of latex particles (Jayachandran, K. N. et al., Macromolecules, 2002, 35: 4247-4257) and silica particles (Perruchot, C. et al., Langmuir, 2001, 17: 4479-4481), HEA ATRP was again shown to be controlled. Based on these prior results, we anticipated controlled ATRP of HEA in our case as well.

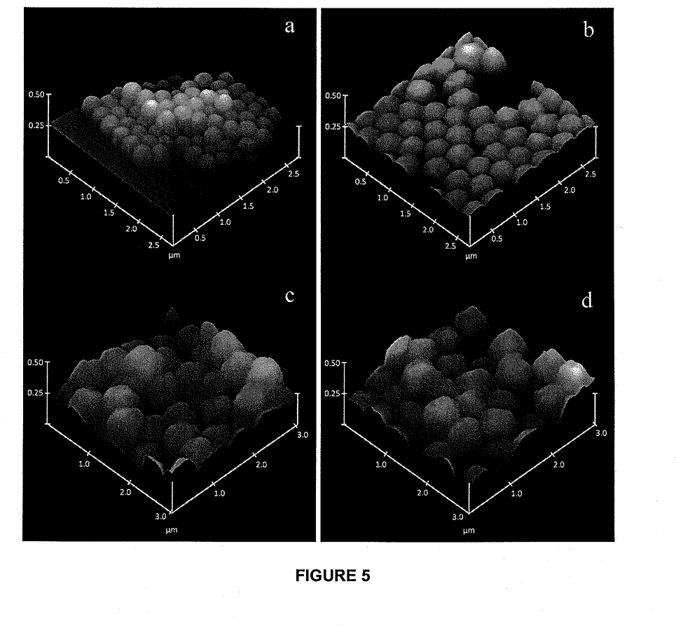

FIG. 5 shows AFM topography images of three batches of CSC particles. CSC-1, CSC-2, and CSC-3 particles were all derived from the same CS particles, but were prepared using different HEA to HEA-Cl molar ratios (n_{HEA}/n_{HEA-Cl}) of 220/1, 430/1, and 1500/1, respectively. AFM images suggest that CSC particle size increased as n_{HEA}/n_{HEA-Cl} increased. This has also been confirmed by dₕ value increases (see Table 1). More interestingly, shape of the particles changed from CSC-1 spheres, to CSC-2 bumpy spheres, and then to CSC-3 spheres bearing fused surface “lobes”.

TABLE 2
SEC characteristics of linear PHEA chains
prepared together with CSC particles.

| Sample | n_{HEA}/n_{HEA-Cl} | SEC Mₙ (g/mol) | SEC M_{w}/Mₙ |
|---|---|---|---|
| CSC-1 | 220 | 2.1 × 10⁴ | 1.15 |
| CSC-2 | 430 | 5.6 × 10⁴ | 1.30 |
| CSC-3 | 1500 | 9.1 × 10⁴ | 1.43 |

Particle size expanded with increasing n_{HEA}/n_{HEA-Cl} because the HEA ATRP reaction was controlled and the surface PHEA chain lengthened with increasing n_{HEA}/n_{HEA-Cl}. To shed light on properties of PHEA chains prepared during corona growth, we mixed some free initiator, methyl 2-chloropropinate, with CS particles before polymerization. Initiation of HEA polymerization by methyl 2-chloropropinate resulted in free PHEA chains in the solvent phase. These free PHEA chains were then analyzed by SEC against monodisperse PS standards. Results are given in Table 2. SEC Mₙ values of free PHEA increased with n_{HEA}/n_{HEA-Cl}, as anticipated. The low M_{w}/Mₙ value of 1.15 for free PHEA chains at n_{HEA}/n_{HEA-Cl}=220 and the reasonably low M_{w}/Mₙ value of 1.43 at n_{HEA}/n_{HEA-Cl}=1500 suggested that HEA free radical polymerization was controlled.

Mₙ values in Table 2 did not grow linearly with n_{HEA}/n_{HEA-Cl} probably because of several reasons. First, we did not know the fraction of HEA-Cl units that initiated HEA polymerization. Second, characteristics of free PHEA chains may have differed from those grafted onto CS particles. Third, we did not determine exact HEA conversions for the different polymerizations. Fourth, SEC Mₙ values were not absolute, but were calculated based on PS standards.

Fraction of HEA-Cl units that did initiate HEA polymerization should change significantly depending on solvent(s) used for ATRP. Brooks and coworkers (Jayachandran, K. N. et al., Macromolecules, 2002, 35: 4247-4257) grew PHEA and poly(N,N-dimethylaminoethyl methacrylate) chains from poly[styrene-co-(HEA-Cl)] latex particle surfaces in water, which swelled core particles insignificantly. Their meticulous work demonstrated that only HEA-Cl units that were in the outer ˜1.5 nm surface layer initiated HEA polymerization. Stover and coworkers (Zheng, G. D. and Stover, H. D. H., Macromolecules, 2002, 35: 7612-7619) grew polymer chains from crosslinked polymer particle surfaces in THF, which solvated the core, and suggested that chains initiated from sites that were deep inside particles. Our ATRP was performed in water/methanol, a solvent mixture that swelled CS particles only slightly. Thus, we believe that mainly surface HEA-Cl units initiated polymerization.

Past studies demonstrated that free polymer chains grown from added small-molecule initiators had molecular weights identical to those of surface-grafted chains. These previous studies utilized particles such as silica, gold, and iron oxides, which had impermeable cores (Tsujii, Y. et al., Adv. Polym. Sci., 2006, 197: 1-45). Latex particles used in the present study could be permeated by ligands, monomer and catalyst. Therefore, Mₙ and WM, values reported in Table 2 may differ from those of grafted polymer chains, although observed trends for Mₙ and M_{w}/Mₙ should be similar for free and grafted chains.

Bumps and lobes on CSC-2 and CSC-3 particle surfaces likely formed due to both kinetic and thermodynamic factors. We observed that bumps were larger when CSC-2 particles were sprayed from more volatile solvent methanol than from water. This suggests that kinetics were a contributing factor to final bump size. Bumps did not disappear despite annealing (for 2 days) the sprayed samples at 90° C., which was above the glass transition temperature of 10° C. for PHEA (Aran, B. et al., J. Appl. Polym. Sci., 2010, 116: 628-635). This suggests that these bumps were thermodynamically stable. Similar surface structures have been observed for long chains grown on other types of polymer particles (Zheng, G. D. and Stover, H. D. H., Macromolecules, 2002, 35: 7612-7619).

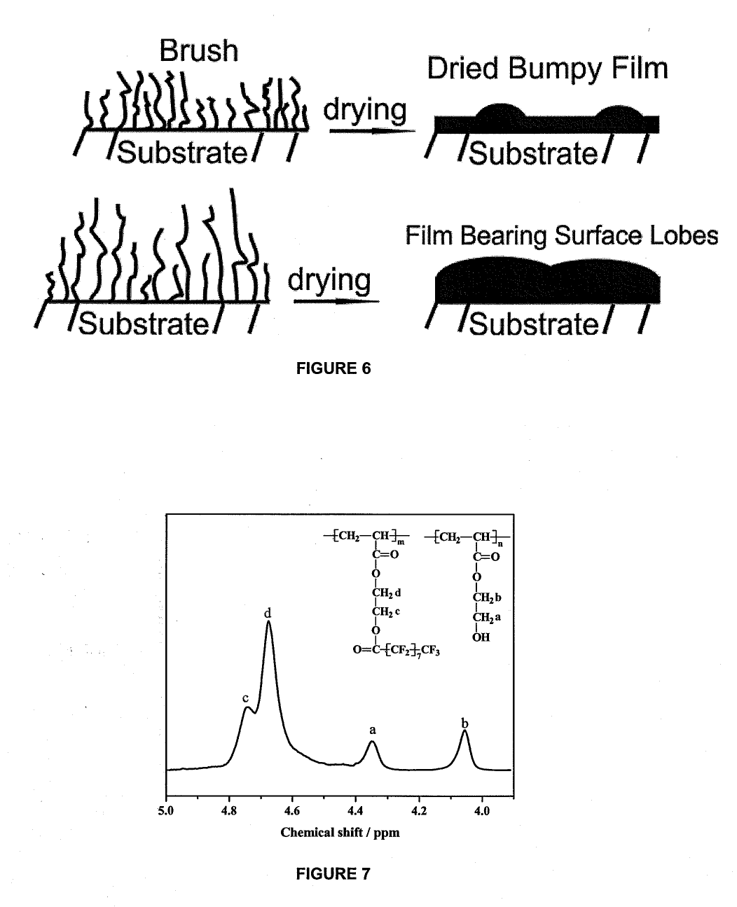

Bumps and lobes are both protruding structures. As illustrated in FIG. 6, bases of lobes overlap with one another, and bumps are better resolved lobes. Lobes are formed from longer and more polydisperse surface chains.

Table 1 shows that polydispersity of grafted PHEA chains increased from CSC-1 to CSC-2 and CSC-3 particles. The polydispersity criterion explains why no obvious bumps were seen on CSC-1 particles, but were seen on CSC-2 and CSC-3 particles.

### Example 6

### Corona Fluorination

Coronal PHEA chains were fluorinated by reacting PHEA hydroxyl groups with perfluorononanoyl chloride in pyridine.

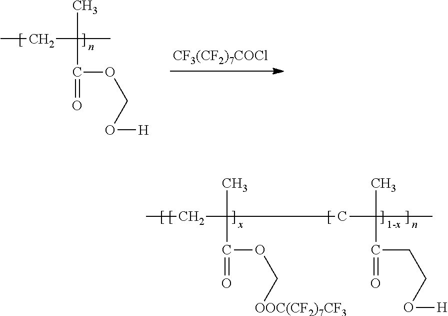

FIG. 7 shows a ¹H NMR spectrum of fluorinated CSC-3 or CSC-3F particles in CDCl₃ and trifluorotoluene. After fluorination, positions of ethylene protons of hydroxylethyl groups shifted downfield. A comparison of integrated areas of c and d peaks of fluorinated polymer and those of a and b peaks of PHEA revealed that 80% of PHEA hydroxyl groups of CSC-3 were fluorinated.

CSC-1F and CSC-2F spheres were analyzed similarly and it was determined that fluorination degrees for these spheres were the same, within experimental error, at 80%. But, the 80% fluorination determined by ¹H NMR should be taken with caution. PHEA segments close to a shell/corona interface may be so dense that their segmental tumbling motion is restricted. Thus, ¹H NMR might not be able to detect these segments. The measured 80% degree of fluorination might be for those segments that were closer to an outer edge of a corona and not for all PHEA hydroxyl groups.

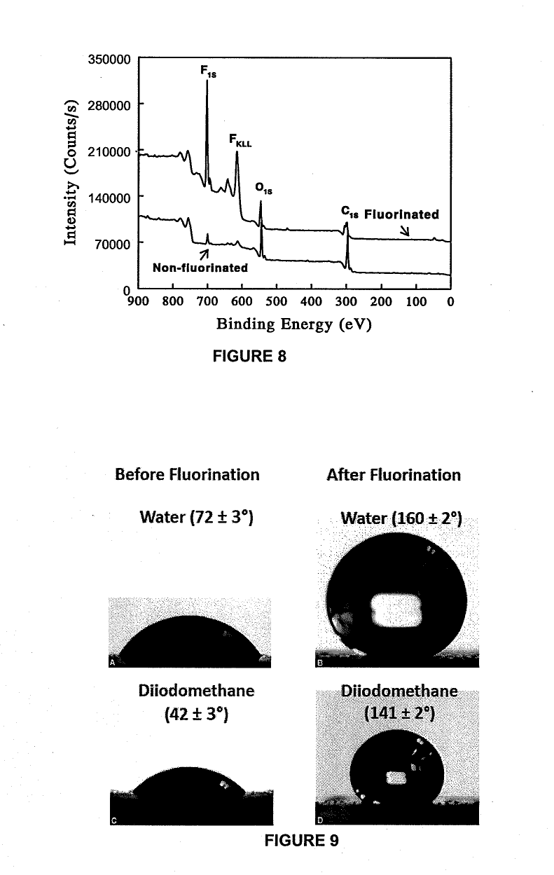

Successful fluorination was also confirmed by an X-ray photoelectron spectroscopy (XPS) study. FIG. 8 compares XPS spectra of CSC-3 and CSC-3F. Before fluorination, O₁ₛ and C₁ₛ peaks were dominant. This was in agreement with the fact that PHEA was composed mainly of carbon, hydrogen, and oxygen and the H₁ₛ peak was not detectable. After fluorination, one F₁ₛ peak and a group of fluorine Auger peaks (F_{KLL}) appeared in the spectrum of CSC-3F (Lim, J. M. et al., Langmuir, 2007, 23: 7981-7989).

FIG. 5d shows an AFM topography image of CSC-3F spheres. Particle morphology did not change with fluorination. Data in Table 1 clearly show that size of CSC particles increased after fluorination because of increased mass of the corona.

### Example 7

### Amphiphobicity of Fluorinated Particles

Successful corona fluorination was further confirmed by liquid contact angle measurements on coatings made from fluorinated and non-fluorinated CSC particles. FIG. 9 compares photographs taken of H₂O and CH₂I₂ droplets sitting on coatings that were prepared by spin-coating CSC-3 and CSC-3F solutions onto glass plates. Static H₂O and CH₂I₂ contact angles (θ_{S}) increased from 72±3 and 42±3° on CSC-3 coatings to 160±2 and 141±2° on CSC-3F coatings. This agreed with a reduced surface energy of fluorinated particles.

Table 3 further lists advancing and receding contact angles (θ_{A} and θ_{R}, respectively) for these droplets. The difference between θ_{A} and θ_{R} values and thus hysteresis was small for each liquid. Furthermore, all contact angles including θ_{A}, θ_{S}, and θ_{R} were larger than 150° for water droplets. Therefore, surfaces of CSC-3F particles were hydrophobic. θ_{A}, θ_{S}, and θ_{R} values were large for CH₂I₂ droplets as well. This shows that CSC-3F coatings were also oil repellent, and thus they were amphiphobic.

Particulate coatings were prepared also from CSC-1F and CSC-2F, and measured H₂O and CH₂I₂ contact angles were also included in Table 3. Regardless of particle type, coatings of all fluorinated particles were superhydrophobic.

TABLE 3
Advancing, static, and receding contact angles (θ_{A},
θ_{S}, and θ_{R}, respectively) of water and diiodomethane
droplets on coatings made from different spheres.

| | Water | | | Diiodomethane | | |
|---|---|---|---|---|---|---|
| Coating | θ_{A}/ | θ_{S}/ | θ_{R}/ | θ_{A}/ | θ_{S}/ | θ_{R}/ |
| Sample | degree | degree | degree | degree | degree | degree |
| CSC-3 | 78 ± 2 | 72 ± 2 | 59 ± 2 | 47 ± 2 | 42 ± 2 | 37 ± 2 |
| CSC-1F | 157 ± 2 | 152 ± 2 | 151 ± 2 | 135 ± 2 | 129 ± 2 | 122 ± 2 |
| CSC-2F | 161 ± 2 | 157 ± 2 | 154 ± 2 | 139 ± 2 | 135 ± 2 | 126 ± 2 |
| CSC-3F | 165 ± 2 | 160 ± 2 | 157 ± 2 | 144 ± 2 | 141 ± 2 | 135 ± 2 |

Water contact angle on a flat fluorinated surface is generally ˜120° (Ming, W. et al., Nano Lett., 2005, 5: 2298-2301). Contact angles were all larger than 150° on coatings prepared from our particles, at least in part because all of our coatings were rough. Roughness of our coatings arose from two reasons. First, a closely-packed rugged particle array rather than a continuous film was formed from our particles. This array arose because both the core and shell of particles were crosslinked and were not deformable, and ultra-dense coronal chains of different particles did not interpenetrate extensively with one another (Zhulina, E. B. et al., J. Colloid Interf. Sci., 1990, 137: 495-511; Zhou, Z. H. et al., ACS Nano, 2009, 3: 165-172). Second, bumps and lobes were formed by surface chains of fluorinated. CSC particles. This multi-level roughness was clearly seen in FIGS. 5c and 5d, which showed AFM images of CSC-3 and CSC-3F coatings.

Table 3 further reveals that θ_{A}, θ_{S}, and θ_{R} values of both liquids increased from CSC-1F coatings to CSC-2F and CSC-3F coatings. This increasing trend was not an artifact of coating preparation protocol, because three physical deposition methods as described herein were used to prepare particulate coatings, and θ_{A}, θ_{S}, or θ_{R} values of a particular sample changed little with the coating preparation method used. Thus, this θ variation trend is most likely due to packing and morphology variation of particles.

Since observed contact angle hysteresis was small on all particulate coatings (Tsai, P. T. et al., Nanotechnology, 2007, 18: 1-7), liquid droplets should have existed in a meta-stable Cassie state, meaning that droplets were suspended above a surface by fluorinated solid protrusions and air pockets were trapped between droplets and valleys (Cassie, A. B. D. and Baxter, S., Trans. Faraday Soc., 1944, 40: 0546-0550; Nosonovsky, M. and Bhushan, B., J. Phys. Condens. Matt., 2008, 20: 1-6; Bico, J. et al., Europhys. Lett., 1999, 47: 220-226). In this state, observed contact angle on a rough surface (θₒ) and that on a flat surface (θ_{f}) were related by:

cos θₒ=f(1+cos θ_{f})−1 (2)

Here f was a ratio between droplet/solid contact area and total contact area made by a droplet with solid protrusions and trapped air.

θₒ value increased from CSC-1F to CSC-2F and CSC-3F coatings because f decreased in this order. This should not have been a direct consequence of particle size increase because f should not change with particle size if particles were sufficiently large and were packed regularly to yield a uniform, even top layer. This has been experimentally verified for even layers of alkylated silica particles that had diameters of 0.5, 1.0 and 1.5 μm and were deposited using the Langmuir-Blodgett method (Tsai, H. J. and Lee, Y. L, Langmuir, 2007, 23: 12687-12692).

Our fluorinated particles had sizes between 350 and 650 nm. It is most likely that surface bumps and lobes of CSC-2F and CSC-3F particles were responsible for the observed 0 variation trend. This is consistent with the importance of roughness for creating amphiphobic surfaces.

### Example 8

### Covalently-Bonded Particulate Coatings

Particulate coatings discussed so far were physically deposited on glass plates, and adhesion forces between material surface and particles and among particles were weak. To prepare covalently-bonded coatings from CSC-2F, we first spin-coated an epoxy glue mixture consisting of a glycidyl part and a multi-amine part onto glass plates. After this glue was partially cured, CSC-2F particles in trifluorotoluene were then aero-sprayed onto the glue. Composite coatings were then further cured so that hydroxyl groups in a CSC-2F corona could react with residual glycidyl units in the epoxy glue.

Composite coatings mentioned above were layered with CSC-2F particles at the top. H₂O and CH₂I₂ contact angles on these coatings (shown in Table 4) were almost identical to those reported for physically-deposited CSC-2F coatings. In addition, liquid contact angles (given in Table 4) changed negligibly after these coatings were stirred for 16 h with trifluorotoluene, which should have extracted CSC-2F particles that were not covalently attached to the material surface and solubilized a physically-deposited CSC-2F coating.

TABLE 4
Advancing, static, and receding contact angles of H₂O and
CH₂I₂ on composite coatings made of CSC-2F and polymer resin,
before and after particle extraction by trifluorotoluene.

| Resin/ | Water | | | Diiodomethane | | |
|---|---|---|---|---|---|---|
| Extraction | θ_{A} (°) | θ_{S} (°) | θ_{R} (°) | θ_{A} (°) | θ_{S} (°) | θ_{R} (°) |
| Epoxy/Before | 162 ± 2 | 161 ± 2 | 154 ± 2 | 140 ± 2 | 138 ± 2 | 127 ± 2 |
| Epoxy/After | 159 ± 2 | 156 ± 2 | 153 ± 2 | 138 ± 2 | 134 ± 2 | 126 ± 2 |
| PCEMA/ | 161 ± 2 | 158 ± 2 | 155 ± 2 | 139 ± 2 | 136 ± 2 | 124 ± 2 |
| Before | | | | | | |
| PCEMA/ | — | 104 ± 2 | — | — | 83 ± 2 | — |
| After | | | | | | |

To show that improved adhesion between CSC-2F particles and epoxy matrix was not due to physical entrapment of particles by crosslinked polymer chains, we performed a control experiment. A layer of PCEMA, which could undergo photocrosslinking (Ding, J. F. and Liu, G. J., Macromolecules, 1999, 32: 8413-8420), was used in place of the epoxy layer. Analogously, CSC-2F particles were aero-sprayed onto a partially crosslinked PCEMA layer. This was followed by further irradiation of the composite coating to crosslink the PCEMA layer more. Liquid contact angles on this coating were the same, within experimental error, as those on CSC-2F/epoxy composite coatings. After particle extraction by trifluorotoluene, contact angles decreased drastically. These results suggested removal of particles from the PCEMA surface and inability of crosslinked PCEMA chains, or crosslinked epoxy matrix, to physically trap CSC-2F particles. Therefore, CSC-2F particles were retained by the epoxy glue because CSC-2F coronal hydroxyl groups had reacted with glycidyl groups of the epoxy glue.

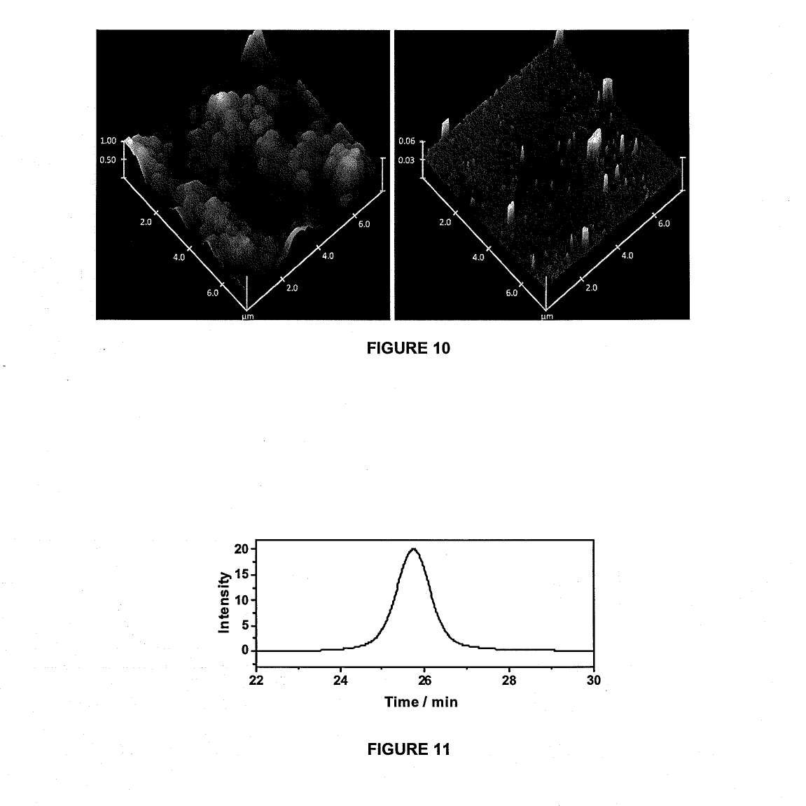

FIG. 10 compares AFM topography images of CSC-2F/epoxy glue and CSC-2F/PCEMA composite coatings after CSC-2F particle extraction by trifluorotoluene. Evidently, a CSC-2F layer was retained by the epoxy glue after a trifluorotoluene extraction step. On the other hand, many holes were seen in the trifluorotoluene-extracted CSC-2F/PCEMA layer, confirming removal of CSC-2F particles in this case.

### Example 9

### Tests to Determine Properties of Amphiphobic Coatings

Properties of amphiphobic coatings may be determined using standardized techniques and methodologies known in the art, such as, for example, American Society for Testing and Materials International (ASTM) standard tests. Appropriate techniques and methodologies to be used, and desired parameters to be achieved, are chosen by a skilled artisan based on material surface to be coated, intended use of coated material surface, etc.

ASTM D6577 provides a standard guide for testing industrial protective coatings. Selection and use of test methods and procedures for evaluating general performance levels of coatings or coating systems on a given material surface, after exposure to a given type of environment, are described therein. As an example, water resistance of coatings is tested: in 100% relative humidity as described in ASTM D2247; using a water fog apparatus as described in ASTM D1735; and/or using a water immersion method as described in ASTM D870. As another example, solvent resistance is tested using solvent rubs as described in ASTM D5402. In an example, immersion testing is performed as described in D6943.

In another example, corrosion resistance is determined using a Salt Spray (Fog) Apparatus (ASTM B117), using test parameters described in ASTM standard B117.

In an example, stain resistance is determined using a nitric acid test as described in ASTM B136.

In another example, chemical resistance (e.g., acid resistance, base resistance, oil resistance, methyl ethyl ketone (MEK) resistance) is tested using a double rub method as described in ASTM 04752.

ASTM F1296 provides a standard guide for evaluating chemical protective clothing. In an example, in the case of amphiphobic multifunctional microsphere-coated fabrics to be used, e.g., for protective clothing, liquid penetration resistance is tested under a shower spray while on a mannequin as described in ASTM F1359. In another example, resistance to penetration by liquids of an amphiphobic multifunctional microsphere-coated fabric material is tested according to ASTM F903. As an example, an multifunctional microsphere-coated fabric is subjected to a test liquid for a specified time and pressure sequence. Resistance to visible penetration by the test liquid is determined with the liquid in continuous contact with the outside surface of the coated fabric. If the test liquid passes through the fabric, the material fails the test for resistance to penetration by the test liquid. In some penetration test apparatuses, the multifunctional microsphere-coated fabric may act as a partition separating a hazardous liquid chemical from the viewing side of a test cell. In an example, ASTM F739 is used to determine permeation under conditions of continuous contact with targeted chemicals, including liquids or gases. In another example, amphiphobic multifunctional microsphere-coated fabrics are tested as described in ASTM D751.

In an example, abrasion resistance for painted material surfaces coated with amphiphobic coatings of the invention is tested using a Norman Tool “RCA” Abrader test as described in ASTM F2357.

The contents of ASTM standard guides and standard test methods mentioned herein are hereby incorporated by reference in their entireties.

### Example 10

### Simultaneous Coating of Silica Particles by Two Diblock Copolymers

Silica particles were coated by two diblock copolymers, P1 and P2, through a one-pot reaction, and the resultant particles were characterized. The P1 and P2 used were synthesized by anionic polymerization and denoted as PIPSMA-b-PFOEMA and PIPSMA-b-PtBA, respectively. PIPSMA, PFOEMA, and PtBA correspond respectively to poly[3-(triisopropyloxysilyl)propyl methacrylate], poly(perfluorooctylethyl methacrylate), and poly(tert-butyl acrylate). Catalyzed by HCl, the PIPSMA blocks of P1 and P2 co-condensed onto the surface of the same silica particles, exposing the PtBA and PFOEMA blocks. Relative amounts of grafted P1 and P2 could be tuned by changing the P1 to P2 weight ratio, and were quantified by thermogravimetric analysis. Vertical segregation of the PFOEMA and PtBA chains could also be adjusted. Casting a dispersion of the coated particles in a solvent selective for either PFOEMA or PtBA onto glass plates or silicon wafers yielded films composed of bumpy silica particles whose surfaces were enriched by the polymer that was soluble in the casting solvent. Particulate coatings with tunable surface wetting properties were obtained by changing either the proportion of grafted P1 and P2 or the casting solvent for coated silica. When a silica dispersion in perfluoromethylcyclohexane (C₇F₁₄) was cast, films of coated silica that had P1 weight fractions of 25%, 50%, and 75% were superhydrophobic because the particle surfaces were enriched by PFOEMA, which was selectively soluble in C₇F₁₄.

PFOEMA was chosen because of its low surface energy and its water and oil repellency. PtBA was used because it could be readily hydrolyzed to poly(acrylic acid) (PAA), which can react with epoxy resin and help anchor PFOEMA-bearing particles onto surfaces of epoxy to yield robust fluorinated particulate coatings. PIPSMA blocks were used because they are sol-gel forming and silanol groups generated from triisopropyloxy hydrolysis could readily couple with silanol groups of silica particles to yield siloxane bonds, Si—O—Si (Brinker, C. J. and Scherer, G. W., Sol-Gel Science: The Physics and Chemistry of Sol-Gel Processing, Academic Press, Inc.: Boston, 1990). Also, silanol groups generated via PIPSMA hydrolysis could condense with each other, yielding a crosslinked sol-gelled PIPSMA layer that was covalently attached to silica (Xiong, D. et al., Chem. Mater., 2011, 23, 4357-4366). Using these two diblock copolymers, silica particles with surface. PtBA and PFOEMA chains were obtained via a one-pot co-condensation of the hydrolyzed PIPSMA blocks of the different copolymers, as described below.

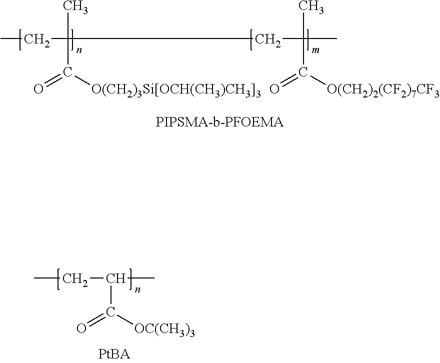

Materials and Reagents. Tetrahydrofuran (THF, Caledon, >99%) was dried by refluxing it with sodium and a small amount of benzophenone until a deep purple color developed and was distilled immediately before use. A dioxane solution of HCl (4.0 M) was purchased from Aldrich and was diluted to 1.0 M by addition of THF before use. The monomer 3-(tri-2-propoxysilyl)propyl methacrylate (TPOSPMA) was synthesized following the method described in the literature (Ozaki, H. et al., Macromolecules, 1992, 25, 1391-1395). sec-Butyllithium (1.4 M in cyclohexane) and the monomer Pert-butyl acrylate (tBA, ≧99%) were purchased from Aldrich. The tBA monomer was purified by vacuum distillation first over calcium hydride and then over trioctyl aluminum before use. Diphenyl ethylene (97%, Aldrich) was purified by distillation in the presence of sec-butyl lithium. Tetraethoxysilane (TEOS, 99.0%), LiCl (Aldrich, 99.99+%), α,α,α-trifluorotoluene (TFT, Acros, 99+%), perfluoromethylcyclohexane (Aldrich, 90%), ammonia (Caledon, 28˜30%) and isopropanol (Fisher, 99.5%) were used as received.

Polymer Synthesis. Polymers were prepared by anionic polymerization in THF at −78° C. The initiator used was generated by reacting sec-butyllithium with excess diphenyl ethylene. Each monomer was polymerized for 2 h. Preparation of P1 and polymerization of tBA were performed as reported (Xiang, D. et al., Chem. Mater., 2011, 23, 4357-4366; Henselwood, F. and Liu, G. J., Macromolecules, 1997, 30, 488-493; Liu, G. J. et al., S. Chem. Mater., 1999, 11, 2233-2240).

Polymer Characterization. ¹H NMR analysis of P2 was performed in CDCl₃ on a Bruker Avance 500 MHz spectrometer. P1 and P2 were analyzed by size exclusion chromatography (SEC) at 36° C. using a Waters 515 system equipped with a Waters 2410 differential refractive index detector. This system utilized three columns, including one Waters μ-Styragel 500 Å column and two Waters Styragel HR 5E columns. The mobile phase was chloroform, which was set to a flow rate of 1.00 ml/min. The system was calibrated by monodisperse polystyrene standards.

Silica Particles. Silica particles used were synthesized following the Stober method (Stober, W. et al., J. Colloid Interf. Sci., 1968, 26, 62-&; Sheen, Y. C. et al., J. Polym. Sci., Part B: Polym. Phys., 2008, 46, 1984-1990). Tetraethoxysilane (2.0 g) was dissolved into 21 mL of isopropanol to yield a homogeneous solution before 0.8 mL of an aqueous ammonia solution (28 wt. %) was added with vigorous stirring. This mixture was refluxed at 60° C. for 4 h, and the resultant silica particles were settled via centrifugation for 10 min at 3050 g. After the supernatant was discarded, the particles were re-dispersed into 10 mL of isopropanol, re-settled via centrifugation, and subsequently decanted from the supernatant. This rinsing process was repeated thrice, and the final particles were dried overnight under vacuum before use.

Silica Coating. Silica was coated by P1 and/or P2 in TFT/THF using HCl as catalyst. TFT was used to ensure the dispersion of the final particles which bore a corona comprising PFOEMA. Unless otherwise mentioned, silica particles were coated using standard conditions, which involved performing the grafting reaction at 21° C. for 10 h in TFT/THF at a THF volume fraction (f_{THF}) of 9.1%. The molar ratio between IPSMA, HCl, and water was 1/1/2 (n_{Si}/n_{HCl}/n_{H2O}). The weight ratio used between polymers (P1 and/or P2) and SiO₂(m_{P}/m_{S}) was 0.08/1.00.

Specifically, P1 and/or P2 were initially dissolved into THF at 5.0 mg/mL. Dry silica particles (5.0 mg) were then mixed with 3.0 mL of TFT in a 20 mL vial and ultrasonicated for 60 s to disperse the particles. To this dispersion were then added 0.080 mL of the 5.0 mg/mL polymer solution mixture in THF, 0.08 mL of the HCl solution (1.0 M in THF) and 3.0 μL of H₂O. The reaction was performed at room temperature for 10 h before it was centrifuged at 3050 g for 10 min to settle the particles. After the supernatant was removed, the particles were re-dispersed into 2.0 mL of TFT and centrifuged again to settle the particles and to remove the catalyst, byproducts, and any residual polymer that was not grafted. The particles were then vacuum-dried for 2 h in a 100° C. oven.

Dynamic Light Scattering (DLS). For DLS analysis, bare and coated silica particles were separately re-dispersed into methanol and into TFT at ˜0.5 mg/mL. The samples were clarified by filtration through 1.2-μm filters. Dynamic light scattering (DLS) measurements were performed at 20.0° C. using a Brookhaven BI-200 SM instrument equipped with a BI-9000AT digital correlator and a He—Ne laser (632.8 nm). The sample temperature was regulated by circulating water from a thermostated bath, and the scattering angles used were 30, 40, 45, 50, 60, 70, 80, and 90°. The data were analyzed using the Cumulant method (Berne, B. J. P., R., Dynamic Light. Scattering with Applications to Chemistry, Biology, and Physics, Dover Publications, Inc.: Mineola, N.Y., 1976) to yield the hydrodynamic diameters (dₕ) and the polydispersity indices (K₁²1K₂). The dₕ values reported for each sample were the averages from 6 measurements. To calculate dₕ, the TFT refractive index and viscosity (DeLorenzi, L. et al., J. Chem. Eng. Data, 1996, 41, 1121-1125) used were 1.414 and 0.5505 cP, respectively, while those for methanol (Lide, D. R., CRC Handbook of Chemistry and Physics, 76th ed.; CRC Press: Boca Raton, 1995) were 1.329 and 0.5513 cP, respectively.

Preparation of Sol-Gelled P1 and P2 Sample. Sol-gelled P1 or P2 samples were prepared by sol-gelling P1 or P2 under similar conditions to those used to coat the silica particles, except the silica particles were not present in this case. After a sample was allowed to react for 10 h, it was centrifuged at 17,000 g for 10 min to settle the product. The solid product was re-dispersed into 2.0 mL of TFT and subsequently centrifuged. The rinsing process was repeated once again before the product was vacuum-dried to yield a white powder.

Thermogravimetric Analyses. Thermogravimetric analyses (TGAs) were performed using a TA Q500 Instrument using air as the heating atmosphere. A typical measurement involved heating a sample from room temperature to 700° C. at a rate of 5° C./min.

Transmission Electron Microscopy. TFT solutions of silica particles were aero-sprayed onto carbon-coated copper grids and then dried under vacuum at room temperature for 2 h before transmission electron microscopy (TEM) observation. The images were obtained using a Hitachi-7000 instrument that was operated at 75 kV.

Atomic Force Microscopy. Bare silica particles and particles coated by pure P2 were re-dispersed into methanol, and silica particles coated by a mixture of P1 and P2 were re-dispersed into either TFT (C₇H₅F₃), perfluoromethylcyclohexane (C₇F₁₄), or methanol at ˜1 mg/mL. The specimen solutions were aero-sprayed onto silicon wafers before analysis by tapping-mode atomic force microscopy (AFM) using a Veeco multimode instrument equipped with a Nanoscopela controller. The Nanosensors NCHRSPL AFM tips used had a tip radius of approx. 5 nm.

Amphiphobic Films. Polymer-coated silica particles were re-dispersed into TFT at a concentration of 2.0 mg/ml . . . . Microscope slide cover slips were coated by casting and evaporating several droplets of the multifunctional silica microsphere solution onto the slips.

Contact Angle Measurements. All contact angles were measured at room temperature (about 21° C.). Static contact angles were measured using 5 μL droplets on a KRUSS K12 tensiometer that was interfaced with image-capturing ImageJ software. Advancing and receding angles were determined by probing expanding and contracting liquid droplets, respectively. For each sample, contact angles were measured at 5-10 different positions, and the reported values were the averages of these measurements. The precision of these measurements was better than ±2°. Liquids that were used for contact angle measurements included Milli-Q water and diiodomethane (>99%, Sigma-Aldrich).

X-Ray Photoelectron Spectroscopy. Silica particles coated at f₁=50% were re-dispersed into C₇H₅F₃. Droplets of this dispersion were then dispensed onto a silicon wafer to yield a particulate film. X-Ray photoelectron spectroscopy (XPS) analysis of this film was performed using a Thermo Instruments Microlab 310F surface analysis system (Hastings, U.K.) under ultrahigh vacuum conditions. The Mg Kα X-ray source (1486.6 eV) was operated at a 15 kV anode potential with a 20 mA emission current. Scans were acquired in the Fixed Analyzer Transmission mode with a pass energy of 20 eV and a surface/detector take-off angle of 75°. All spectra were calibrated to the C is line at 285.0 eV, and minor charging effects were observed that produced a binding energy increase between 1.0 and 2.0 eV. The background of the spectra were subtracted by using a Shirley fitting algorithm and a Powell peak-fitting algorithm (Liu, H. B. and Hamers, R. J., Surf. Sci,. 1998, 416, 354-362).

Diblock Copolymers. The diblock copolymers used in this study were prepared by anionic polymerization. Since the repeat unit numbers were low for the copolymers and large amounts of initiator were used, initiator utilization efficiencies should have been high. Therefore, the synthesized copolymers were expected to possess the targeted repeat unit numbers. ¹H NMR was used to confirm the repeat unit ratios between the two blocks of the diblock copolymers and SEC was used to determine the polydispersity indices (M_{w}/Mₙ) of the copolymers in terms of polystyrene standards. Using these techniques, P1 was determined to have an M_{w}/Mₙ value of 1.16 and a repeat unit number ratio of 1.0/1.0.

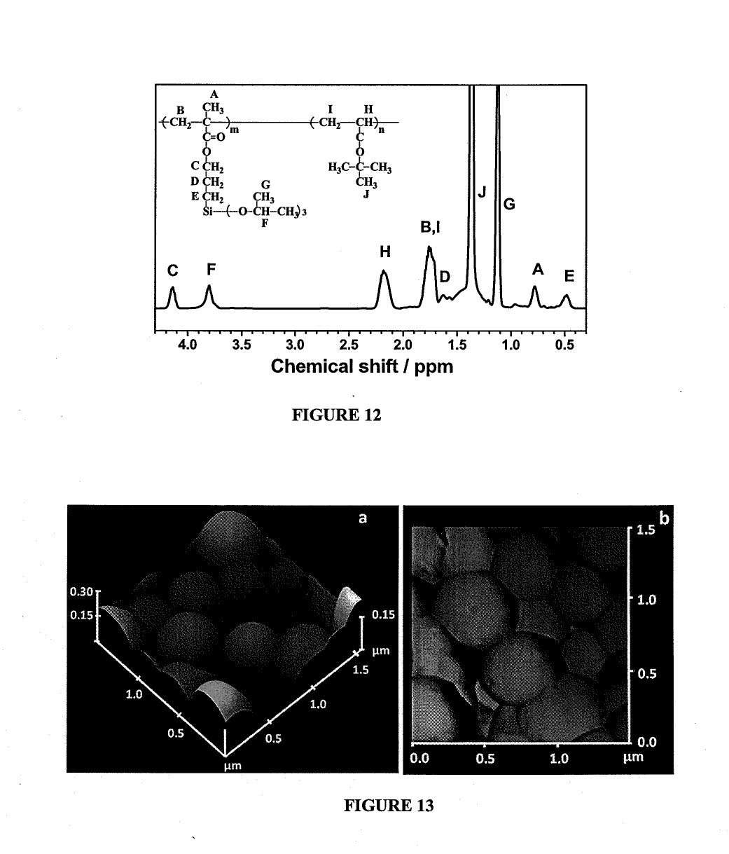

Chloroform was used as the mobile phase to elute P2 and FIG. 11 shows the obtained SEC trace. A quantitative analysis indicated that the polydispersity index based on polystyrene standards was low, at 1.05. ¹H NMR spectrum was obtained for P2 in CDCl₃ and is shown in FIG. 12 together with the peak assignments. Peak integral analysis indicated that the repeat unit ratio between the PIPSMA and RBA blocks was 1.0/7.0, in agreement with the targeted repeat units of 10 and 70, respectively, for the two blocks.

Based on the targeted repeat unit numbers of 10 and 10 for P1, a number-average molecular weight of 8.6×10³ g/mol was calculated for P1. For P2, possessing 10 PIPSMA units and 70 tBA units, the molecular weight was expected to be 1.23×10⁴ g/mol.

Silica Particles. The silica particles used were prepared through sol-gel chemistry of tetraethoxysilane using a modified Stober procedure (Stober, W. et al., Colloid Interf. Sci., 1968, 26, 62-&; Sheen, Y. C. et al., J. Polym. Sci., Part B: Polym. Phys., 2008, 46, 1984-1990). This process involved ammonia-catalyzed hydrolysis of the ethoxy groups of tetraethoxysilane in isopropanol to yield silanol groups and subsequent condensation of the resultant silanol groups into siloxane bonds. According to Bogush et al. (Bogush, G. H. et al., J. Non-Cryst. Solids, 1988, 104, 95-106), silica particles prepared under these conditions should have a pore volume fraction of 11-15% and a bulk density of 1.82 g/cm³, which can be used to relate the weight and volume of the silica particles.

Silica particles thus prepared were re-dispersed into methanol and aero-sprayed using a home-built device (Ding, J. F. and Liu, G. J., Macromolecules, 1999, 32, 8413-8420) onto a silicon wafer and analyzed by AFM. Aero-spraying was used to atomize the spraying solution and to accelerate the solvent evaporation. This technique helped reduce the chances of block copolymer micellar morphological changes during specimen preparation but it was also used here as a routine technique without an intended special function. FIGS. 13a and 13b show AFM topography and phase images of samples of the silica particles, respectively. Aside from occasional surface craters and bumps, which were more apparent in the phase image, the spheres were rather smooth. These defects should not be surprising because silica particles were formed from the fusion of primary silica nanoclusters during sol-gel synthesis. TEM images of the silica particles were also obtained. From these images, an average diameter of 415±15 nm was determined for the particles. Here 15 nm denotes the spread in the diameters of different particles rather than the error in measuring each diameter.

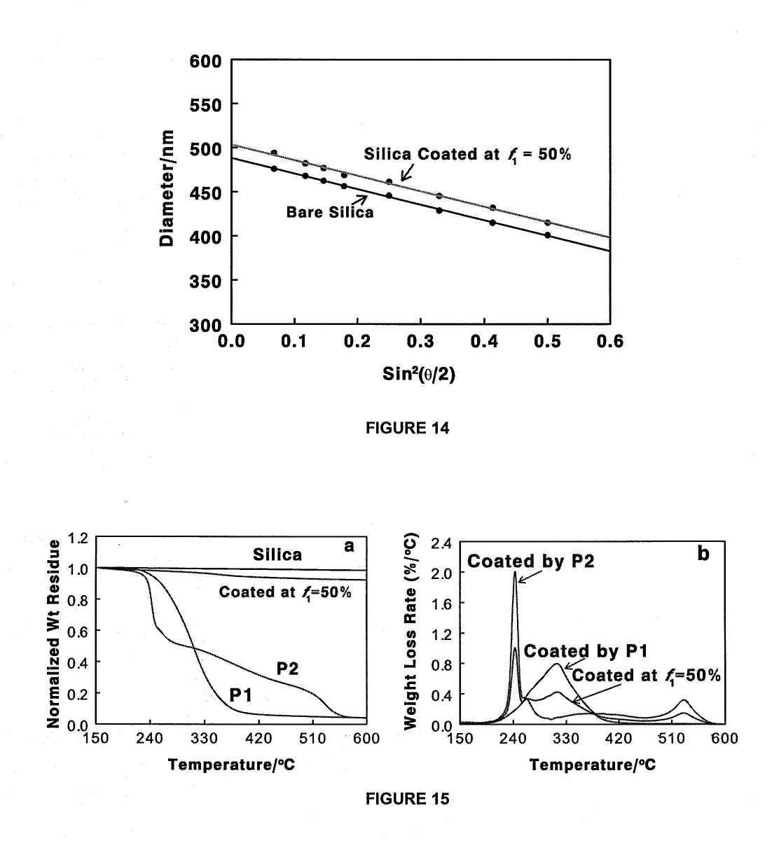

Silica particles that were re-dispersed into methanol were analyzed at a regulated temperature of 20.0° C. by DLS to yield their hydrodynamic diameters dₕ at different scattering angles θ. Plotted in FIG. 14 is the variation of the measured dₕ with sin²(θ/2). It can be seen that dₕ value increased as 0 decreased. Extrapolating 0 to zero yielded a dₕₒ value of 488.3±0.8 nm, where 0.8 nm was the extrapolation error for the determined average dₕₒ value.

The dₕ increase with decreasing A was not surprising. Larger particles scatter preferentially at small 0 values. At larger 0 values where only the smaller particles contribute significantly to the detected intensity, the scattering-intensity-average size should be smaller. This scattering-intensity-average size increased as 0 decreased or when the larger particles contributed increasingly towards the scattered intensity (Berne, B. J. P., R., Dynamic Light Scattering with Applications to Chemistry, Biology, and Physics, Dover Publications, Inc.: Mineola, N.Y., 1976; Pencer, J. and Hallett, F. R., Langmuir, 2003, 19, 7488-7497).

The dₕ₀ value was larger than the TEM diameter mainly for two reasons. Firstly, dₕ₀ was the scattering-intensity-average or z-average diameter of the particles and the TEM diameter was the number-average value. For a disperse sample, the former term should be larger than the latter. Secondly, the TEM diameter was that of the dry particles, while the dₕ₀ value included a contribution from a layer of solvent molecules adsorbed onto the silica particles.

Silica Coating. The sol-gel reactions of the PIPSMA blocks of P1 and P2 were catalyzed by HCl and performed at room temperature for 10 h. The weight ratio used between a polymer or a polymer mixture and silica was always 0.080/1.00. The coated silica particles were settled via centrifugation and thus freed from the un-grafted polymer, catalyst, and other soluble impurities, which remained in the supernatant. Furthermore, the purified coated silica particles were heated in a 100° C. vacuum oven for 2 h to complete the silanol condensation reaction.

FT-IR was used to demonstrate the condensation between the silica surface silanol groups and the silanol groups of sol-gelling PIPSMA, as presented previously (Xiong, D. et al., Chem. Mater., 2011, 23, 4357-4366). Anecdotal evidence supporting successful silica coating by the block copolymers was the altered dispersion properties of the coated particles. While bare particles were dispersible in methanol but not in trifluorotoluene (TFT), particles coated by a mixture of P1 and P2 were readily dispersed in TFT because of the solubility of both PFOEMA and PtBA in TFT. While the particles coated at low P1 weight ratios, e.g. at f₁=0%, were dispersible in methanol, a good solvent for PtBA, particles coated at sufficiently high A values, e.g. at f₁=50%, did not disperse well in methanol due to the insolubility of PFOEMA in this solvent.

An increase in the determined dₕ₀ value provided direct evidence of particle coating. Particles coated at f₁=50% were studied by DLS. Since these particles did not disperse well into methanol (the solvent used for bare silica analysis), the coated silica particles were analyzed in TFT. Fortunately, the refractive index and viscosity data were accurately known at 20.0° C. for these two solvents (DeLorenzi, L. Et al., Chem. Eng. Data, 1996, 41, 1121-1125; Lide, D. R., CRC Handbook of Chemistry and Physics. 76^{th} ed., CRC Press: Boca Raton, 1995). Thus, comparable DLS studies were performed at this temperature.

FIG. 14 also shows the variation in the DLS dₕ of the coated silica particles with sin²(θ/2). The dₕ-vs.-sin²(θ/2) line paralleled that of uncoated particles, suggesting that the coating procedure did not lead to particle degradation or aggregation and also that the coating conformed to the shape of the original silica particles. Extrapolating to zero scattering angle yielded a dₕ₀ value of 503.6±1.4 nm. This represented a 15.3±2.4 nm increase relative to that of uncoated silica. The thickness of the conforming coating should be 7.7±1.2 nm.

While the above comparative study yielded a reasonable dₕ₀ increase, it should be kept in mind that assumptions were made to extract the dₕ₀ values. Strictly speaking, dₕ is a function of both particle concentration c and sin²(θ/2). The c dependence was not examined in this comparative study because it was assumed that contributions to dₕ₀ from the c term cancelled each other for the two types of particles examined. It should also be realized that particle concentrations used were low at 0.5 mg/mL, and thus the contribution of the c term to dₕ₀ should be small in each case.

Quantification of Grafted Polymer Amounts. Grafted polymer amount in a coated silica sample was determined via TGA. TGA curves were obtained by heating samples in air from room temperature to 700° C. at 5° C./min. The residual weight of each sample at each temperature was then normalized to that measured at 150° C. The weight at 150° C. was taken as the intrinsic weight of a sample because sorbed moisture would have evaporated and sample degradation would not have begun by this temperature. Plotted in FIG. 15a are the normalized TGA curves for uncoated silica particles, silica particles that were coated at f₁=50%, as well as P1 and P2 that were sol-gelled under conditions similar to those used to coat silica particles.

As expected, bare silica was thermally stable, experienced little weight loss and had a weight residue of 98.4% when heated from 150 to 600° C. Over the same temperature range, the sol-gelled P1 and P2 copolymers were mostly decomposed and had residual weights of 4.2% and 4.1%, respectively. It is possible that silicone oxide formation from the sol-gelled PIPSMA blocks of P1 and P2 was a source of the detected residues. Particles coated at f₁=50% had by 600° C. a cumulative weight loss of 7.7% or a residual weight of 92.3%, which was expectantly between those of silica and the sol-gelled polymers. Aside from residue readings, the curves revealed different weight loss patterns for the sol-gelled P1 and P2 copolymers, and these patterns were more clearly seen in the differential TGA curves shown for silica particles coated by P1, by P2, and by P1 and P2 at f₁=50%. While P1-coated silica particles lost weight continuously between 200 and 400° C., P2-coated silica particles exhibited three major weight loss regions centered near 243, 391, and 530° C.

FIG. 15 shows that the sol-gelled P1 and P2 had weight loss patterns identical to those of P1 and P2 that were grafted onto silica. We further assumed that the silica component of a coated silica particle displayed similar thermal behavior as that of an uncoated silica particle. This allowed us to relate, at each temperature, the weight residue of a coated silica sample to those of uncoated silica samples as well as sol-gelled P1 and P2 copolymers. If the residues at a given temperature for sol-gelled P1, sol-gelled P2, silica, and coated silica are R₁, R₂, R_{S}, and R_{PS}, individually, and the grafted P1 and P2 weight fractions in a coated silica sample are respectively x and y, the following equation applies:

R₁x+R₂y+(1−x−y)R_{S}=R_{PS} (1)

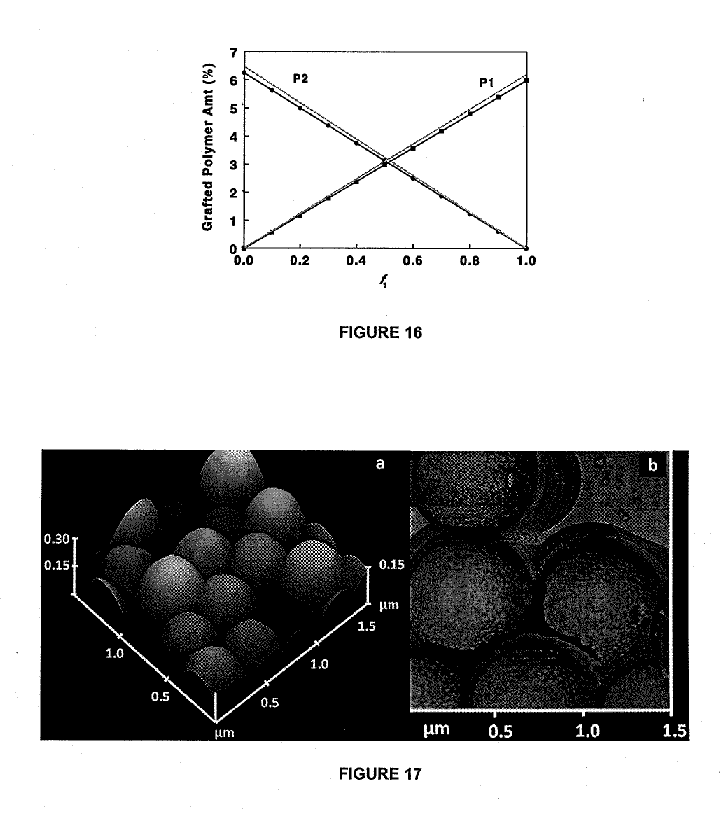

Since there were two unknowns in eq. (1), the R₁, R₂, R_{S}, and R_{PS} values had to be obtained at a minimum of two temperatures to solve for x and y. The weight residues at 300 and 400° C. were used for each coated silica sample to quantify the amounts of grafted P1 and P2. The two temperatures were chosen because the decomposition of P2 and P1 was mainly responsible for the weight loss of a coated silica sample at the lower and higher temperatures, respectively, and the use of the residual values at these temperatures would allow more accurate quantification of the amounts of grafted P2 and P1. Following this method, the x and y values were calculated for samples coated at different f₁ values and plotted in FIG. 16. As f₁ increased, x increased and y decreased linearly in agreement with the theoretical prediction.

If all of the isopropyloxy groups of PIPSMA were hydrolyzed and the resultant silanol groups were fully condensed to form siloxane (Si—O—Si) bonds, the effective chemical formula for a sol-gelled IPSMA unit was C₇H₁₁SiO_{3.5}, where the oxygen number was not an integer because each of the 3 siloxane oxygen atoms were shared by two Si atoms. Using this effective formula, 0.080 g of P1 was calculated to yield 0.066 g of grafted polymer. Under the standard silica coating conditions, the P1 to silica weight ratio used was 0.080/1.00. Assuming quantitative polymer grafting, the polymer weight fraction in the P1-coated silica should be 0.066/(0.066+1.00) or 6.2%. Assuming quantitative grafting, the P2 weight fraction in a P2-coated silica sample could be calculated analogously and should be 6.5%. When the particles were coated by a mixture of P1 and P2 at a P1 weight fraction of f₁, the grafted P1 weight fraction in the coated silica, as derived in the Supporting Information (SI), should follow:

x≈0.062f₁ (2)

and amount of grafted P2 should follow:

y≈0.065(1−f₁) (3)

Also plotted in FIG. 16 were the straight lines drawn following eqs (2) and (3). The calculated and experimentally determined x and y amounts agreed well with each other. This showed that the polymers were essentially quantitatively grafted.

Co-Grafting of P1 and P2 onto the Same Silica Particles. DLS and TGA results so far have confirmed the grafting of P1 and P2 onto silica particles but provided no clue on the distribution of the grafted chains. Due to the likely incompatibility between PtBA and PFOEMA, the different diblock copolymers might preferentially graft onto different particles. When they were grafted onto the same particles, they could attach onto the opposite sides of a particle to yield Janus particles (Walther, A. and Muller, A. H. E., Soft Matt., 2008, 4, 663-668; Liu, Y. F. et al., Macromolecules, 2003, 36, 7894-7898), form patches enriched by one polymer to yield patched particles (Zheng, R. H. et al., J. Am. Chem. Soc., 2005, 127, 15358-15359; Hoppenbrouwers, E. et al., Macromolecules, 2003, 36, 876-881), or they could graft randomly.

FIG. 17 shows AFM topography and phase images of silica particles coated at f₁=50% and cast onto a silicon wafer from TFT (C₇H₅F₃), a good solvent for both PtBA and PFOEMA. While the particles appeared smooth in the topography image, the phase image clearly revealed the presence of circular or elongated brighter patches dispersed in a darker phase. The smallest dimension of these dark patches was approximately 10 nm. This suggested the binary composition of the particle surfaces and thus the co-grafting of P1 and P2 chains onto the same particles.

In FIG. 17, part (b), patched grafting of P1 and P2 is suggested. This was possible because the PFOEMA and PtBA blocks were probably incompatible and would tend to segregate. This segregation had to compete with the grafting reaction, which was probably controlled by kinetics and would predominantly yield a randomly-grafted layer. Patched P1 and P2 grafting occurred because of the simultaneous interplay of thermodynamic and kinetic factors.

However, a similar phase image could result even if P1 and P2 chains were randomly distributed. According to Marko and Witten (Marko, J. F. and Witten, T. A., Phys. Rev. Lett., 1991, 66, 1541-1544) or Zhulina and Balazs (Zhulina, E. and Balazs, A. C., Macromolecules, 1996, 29, 2667-2673), two types of highly incompatible surface chains could be uniformly grafted and thus be uniformly distributed on the grafting substrate. Further away from the substrate, the chains could still laterally segregate into patches with dimensions comparable to the unperturbed root-mean-square end-to-end distance (Rₙ) of the grafted chains. This picture has been confirmed by Muller using a self-consistent field theory analysis (Muller, M., Physical Review E, 2002, 65, 030802(R)). According to Muller, the lateral segregation pattern of the top part of the grafted chains could change from a rippled phase to a tetragonally-packed dimpled phase, and then to a hexagonally-packed dimpled phase as the incompatibility between the grafted chains increased. Thus, the circular and elongated patches observed in FIG. 7b could also be due to a surface dimpled or rippled phase despite the uniform grafting of the P1 and P2 chains.

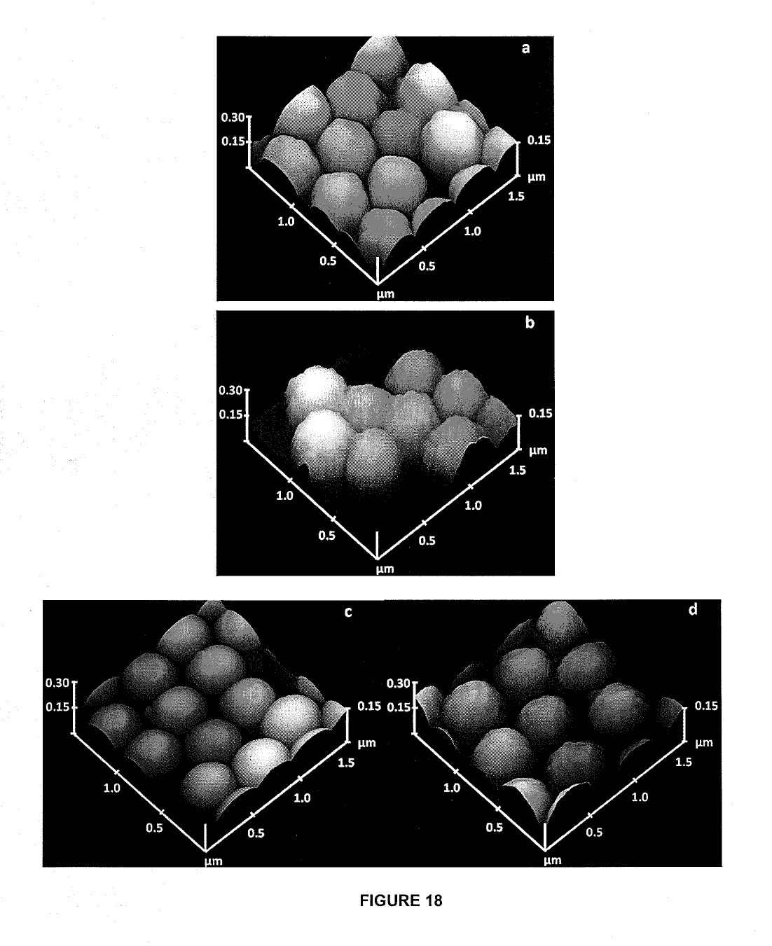

Co-deposition of two types of polymer chains onto the same silica particles was further supported by comparing AFM images of silica particles coated at different f₁ and cast from different solvents. FIG. 18 compares AFM topography images of silica particles that were coated by pure P2 and coated by a mixture of P1 and P2 at f₁=25% and 50% and were cast from either CH₃OH or perfluoromethylcyclohexane (C₇F₁₄). Here CH₃OH and C₇F₁₄ were selective towards PtBA and PFOEMA, respectively. While particles coated by pure P2 were round and smooth and were analogous to those that were coated by pure P1, particles that were coated by P1 and P2 mixtures were rugged after being cast from these selective solvents. Particles coated by a singular brush were smooth, because the polymer chains collapsed uniformly on the silica surface after solvent evaporation. Particles coated by a mixture of P1 and P2 appeared rugged because the particles were co-grafted by the two different polymers and these two polymers collapsed to different degrees when the particles were last cast from a selective solvent.

In sum, the AFM study suggests that P1 and P2 co-condensed on the same silica particles. Also, they were grafted either in a patched or uniform fashion.

Grafting of Unimolecular Layer. We previously reported on silica coating by P1 alone and drew conclusions about unimolecular layer formation from P1 under our coating conditions based on the following considerations (Xiong, D. et al., Chem. Mater., 2011, 23, 4357-4366): Firstly, the amount of grafted polymer as determined by TGA increased initially with the feed weight ratio (mₚ/mₛ) between P1 and silica and then approached an asymptote at high mₚ/mₛ values. This was a trend that would be anticipated for unimolecular layer adsorption.^{49,50} Secondly, the thickness of a saturated layer that was grafted at a sufficiently high mₚ/mₛ value was slightly smaller than the contour length of the fully stretched PFOEMA block. Thirdly, our XPS analysis confirmed that the grafted layer was covered by the PFOEMA block. This suggested that the polymer was grafted via the PIPSMA block and possessed the anticipated layered structure.

Here, we report that a mixture of P1 and P2 replaced P1 and was used to coat silica particles. Since the polymer to silica weight ratio was optimal for unimolecular layer formation and also the sol-gel chemistry should be the same, a similar unimolecular layer grafting behavior was anticipated, i.e., the PIPSMA blocks of P1 and P2 should anchor onto the silica particles and a mixture of PtBA and PFOEMA should top the sol-gelled PIPSMA blocks.

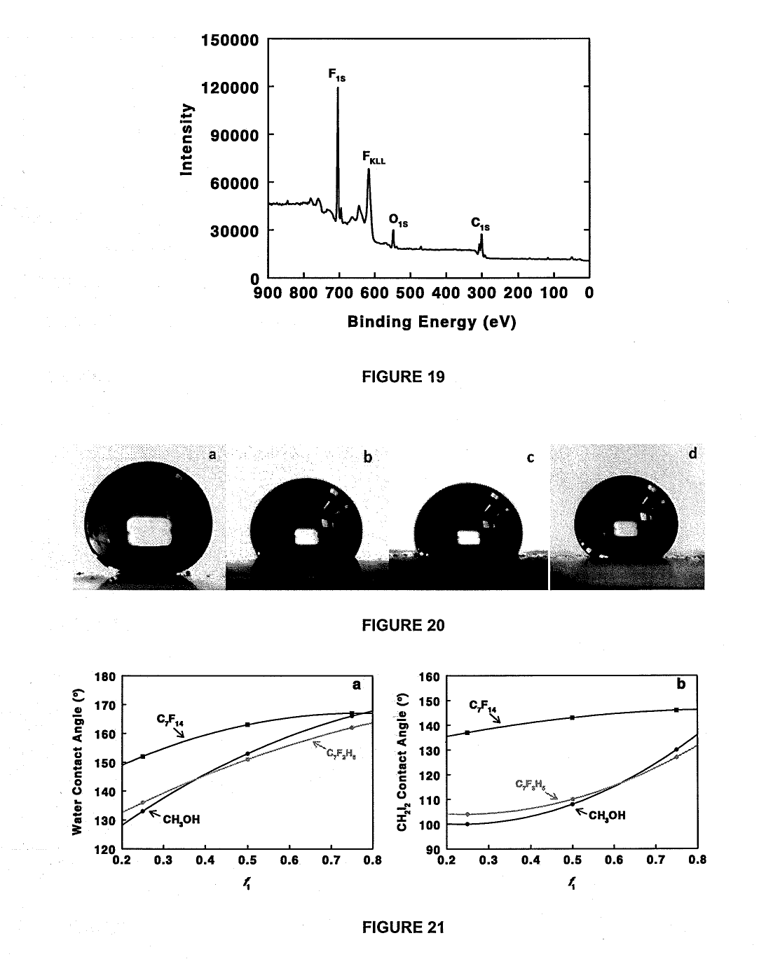

XPS was used to probe the surface composition of the coated silica samples. Silica particles were coated at f₁=50%, dried, and then re-dispersed into C₇H₅F₃. This dispersion was cast onto a silicon wafer to yield a silica particulate film for XPS analysis. FIG. 19 shows the XPS spectrum of this silica particulate film. The characteristic 2S and 2P peaks of silicon normally observed at 166 and 116 eV were not present (Xiong, D. et al., Chem. Mater., 2011, 23, 4357-4366). Rather, fluorine peaks dominated the spectra. Since the sol-gelled PISPMA blocks contained silicon, the spectrum suggested that the PFOEMA block topped the sol-gelled PIPSMA blocks.

The same conclusion could not be made from the XPS spectrum about the location of the PtBA block because PtBA lacked characteristic XPS peaks. However, the PtBA block must have co-existed with the PFOEMA block in the corona because its presence on the surface was essential for explaining the AFM images discussed above.

While the XPS data above did support a unimolecular layer coating model, stronger support was rendered by the solvated coating thickness of 7.7±1.2 nm obtained from DLS analysis of silica particles that were coated at f₁=50%. At 70 repeat units and possessing a characteristic ratio of 6.25,⁵¹ the PtBA block had a fully stretched chain length of 17.6 nm and an unperturbed root-mean-square end-to-end distance of 4.6 nm. The solvated layer thickness of 7.7±1.2 nm was between 4.6 and 17.6 nm, and was thus a reasonable unimolecular layer thickness.

The thickness of a layer coated at f₁=50% after drying could also be calculated based on the assumptions that the silica particles were perfect spheres, the coating was perfectly smooth, and that the polymers were quantitatively grafted. This layer was expected to be 6.0 nm thick, a value that is also reasonable for a unimolecular layer. Aside from being a unimolecular layer, the chains in this layer were expected to be crowded. Chain grafting densities for coatings prepared at f₁=0%, 50%, and 100% and those for the chain densities at which the grafted chains began to overlap were calculated, as explained below. Since the former densities were much larger than the latter, the grafted PtBA chains should be stretched.

Derivation of Equations 2 and 3. Supposing that a total of 0.080 g of P1 and P2 at a P1 mass fraction of f₁ was used to coat 1.00 g of silica particles and the masses of P1 and P2 were m₁ and m₂, respectively, we have

m₁=0.080×f₁ (1S)

and

m₂=0.080×(1−f₁) (2S)

If we further assume that the PIPSMA blocks of P1 and P2 after sol-gel reaction had the effective formula of C₇H₁₁O_{3.5}Si, only 82.3% of m₁ and 87.5% of m₂ were eventually grafted onto silica. Thus,

$$x = \frac{0.080 \times 82.3 \% {f}_{1}}{\begin{matrix}1.00 + 0.080 \times 82.3 \% {f}_{1} + \\ 0.080 \times 87.5 \% ( 1 - {f}_{1} )\end{matrix}} \approx 0.062 {f}_{1} . \qquad ( 3 S )$$

Thickness of a Dried Grafted Layer. The thickness of a grafted and dried P1 and P2 layer coated at f₁ were calculated based on several assumptions. First, based on data of FIG. 16 we assumed quantitative grafting of P1 and P2 under our coating conditions. Second, silica particles were assumed to be perfectly spherical with a radius Rₛ of 207 nm and a density ρₛ of 1.82 g/cm³. Third, after drying a mixed uniform P1 and P2 layer was assumed to form around the silica. Based on these assumptions and the fact that a total of 0.080 g of P1 and P2 at a P1 mass fraction of f₁ was used to coat 1.00 g of silica particles, the volumes of silica V_{S}, sol-gelled P1 V_{P1}, and sol-gelled V_{P2} were calculated and used to estimate h using:

$${( \frac{{R}_{S} + h}{{R}_{S}} )}^{3} = \frac{{V}_{S} + {V}_{P 1} + {V}_{P 2}}{{V}_{S}} \qquad ( 4 S )$$

To calculate V_{P1} and V_{P2}, we needed the density values for sol-gelled P1 and P2. To calculate the densities of sol-gelled P1 and P2, we further assumed that the density of the sol-gelled and grafted PIPSMA layer was the same as silica at 1.82 g/cm³. The density of PtBA was measured by us before (Liu, G. J. et al., Chem. Mater., 1999, 11, 2233-2240) to be 1.02 g/cm³ and that of PFOEMA (ρₜₒₚ) should be close to 1.85 g/cm³, which was calculated for poly[2-(perfluorooctyl)ethyl acrylate] from a group contribution method (Kim, J. et al., Macromolecules, 2007, 40, 588-597). Densities ρ_{P} of grafted P1 and P2 were thus estimated to be 1.84 and 1.10 g/cm³ using:

1/ρ_{P}=fₜₒₚ/ρₜₒₚ+(1−fₜₒₚ)/ρ_{S} (5S)

Here fₜₒₚ, the mass fractions of the PFOEMA and PtBA block in the grafted P1 and P2 layers, were calculated to be 74.9% for P1 and 83.3% for P2, which contained a fully sol-gelled IPSMA block with an effective formula of C₇H₁₁O_{3.5}Si.

h values were calculated to be 7.7, 6.0, and 4.4 nm at f₁=0%, 50%, and 100%, respectively.

Chain Grafting Density Calculation. Based on assumptions mentioned above, the number of silica particles making 1.0 g of silica can be calculated using:

$${n}_{s} = \frac{1.0}{( 4 / 3 ) π {ρ}_{S} \text{?}} \\ \text{?} \text{indicates text missing or illegible when filed} \qquad ( 6 S )$$

The total surface area of these silica particles is

A_{S}=n_{S}4πR_{S}²=3/(ρ_{S}R_{S}) (7S)

The number of chains N making up 0.080 g of polymer mixture having a composition of f₁

$$N = 0.080 ( \frac{{f}_{1}}{{M}_{1}} + \frac{1 - {f}_{1}}{{M}_{2}} ) {N}_{A} \qquad ( 8 S )$$

where N_{A} is the Avogadro number, and M₁ and M₂ are the molar masses of P1 and P2, are 8.6× and 12.3×10³ g/mol, respectively. The number of chains g grafted per nm² of silica surface could be calculated using

$$g = \frac{0.080 ( {f}_{1} / {M}_{1} + ( 1 - {f}_{1} ) / {M}_{2} ) {ρ}_{s} {R}_{s} {N}_{A}}{3} \qquad ( 9 S )$$

The g values for silica coated at f₁=100%, 50%, and 0% were 0.70, 0.60, and 0.49 chain/nm², respectively.

Crowded. Unimolecular. Layer. We showed chain crowding for the two extreme cases where silica was coated by P1 or P2 alone. If silica was coated by P2 alone, we started by calculating the area occupied by each unperturbed PtBA chain. Possessing a characteristic ratio of 6.25 (Jerome, R. and Desreux, V., Eur. Polym. J., 1970, 6, 411-421), the PtBA block consisting of 70 units had an unperturbed radius of gyration of 1.9 nm. Thus, each PtBA chain should have an unperturbed area of 11.3 nm². At the onset of chain overlapping, polymer grafting density should be 0.088 chain/nm². Since this was much smaller than the 0.49 chain/nm² calculated for the grafted P2 layer, it is expected that grafted P2 chains existed in a brush configuration.

The FOEMA units of the PFOEMA block are rod-like and tend to form a liquid crystalline phase at room temperature. Because of the bulkiness of FOEMA units, a PFOEMA methacrylate backbone should be approximately fully stretched as well. Thus, the lateral dimension of an unperturbed PFOEMA block would be approximately equal to twice the contour length of a PFOEMA side chain consisting of a perfluorooctylethyl unit plus a COO group, and would be ˜3.0 nm. Using a radius of 1.5 nm, we calculated an unperturbed area of 7.0 nm² per chain. At the point when different PFOEMA units start to overlap, grafting density should be 0.14 chain/nm², which was again substantially smaller than 0.70 chain/nm². Thus, grafted P1 chains were crowded as well.

Since surface chains were crowded on particles coated at f₁=0% and 100%, they should be crowded on particles coated at f₁=50%, especially since repulsion between the PFOEMA and PtBA chains would be stronger than those among similar chains. Therefore, it is expected that PtBA and PFOEMA chains in our coatings are crowded.

Despite the crowding of the PtBA and PFOEMA chains and their high g values of 0.70, 0.60, and 0.49 chain/nm² for silica coated at f₁=100%, 50%, and 0%, respectively, we point out that our chains were not as crowded as those obtained from a “graft from” method (Tsujii, Y. et al., Adv. Polym. Sci., 2006, 197: 1-45). While the absolute grafting density was high at 0.49 chain/nm² when P2 was used to coat silica, the grafted PtBA chains were short at 70 repeat units. Because of this, the ratio between the determined chain grafting density of 0.49 chain/nm² and the overlapping chain grafting density of 0.088 chain/nm² was only 5.6. This is a value easily achievable from physical deposition of diblock copolymer chains from a block-selective solvent, as reported previously (Tao, J. et al., Macromolecules, 1998, 31, 172-175; Ding, J. F. et al., Macromolecules, 1996, 29, 5398-5405).

Wetting Properties of Films of Coated Silica. Mixed brushes have attracted attention due to their stimuli-responsive properties (Stuart, M. A. C. et al., Nat. Mater., 2010, 9, 101-113; Tsujii, Y. et al., Adv. Polym. Sci., 2006, 197, 1-45; Zhao, B. and Brittain, W. J., Progr. Polym. Sci,. 2000, 25, 677-710; Minko, S., Polymer Reviews, 2006, 46, 397-420). The polymer chains in these layers change their organization and thus modulate their surface properties in response to changes in external medium, pH, temperature, or ionic strength. The PtBA and PFOEMA blocks in the corona of our particles should also be stimuli-responsive. This was demonstrated by AFM, which revealed that segregation patterns of PtBA and PFOEMA changed depending on the solvent from which the silica particles were cast. If sufficient silica particles were cast, they fused into particulate films. Thus, another way to verify the responsiveness of the surface structure to the casting solvent has been to monitor water and oil (CH₂I₂) contact angle changes among these cast silica films.

FIG. 20 compares photographs of a water droplet and CH₂I₂ droplets on films of silica coated at f₁=75%. The water contact angle on a silica particle film cast from methanol was 166±2°. The CH₂I₂ contacts angles were 130±2°, 127±2°, and 146±2° on silica particulate films cast from CH₃OH, C₇F₃H₅, and C₇F₁₄, respectively. Thus, contact angles of CH₂I₂ droplets changed depending on the casting solvent that was used for a given silica sample.

Water was further noted to be very unstable on surfaces of particles coated at f₁=75% and could readily roll off the surface. To obtain a stable droplet for photography, the droplet had to be dispensed with care and the material surface had to be very level. This behavior and the >150° contact angle for water suggested that this material surface was superhydrophobic. Also, the contact angle difference between different samples was real and was not an artifact derived from the sample preparation protocol. Despite the crude nature of the particulate film preparation protocol, the contact angle changes were within ±2° for a given sample from different films.

Results of a more comprehensive study are shown in FIG. 21, where water and CH₂I₂ contact angle values were plotted as a function of the casting solvent and f₁ at which the silica particles were coated. The general trends were: a) water or oil repellency improved as f₁ increased, b) films cast from C₇F₁₄ were superhydrophobic at all tested f₁ values and possessed the best water or oil repellency, and c) films cast from methanol possessed better water and oil repellency than those cast from C₇H₅F₃ at f₁=75% and this trend was reversed at f₁=25%.

It is not surprising that oil and water repellency improved with increasing f₁ values. A first criterion for enhanced oil and water repellency or amphiphobicity is the low surface tension of the coating. The surface tensions of PtBA (Li, S. Y. et al., Microelectron. Eng., 2010, 87, 715-718) and PFOEMA (Hirao, A. et al., Progr. Polym. Sci., 2007, 32, 1393-1438) are 31.2 and ˜7 mN/m, respectively. Increasing the presence of PFOEMA in a material surface should enhance its amphiphobicity.

Films cast from C₇F₁₄ should have the best amphiphobicity because C₇F₁₄ was a selective solvent for PFOEMA. Casting from such a solvent should help enrich the material surface with PFOEMA.

When cast from methanol, a selective solvent for PtBA, the silica surfaces should be enriched with PtBA. From surface tension considerations alone, films of these silica particles should have the lowest H₂O and CH₂I₂ contact angles. While this was true on films of silica coated at f₁=25%, the H₂O and CH₂I₂ contact angles were larger on films of silica particles that were coated at f₁=75% and cast from methanol than on those cast from C₇H₅F₃, a mutual solvent for PtBA and PFOEMA. A comparison of the AFM images in FIGS. 17 and 18 suggested that the particles cast from methanol bore nanometer-sized bumps while those cast from C₇H₅F₃ did not. Thus, the former particles had higher surface roughness. It is well known that surface roughness also helps increase droplet contact angles if the droplet contact angle on a flat surface is already >90°. Thus, the surface roughness of the silica coated at f₁=75% probably played a more important role than the surface composition in boosting the liquid contact angles.

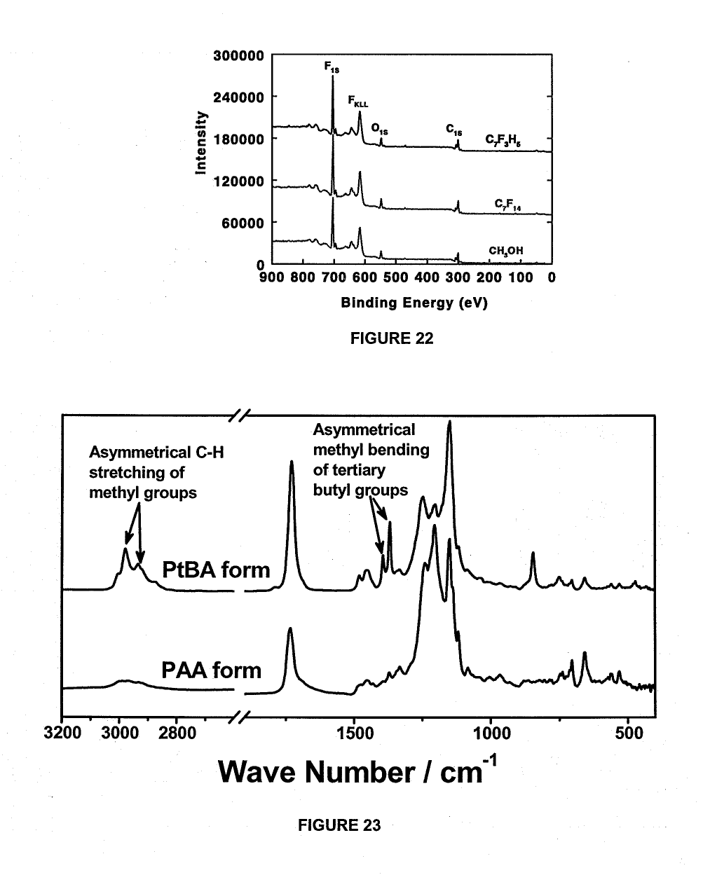

Significant contact angle changes, from 133 to 152° for H₂O and from 100 and 137° for CH₂I₂, were observed on films of silica coated at f₁=25% by changing the casting solvent from CH₃OH to C₇F₁₄. Two factors probably contributed to this. Firstly, both PtBA and PFOEMA were hydrophobic and a switch from superhydrophobicity to superhydrophilicity would be unlikely if these two polymers were used. Secondly, neither the PFOEMA nor the PtBA block used was long enough for one block to fully cover the other block when the particles were cast from a block-selective solvent for PFOEMA or PtBA. This was also deduced from a comparison of the XPS spectra shown in FIG. 22, where XPS spectra of particulate films of silica coated at f₁=50% but cast from different solvents including CH₃OH, C₇F₁₄, and C₇H₅F₃ are compared.

The spectra all looked very similar regardless of the casting solvent, suggesting the thinness of the topping PFOEMA or PtBA layer relative to the pathlength of the X-ray-generated electrons. Nevertheless, we have shown that solvent-switchable surfaces were achieved from silica particles that were simultaneously coated by two diblock copolymers.

In summary, in this example PFOEMA-b-PIPSMA (P1) and PIPSMA-b-PtBA (P2) with low polydispersity indices were synthesized by anionic polymerization. Catalyzed by HCl, P1 and P2 were co-grafted in a one-pot reaction onto silica particle surfaces. A simple and effective method based on TGA was developed for determining the amounts of grafted P1 and P2 copolymers. The copolymers were shown to graft essentially quantitatively under the applied coating conditions. The relative quantities of grafted P1 and P2 copolymers could be tuned by changing the P1 and P2 weight ratios. An AFM study suggested that P1 and P2 copolymers were co-grafted onto the same silica particles in either a patched or uniform fashion. XPS analysis indicated that the PFOEMA block topped the sol-gelled PIPSMA block, suggesting polymer grafting by the PIPSMA block. When studied by DLS, the silica particles coated at f₁=50% exhibited a hydrodynamic diameter increase of 15.3±2.4 nm or a solvated coating thickness of 7.6±1.2 nm. The reasonable grafted layer thickness and the desired layered structure of the grafted layer suggested that P1 and P2 were grafted as a unimolecular layer. Interestingly, this mixed unimolecular layer bearing PFOEMA and PtBA coronal chains was stimuli-responsive. Wetting properties of films of the cast particles changed with the casting solvent. Casting from C₇F₁₄, a selective solvent for PFOEMA, enriched the film surfaces with PFOEMA and thus increased oil and water repellency of the silica particulate films. Also, oil and water repellency improved as f₁ increased under otherwise identical conditions. When they were cast from C₇F₁₄, films of silica coated at f₁=25%, 50%, and 75% were all superhydrophobic.

### Example 11

### Block Copolymer Approach to Bi-functional Silica Particles for Robust Oil- and Water-Repellent Coatings

Silica particles bearing poly(perfluorooctylethyl methacrylate), PFOEMA, and poly(tert-butyl acrylate), PtBA, coronal chains were derivatized and used to fabricate oil- and water-repellent or amphiphobic particulate coatings. To prepare bi-functional particles bearing two types of coronal chains, PIPSMA-b-PFOEMA (P1) and PIPSMA-b-PtBA (P2) were used together to coat silica particles. Here PIPSMA denotes poly[3-(triisopropyloxysilyl)propyl methacrylate] and is sol-gel forming. Under appropriate conditions, the PIPSMA block of the two polymers co-condensed onto the surface of each silica particle. By changing the mass ratio of the two coating polymers, we were able to adjust the relative amounts of P1 and P2 grafted onto silica particles. We were also able to tune the vertical positioning of the two types of chains. This was achieved by dispersing the coated particles in trifluorotoluene, a good solvent for both PtBA and PFOEMA, and then adding a selective solvent for one of these two polymers. Depositing these particles in the selective solvent onto a material surface such as glass plates yielded particulate films in which the particles were enriched by the polymer that was last selectively solubilized. Therefore, these particles were used to yield particulate coatings with surface wetting properties that could be tuned either by changing the relative grafted P1 and P2 amount on the silica surfaces or by changing the last solvent from which the coated particles were deposited. When the P1/P2 mass ratio was high and after PtBA hydrolysis into poly(acrylic acid), these bi-functional particles were sprayed onto epoxy coatings that only partially cured. Upon further epoxy curing, a rough coating with covalently-attached bi-functional particles was obtained. These coatings were superhydrophobic and robust.

Materials and Reagents. Tetrahydrofuran (THF, Caledon, >99%) was dried by refluxing with sodium and a small amount of benzophenone until a deep purple color developed and was distilled just before use. HCl in dioxane (4.0 M) was purchased from Aldrich and was diluted by THF to 1.0 M before use. Araldite/Embed-812 Embedding Kit was purchased from Cedarlane Laboratories Limited (Burlington, Ontario, Canada). The kit consisted of 450 mL Araldite 502 (bisphenol A diglycidyl ether+dibutyl phthalate), 450 mL Embed-812 (1,2,3-propanetriol+polymer bearing chloromethyl oxirane pendant groups), 450 mL DDSA (dodecynyl succinic anhydride) and 50 mL DMP-30 (epoxy tertiary amine accelerator or 2,4,6-tris(dimethylaminoethyl)phenol). The suggested mixing weight ratios for the components were 17.0/27.5/55.0/1.45-1.80 for glue curing.

Silica Particles. Silica particles were synthesized following the Stöber method (Stober, W. et al., J. Colloid Interf. Sci., 1968, 26, 624). Tetraethoxysilane (2.0 g) was dissolved into 21 mL of isopropanol to yield a homogeneous solution before 0.8 mL of an aqueous ammonia solution (28 wt %) was added with vigorous stirring. This mixture was refluxed at 60° C. for 4 h, and the resultant silica particles were settled by centrifugation at 3050 g for 10 min. After discarding the supernatant, particles were redispersed into 10 mL of isopropanol and were re-settled by centrifugation and re-separated from the supernatant by decantation. This rinsing process was repeated thrice, and the final particles were dried overnight under vacuum before use.

Silica Coating. Silica was coated by P1 and/or P2 in TFT/THF using HCl as the catalyst. TFT was used to ensure the dispersion of the final particles, which bore a PFOEMA corona. Unless otherwise mentioned, silica particles were always coated using standard conditions, which involved performing the grafting reaction at 21° C. for 10 h in TFT/THF at a THF volume fraction (f_{THF}) 9.1%. The molar ratio between IPSMA, HCl, and added water was 1/1/2 (n_{Si}/n_{HCl}/n_{H2O}). The weight ratio used between polymer consisting of P1 and/or P2 and SiO₂ (m_{P}/m_{S}) was 0.08/1.00.

Specifically, P1 and/or P2 were first dissolved into THF at 5.0 mg/mL. Dry silica particles, 5.0 mg, were then mixed with 3.0 mL of TFT in a 20 mL vial and ultrasonicated for 60 s to disperse the particles. To this dispersion were then added 0.080 mL of a 5.0 mg/mL polymer solution in THF, 0.08 mL of the HCl solution (1.0 M in THF) and 3.0 μL of H₂O. The reaction was performed at room temperature for 10 hours before it was centrifuged at 3050 g for 10 min to settle the particles. After the supernatant was removed, the particles were redispersed in 2.0 mL of TFT and centrifuged again to settle the particles to remove the catalyst, byproduct, and any residual polymer that was not grafted. The particles were then vacuum-dried for 2 h in a 100° C. oven.

Hydrolysis of PtBA chain on the particle surface. Coated silica particles with different weight ratios of P1 to P2 were re-dispersed into dichloromethane at a concentration of 2.0 mg/mL. Equal volume of trimethylsilyl iodide solution in dichloromethane, 0.10 M was added under stirring and kept at room temperature overnight. The particles were washed with dichloromethane three times and centrifuged (3050 g) to remove the byproduct and the reactant before drying under vacuum.

Bi-functional Films on Coverslips. Polymer-coated silica particles were redispersed into TFT at a concentration of 2.0 mg/mL. Microscope slide coverslips were coated by casting and evaporating several drops of the silica solution onto the slips.

Bifunctional Coating. Bifunctional silica particles bearing PAA chains were redispersed into methanol at 2 mg/mL. Epoxy glue mixture consisting of Araldite 502, Embed-812, and DDSA (dodecynyl succinic anhydride) at weight ratio of 17.0/27.5/55.0 and a total concentration of 5 mg/mL in ethanol was spin-coated onto a glass plate. The epoxy glue film was cured at 60° C. for 15 min and then the bi-functional silica particles in TFT were cast onto the epoxy film. The particulate film was air-dried at room temperature and then annealed at 120° C. for 30 min before testing the surface properties.

Diffuse-Reflectance Fourier-Transform Infrared Analyses. Diffuse-reflectance Fourier-transform infrared spectra were obtained using a Varian 640-IR FT-IR spectrometer for coated silica particles and a mixture of bi-functional silica particles bearing PAA chains and Embedding 812 or Araldite 502. Bifunctional silica particles, PAA, Embedding 812, Araldite 502 and DDSA were dissolved into methanol separately at a concentration of 2.0, 5.0, 27.5, 17.0 and 55 mg/mL, respectively. To prepare a glue mixture, Araldite, Embed-812, and DDSA were mixed at equal volume and stirred overnight at room temperature. A bi-functional silica particle and Embed-812 mixture was also prepared by mixing methanol solutions of these two samples at equal volume. Samples were then dried by rotary evaporation, and cured at 60° C. overnight. Samples were then ground with KBr using a mortar and pestle to yield a powder for analysis.

Robustness of Coated Silica-Epoxy. Films. Robustness of coated silica-epoxy films was checked by TFT extraction and vortexing experiments. For the extraction experiment, the films, either pure coated silica particulate film or coated silica-epoxy film (1 cm×1 cm), were put into a 25 mL vial upside down with a copper wire supporter. TFT was added into the vial until the sample was immersed into the solvent. The solution was stirred vigorously at room temperature for 3 days. Films were picked out and rinsed with 1 mL TFT thrice and dried at room temperature in the air. For the vortexing experiment, films on glass plates were put into a 50 mL centrifuge tube and then topped with 35 mL of silica gel. The tube was taped onto a vortex machine vertically and the vortex machine was turned to its maximum power. After a pre-designated time ranging from 5 to 60 minutes, samples were taken out and blown with compressed air and rinsed with running methanol to remove the remaining silica gel. Samples were dried at room temperature in air before testing surface properties.

Scanning Electron Microscope (SEM). A Philips XL-30 ESEM FEG instrument was operated at 2 kV to obtain the scanning electron microscope (SEM) images after samples were coated by Au.

Contact Angle Measurements. All contact angles were measured at room temperature (˜21° C.). Static contact angles were measured using 5 μL droplets on a KRUSS K12 tensiometer that was interfaced with image-capturing software. Advancing and receding angles were determined by probing expanding and contracting liquid droplets, respectively. For each sample, contact angles were measured at 5-10 different positions, and reported values were the averages of these measurements. The precision of these measurements was better than ±2°. The liquids used for contact angle measurements were Milli-Q water and diiodomethane (>99%, Sigma-Aldrich).

Silica Particles Coated by P1 and P2. Silica particles were prepared by a modified Stober's method, as described above. Particles had an average TEM diameter of 415±15 nm.

Silica particles were coated by P1 and P2 in a one-pot process relying on the sol-gel reaction of PIPSMA blocks. The reaction was catalyzed by HCl and done at room temperature for 10 h. The mass ratio used between a polymer or a polymer mixture and silica was always 0.08. Un-grafted polymer, catalyst, and other impurities were separated from the coated silica by centrifugation. Furthermore, purified coated silica particles were heated in a 100° C. vacuum oven for 2 h to complete the silanol condensation reaction.

Thermogravimetric analysis indicated that the polymers were essentially quantitatively grafted under our coating conditions. Based on grafted polymer amounts, our calculations yielded grafted dry layer thicknesses of 4.4 and 7.7 nm and chain grafting densities of 0.70 and 0.49 mm² at f₁=0% and 100%, respectively. Coated particles were further studied by XPS. Since silicon signals of sol-gelled PIPSMA blocks were not seen and PFOEMA signals were pronounced, this study suggested that PFOEMA blocks were in the layer topping the sol-gelled PIPSMA blocks. A further AFM study of silica particles coated by P1 and P2 at the P1 mass fraction f₁ of 50% revealed that polymers in the top layer segregated into different patterns depending on the last solvent from which the silica particles were cast. When cast from trifluorotoluene, a good solvent for both PtBA and PFOEMA, silica particle surfaces were topographically smooth. The phase image, however, revealed the existence of 10-nm-sized patches enriched by one polymer dispersed in the other phase enriched by another polymer, suggesting P1 and P2 were co-grafted on the same silica particles, most likely in a patched or random fashion. After casting from methanol, a selective solvent for PtBA, and from (trifluoromethyl)undecafluorocyclohexae or C₇F₁₄, a selective solvent for PFOEMA, surface bumps were seen on these silica particles: H₂O and CH₂I₂ contact angle measurements yielded the highest contact angles on films of silica particles that were last cast from C₇F₁₄, suggesting that the surfaces were enriched with PFOEMA in this case.

PAA-Bearing Silica Particles. PtBA and PFOEMA chain-bearing silica particles were redispersed into dichloromethane, which is a good solvent for PtBA block. Hydrolysis of PtBA chains was performed under the catalysis of trimethylsilyl iodide at room temperature. The resulting PAA and PFOEMA chain-bearing silica particles were purified by centrifugation and then dried under vacuum. FTIR was used to monitor the process of hydrolysis. In the spectrum of PtBA and PFOEMA chain-bearing silica particles, the asymmetrical C—H stretching band of methyl groups was observed at 2961 to 2976 cm⁻¹, and asymmetrical bending of tertiary butyl groups was also observed at 1392 and 1366 cm⁻¹. These peaks disappeared in the spectrum of the particles after hydrolysis, revealeding that the tert-butyl groups were removed during hydrolysis, producing PAA (FIG. 23).

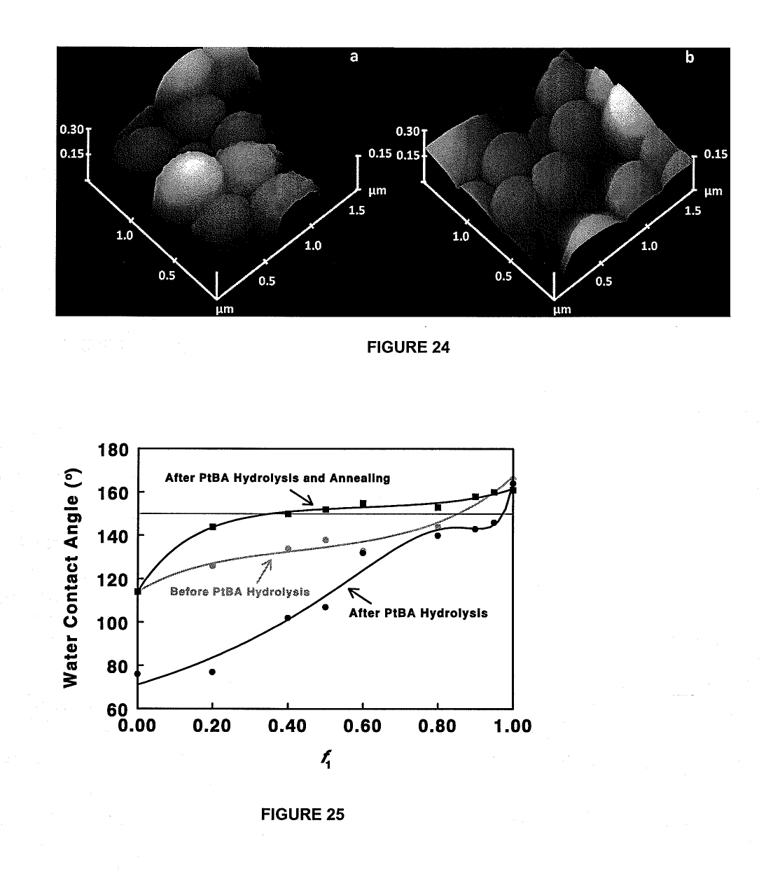

When cast from methanol, bumps around 10-nm could be seen in the topography image of the silica surface if the weight faction of P1 was 50% (FIG. 24a) or 90% (FIG. 24b), which is similar to the phase separation of the polymers before PtBA hydrolysis. This means that PAA chains remained on the top of the coating after being cast from methanol onto the material surface before annealing. This ensures that PAA chains will contact a material surface directly.

Surface Properties of Films of PAA-Bearing Particles. PtBA and PFOEMA chain-bearing silica particulate film was hydrophobic when casted from methanol. However, contact angle of water drops on the film was not sufficiently high, even at high P1 fraction (CA of water drops was around 140 degrees when f₁=0.8 while it was larger than 160 degrees when f₁=1.0, see FIG. 25, gray line). A possible explanation for this is that the surfaces of the particles were mainly covered by PtBA chains when cast from methanol, and the surface tension of PtBA is much higher than that of PFOEMA. After hydrolysis of PtBA into PAA, surface tension of polymer on the material surface became even higher when cast from methanol, and contact angles of water drops became lower (see FIG. 25, black line with solid circle dot) With increasing f₁ in the shell, more PFOEMA chains were exposed to air and contact angles became higher. In order to obtain a film with high performance of water and oil repellency, the surface of the particles must be covered by low surface tension polymer chains, e.g., PFOEMA. As shown above, one effective way to do this is to cast the particles from a PFOEMA-selective solvent. PFOEMA chains will form bumps on the surface of silica particles when cast from C₇F₁₄, and most areas of the surface will be covered by PFOEMA bumps. However, in the present experiment, because PAA chains form covalent bonds with an epoxy glue, they were covered by a PFOEMA film and therefore lacked contact with the epoxy-coated surface. The glass transition temperature of PFOEMA is lower than 100 degrees, and PFOEMA chains become mobile at high temperature. Accordingly, another method, annealing, was used to transfer PFOEMA chains from the inner layer to the top, because PFOEMA chains preferentially stay at the interface of air and solid if they can move freely. FIG. 25 shows water contact angles on the particulate film after annealing at 12 degrees for 30 min (FIG. 25, black line with solid square dot). Compared to the curve before annealing, it can be seen that contact angles increased drastically. Water contact angles were larger than 150 degrees at f₁=0.5 or higher, which was much better than for PtBA and PFOEMA bearing silica particles, and indicated that PFOEMA chains merged to the top of the coating during annealing.

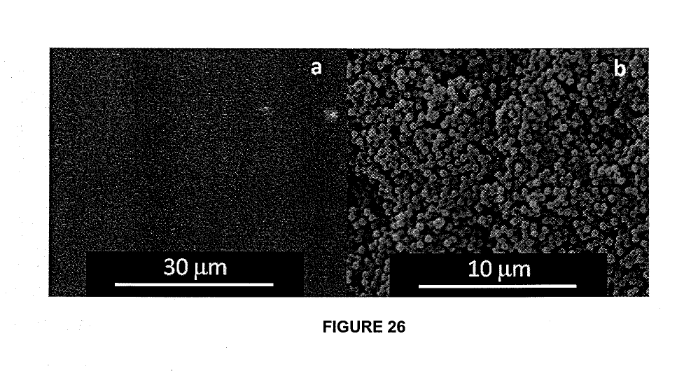

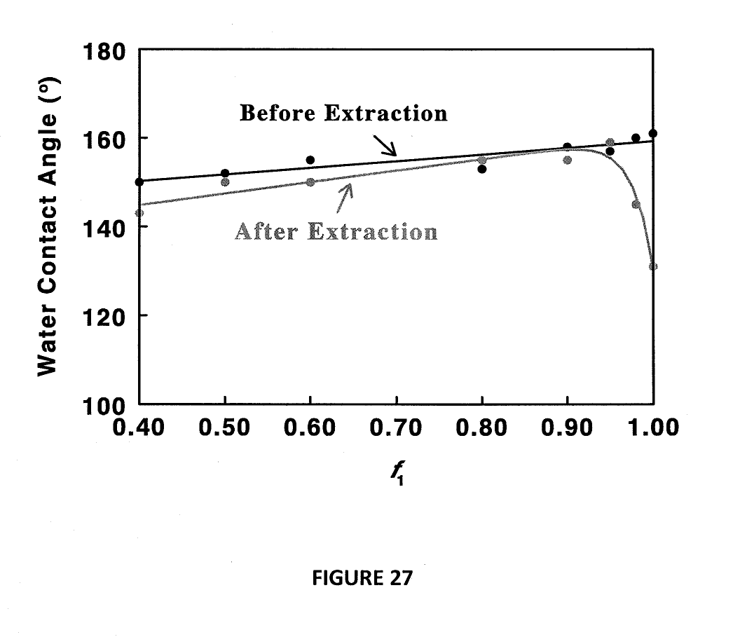

Robust Amphiphobic Particulate Coatings. It is well known that carboxyl groups will react with an epoxy ring and form a covalent bond with an epoxy glue. Poly(acrylic acid) will also react with an epoxy ring during a curing process. Diluted with methanol, embedded epoxy glue formed a uniform film, after being spin-coated onto a microscope coverslip (FIG. 26a). Spherical particles with a diameter of around 420 nm were detected by SEM when PAA-bearing bi-functional silica particles were drop-cast onto epoxy glue film. After drying the particulate film in air, samples were put into a 120° C. oven for 30 min. This treatment both accelerated the curing of epoxy resin and exposed the FOEMA chains to the surface of the silica particles. The bi-functional particulate film exhibited similar surface properties on epoxy glue as on the glass plate. Water contact angles were larger than 150 degrees when the weight fraction f₁ of P1 in the silica particle shell was larger than 0.4 and increased with increasing f1 value (FIG. 27, black line with solid spherical dot).

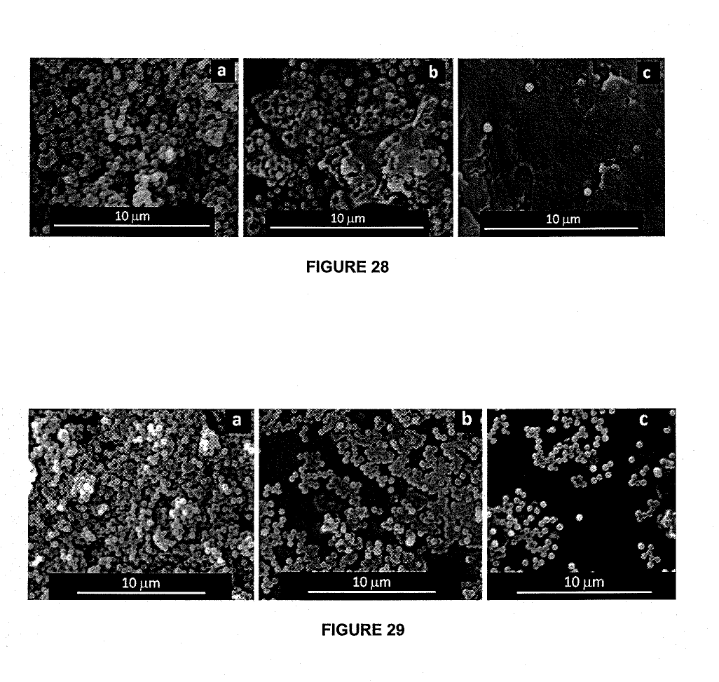

Extraction and vortex tests were used to demonstrate robustness of the bi-functional coating and functionality of PAA chains on silica particles. Silica particles coated with different weight ratios of P1 or f1 were drop cast onto epoxy film, and then extracted with TFT for 3 days with stirring. Samples were dried and annealed at 120° C. for 30 min before testing surface properties. Water contact angles on particulate film were almost the same as those before extraction, when the weight fraction of P1 in the shell was lower than 95%. Large differences were observed between water contact angles of extracted and non-extracted particulate film when the weight ratio of P1 in the shell was 98% or higher. Before extraction, contact angle of water drops on the film was around 165 degrees at f₁=0.98, and decreased to 145 after 3 days of extraction. The difference in contact angle was even greater at f₁=1.00 (FIG. 27, gray line with solid spherical dots). SEM was used to investigate what happened during extraction; images are shown in FIG. 28. At f₁=0.80, the particulate film before and after TFT extraction was almost the same and its surface consisted of a layer of dense spherical particles. For the particulate film with f₁=0.98, the film surface after extraction consisted of particle-covered regions and exposed epoxy regions, suggesting partial removal of silica particles. After extraction of a film that was prepared from epoxy and particles coated by P1 only, few particles per unit area remained, suggesting a much higher degree of particle removal. This should explain why the water contact angles decreased from 165 degrees to 145 and 131 degrees, respectively, after TFT extraction, of films prepared from particles prepared at f1=98% and 100%, individually, because the surface tension of epoxy film was higher than that of the fluorinated silica particles.

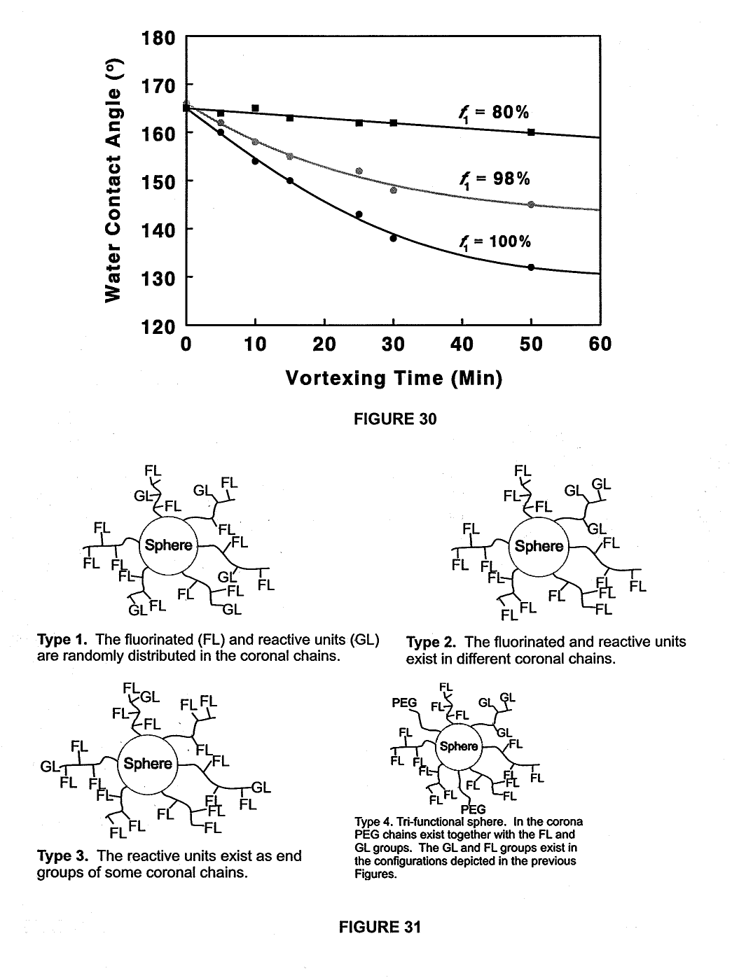

We also measured water contact angles on the particulate films that had been vortexed for different times and then cleaned, and the data were plotted in FIG. 30. After 60 min of vortexing, the water contact angle on the film of epoxy/PAA-bearing silica coated at f₁=0.8 decreased only slightly from 165 degrees to around 161 degrees. This small decrease might be due to loss of silica particles that were not attached covalently (FIG. 30, black line with solid square dots). More loss of silica particles from films of epoxy/PAA-bearing silica coated at f₁=0.98 and f₁=1.00, as revealed by SEM in FIG. 29, caused the water contact angles to decrease more, as seen in FIG. 30.

Particulate films with f₁=0.95 or lower survived in the extraction and vortex tests, while films with f₁=0.98 or higher lost their surface properties gradually during the tests. Accordingly, in this example, 5% of PAA chains or higher was needed to obtain a stable particulate film with an epoxy-coated surface.

In summary, a bi-functional silica particle was synthesized by one-pot coating PIPSPMA-b-PtBA and PIPSPMA-b-PFOEMA block copolymers onto silica particles. After hydrolysis of PtBA into PAA, the PAA carboxyl groups could form covalent bonds with an epoxy resin surface. Particulate films of epoxy/bi-functional silica bearing ˜5 wt % of surface PIPSPMA-b-PAA chains were shown to form stable films that resisted TFT extraction and wearing by silica particles. Aside from being robust, these particulate films were superhydrophobic and strongly oil repellent.

### Example 12

### One-Pot Synthesis of a Polymer Comprising 3 Functionalities (FOE-(FOEMA)₁₃-(IPSMA)₁₃-b-(HEMA-TMS)₁₀)

A polymer having the following structure was prepared:

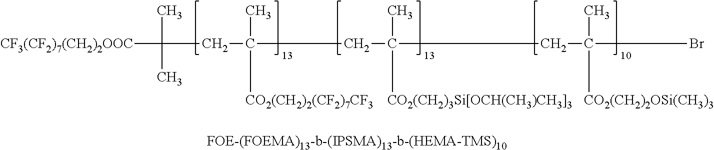

This polymer can be used to prepare tri-functional microspheres of the invention, e.g., tri-functional silica or other types of particles. The middle PIPSMA block can undergo sol-gel reactions and graft and crosslink around a substrate, e.g., silica particles. During the sol-gel process, the P(HEMA-TMS) block will hydrolyze to yield a poly(2-hydroxyethyl methacrylate) or PHEMA block, which can react with components of adhesives, e.g., epoxy or urethane glues. In this example, the PHEMA block was designed and made shorter than the PFOEMA block so that the surfaces of the coated silica particles are enriched by the fluorinated units.

The polymer was prepared by one-pot atom transfer radical polymerization of FOEMA, IPSMA, and HEMA-TMS. A fluorinated initiator, FOE-Br, was prepared by reacting 2-(perfluorooctyl)ethanol with 2-bromoisobutyryl bromide. The synthesis is referred to as a “one-pot” synthesis because the polymer was made by adding FOEMA, IPSMA, and HEMA-TMS sequentially during the polymerization at controlled time intervals, without purifying the FOE-PFOEMA or FOE-PFOEMA-b-PIPSMA precursors. Although this procedure provides economical advantages, a drawback is that the second and third blocks were not pure. Rather, the second block contained a small number of FOEMA units because the FOEMA monomer was only 85% polymerized before the IPSMA monomer was added for polymerization. Similarly, the third block contained some IPSMA units and probably some FOEMA units as well. Despite this drawback, the impure triblock polymer should still function well in making tri-functional microspheres, e.g., silica particles, for amphiphobic coatings since the fluorinated block was pure, the second block would still bind to and crosslink around silica particles if the IPSMA content were sufficiently high (e.g., about 70% or greater), and the third block would still have hydroxyl groups to react with epoxy or urethane glue components. It is noted that full polymerization of FOEMA or IPSMA should not be allowed to occur before the next monomer is added, because heating a polymer in the absence of monomer can lead to chain coupling and deactivation of polymer chains.

Fluorinated initiator (FOE-Br) (200 mg or 0.326 mmol), FOEMA (1.3 mL or 12 molar equivalents), trifluorotoluene (1.6 mL), anisole (1.6 mL), bipyridine (152 mg or 3 molar equivalents), and CuBr₂ (5.5 mg) were added into a round-bottomed Schlenk flask. The flask was bubbled with N₂ for ˜4 min before 52 mg (1.1 equivalents) of CuBr was added. This mixture was frozen in liquid nitrogen, pumped under vacuum, thawed to room temperature, and back-filled with nitrogen. This freeze-pump-thaw-N₂ backfill procedure was repeated 4 times. The flask was then placed in a pre-heated oil bath at 85-87° C. for 70 min. ¹H NMR analysis of a sample showed that 85% of FOEMA was polymerized at this stage. The oil bath temperature was lowered down to 65-67° C. over 10-15 min. Degassed IPSMA (1.52 mL or 13 molar equivalents) was transferred to the reaction flask and stirred at 65-67° C. for 3.2 h. ¹H NMR analysis of a sample taken at this stage indicated 80-82% conversion of IPSMA. Degassed HEMA-TMS (1.1 mL or 15 molar equivalents) was added to the flask using a syringe purged by nitrogen gas. The reaction was stirred at 65-67° C. for another 4 h to obtain a conversion of 68%. The reaction flask was cooled with liquid nitrogen. After warming to room temperature, the crude mixture was diluted with 10 mL of THF. The crude mixture was then passed through an alumina column to remove copper residues. The crude mixture was concentrated into 3 ml solution and was poured into 50 ml of water:THF mixture (water volume fraction of 93%). After centrifugation, the thick semi-solid polymer at the bottom of the centrifuge tube was collected and re-dissolved in THF (3 mL) and poured into 50 mL water. The precipitation procedure was repeated four times and then the sample was dried under vacuum overnight. Overall yield after drying was 80%.

¹H NMR analysis of the polymer gave the following block structure: FOE-(FOEMA)₁₃-(IPSMA)₁₃(HEMA-TMS)_{9.5}, suggesting the average number of HEMA-TMS repeat units was slightly smaller than the targeted 10 units. Size exclusion chromatography analysis indicated that the polydispersity of the copolymer was 1.17 based on polystyrene standards.

### Materials and Methods for Examples

### Materials

Monomers 2-hydroxyethyl acrylate (HEA, 96%), methyl methacrylate (MMA, 99%), and ethylene glycol dimethacrylate (EGDMA, 96%) were purchased from Aldrich and were distilled under reduced pressure before use. Literature procedures were followed for synthesis of 2-(2′-chloropropionato)ethyl acrylate (CH2=CHCOO(CH2)2OOCCHClCH3, HEA-Cl)40 and tris[2-(dimethylamino)ethyl]amine (Me6TREN)(Ciampoli, M. and Nardi, N., Inorg. Chem., 1966, 5: 41-44). 2,2-azobisisobutyronitrile (AIBN) (Fisher Scientific) was recrystallized from ethanol before use. 2-Chloropropionyl chloride (97%), triethylamine (99%), perfluorononanoyl chloride (CF₃(CF₂)₇COCl, 98%), potassium persulfate, CuBr, CuBr₂, and methyl 2-chloropropinate were also purchased from Aldrich, and were used as received. The epoxy glue used was of the Varian Torr Seal® brand. It consisted of two parts. Part A most likely consisted of glycidyl moieties, plasticizer, and silica, and Part B most likely consisted of diamines. Cure times were specified as 24 h at 25° C. and 2 h at 60° C.

### Core-Shell (CS) Particles

To synthesize cores of CS particles, 4.80 g (48.0 mmol) of MMA, 0.40 g (2.0 mmol) of EGDMA, and 41 mg (0.15 μmol) of potassium persulfate in 5.0 mL of water were mixed under stirring (600 rpm) with 130 mL of deionized water in a 500 mL three-necked round bottom flask at room temperature. The mixture was bubbled with nitrogen for 15 min before the flask, under N₂ protection, was immersed into an oil bath that was preheated to 90° C. This temperature was maintained for 2 h to complete the polymerization.

From the resultant mixture, 43 mL was removed by a syringe and added into a 250 mL three-necked round bottom flask that was filled with N₂. This was followed by addition of 2.4 mg (14.6 μmol) of AIBN that was dissolved into 0.5 mL of distilled THF. After this mixture was stirred for 15 min at 600 rpm to facilitate absorption of AIBN by the particles, the flask was immersed into an oil bath that was preheated to 90° C. A mixture of HEA-Cl (0.40 g, 1.9 mmol), EGDMA (40 μL, 0.21 μmol), and 0.67 g MMA (6.7 mmol) was added dropwise using a syringe pump at a flow rate of 2.03 mL/h. After monomer addition, heating at 90° C. was continued for 4 h to complete shell growth.

CS particles were settled by centrifugation at 16 000 rpm (28930 g) for 20 min. The supernatant was then decanted, and particles were re-dispersed by vigorous stirring into 100 mL of deionized water. Following this, the centrifugation and supernatant removal procedure was repeated. Precipitate was dried under vacuum to give 2.0 g of the product at a 75% yield.

### Core-Shell-Corona (CSC) Particles

CSC particles were prepared by growing PHEA chains from CS particle surfaces. Three types of CSC particles were prepared using HEA-to-HEA-Cl molar feed ratios of 220:1, 430:1, and 1500:1. Resultant particles were denoted as CSC-1, CSC-2, and CSC-3, respectively.

To prepare CSC-2, 13.6 mg of CS particles containing 8.9×10⁻³ mmol of HEA-Cl were dispersed into 5.0 mL of water/methanol (at v/v=1/1) in a 50 mL Schlenk flask. To the dispersion were added 23.0 mg (0.160 mmol) of CuBr, 2.3 mg (0.010 mmol) of CuBr₂, and 64.5 mg (0.28 mmol) of Me₆TREN. Also added were 0.9 mg (8.5×10⁻³ mmol) of methyl 2-chloropropionate in 0.45 mL of methanol/water (at V/V=1/1) and 0.7456 g (6.42 mmol) HEA. The mixture was degassed thrice using a cycle consisting of sample freezing, pumping, thawing, and N₂ back-filling. This mixture was then stirred for 30 min at room temperature, and the flask was immersed into an oil bath that was preheated to 75° C. After 10 h of heating followed by cooling to room temperature, the mixture was diluted by 5.0 mL of a water/methanol mixture (v/v=1/1) and centrifuged at 3800 rpm (2850 g) for 10 min to settle the particles. The particles were redispersed into water, and the resultant solution was centrifuged to resettle the particles. This rinsing step was repeated thrice before redispersed particles were dialyzed in a tube with a cut-off molecular weight of 12000-14000 g/mol to remove small-molecule impurities. Finally, particles were settled by centrifugation and dried under vacuum to yield a white powder. Particle yield, defined as the ratio between the mass of the obtained CSC-2 particles and the total mass of the fed CS particles and HEA monomer, was determined gravimetrically to be 76%.

The supernatant of the reaction mixture after settling the CSC particles contained free polymer chains that were initiated by methyl 2-chloropropionate. The original supernatant and those from the later CSC particle rinsing steps were combined, condensed by a rotary evaporator, and then passed through a silica gel column to remove catalysts. The resultant PHEA solution was concentrated for size exclusion chromatography (SEC) analysis.

### SEC Analysis

PHEA samples were characterized by size-exclusion chromatography (SEC) operated at 70° C. Columns consisted of AM GPC Gel 1,000 Å, 10,000 Å, and 100,000 Å and a Water 2410 differential refractometer was used as the detector. The system was calibrated by monodisperse polystyrene standards. Eluant used was DMF at a flow rate of 0.90 mL/min.

### CSC Particle Fluorination

CSC particles were fluorinated by reacting hydroxyl groups of PHEA chains with perfluorononanoyl chloride. To fluorinate CSC-3 particles, particles were dissolved in dry pyridine at a concentration of 5.0 mg/mL. Perfluorononanoyl chloride (25 mg) was then slowly added as a neat liquid into 1.0 mL of the particle solution with stirring. After the addition, the system was stirred at room temperature for 18 h. Precipitate was then collected and washed with pyridine and methanol to remove byproducts before it was dried under vacuum to yield 15 mg of product CSC-3F. CSC-1 and CSC-2 were fluorinated analogously to yield CSC-1F and CSC-2F.

¹H NMR spectra of fluorinated particles were recorded on a Bruker Avance 500 MHz spectrometer. The solvent used consisted of a α,α,α-trifluorotoluene/deuterated chloroform mixture at v/v=3/1.

### Physically-Deposited Particulate Coatings

Fluorinated particles were dispersed into α,α,α-trifluorotoluene or trifluorotoluene and CSC particles were dispersed in methanol at 3.0 mg/mL, respectively. The fluorinated particle solution was then cast onto glass slides to yield physically-deposited coatings by three methods. In Method 1, coatings were obtained by spin coating a drop of the solution onto a glass slide at 3000 rpm. Method 2 involved dispensing several drops of the solution onto a glass slide and subsequently spreading them with a glass rod. In Method 3, a glass slide was tilted at ˜45° and several drops of the solution were then applied. The CSC particle coatings were prepared by Method 1. In every case, at least 4 h was allowed for solvent to evaporate at room temperature before contact angle measurements.

### Covalently Attached Amphiphobic Coatings

Part A and Part B of Varian Torr Seal® epoxy glue were mixed at a volume ratio of 2:1. About 0.1 mL of this mixture was dispensed onto a 0.7×0.7 cm² glass plate, which was subsequently spun at 10000 rpm for 1 min. The resultant film had a thickness ˜0.5 mm and was heated in a 60° C. oven for 1 h to partially cure the glue. On this glue surface was then aero-sprayed, using a home-built device (Ding, J. F. and Liu, G. J., Macromolecules, 1999, 32: 8413-8420), 0.2 mL of a 2 mg/mL CSC-2F solution in trifluorotoluene. The composite film was heated at 70° C. for 1 h and cooled to room temperature before liquid contact angle measurements.

### Fluorinated Particles on PCEMA Film

In a control experiment, a composite film was prepared by depositing CSC-2F particles on a film of a photocrosslinkable polymer, poly(2-cinnamoyloxyethyl methacrylate) or PCEMA, that had 100 repeat units. This first invoked spin-coating, at 300 rpm for 1 min, a 0.2 g/mL PCEMA solution in chloroform onto a 0.7×0.7 cm² glass plate and drying the resultant film at room temperature for 3 h, film was then irradiated for 15 min by a focused beam that had passed through a 270 nm cut-off filter from a 500 W mercury lamp in an Oriel 6140 lamp housing powered by an Oriel 6128 power supply. CEMA double-bond conversion, determined from absorbance decrease at 274 nm, was 48% (Guo, A. et al., Macromolecules, 1996, 29: 2487-2493). The CSC-2F solution in trifluorotoluene was then aero-sprayed onto the partially crosslinked PCEMA film. The composite film with polymeric particles was further irradiated for 2 h to reach a final CEMA double bond conversion of ˜90%.

Particle Extraction from the Composite Films

CSC-2F/epoxy and CSC-2F/PCEMA composite films were stirred with ˜20 mL of trifluorotoluene at 180 rpm for 16 h. The glass-plate-backed films were then dried at 100° C. for 30 min.

### Dynamic Light Scattering Measurements

Dynamic light scattering (DLS) measurements were carried out at 21° C. using a Brookhaven BI-200 SM instrument equipped with a BI-9000AT digital correlator and a He—Ne laser (632.8 nm). Samples in light scattering cells were centrifuged at 2500 rpm (1250 g) for 25 min before they were inserted gently into the DLS sample holder for measurements at 90°. Data were analyzed using the Cumulant method to yield the hydrodynamic diameter dₕ and polydispersity index K₁²/K₂ (Berne, B. J. and Pecora, R., Dynamic Light Scattering with Applications to Chemistry, Biology, and Physics, Dover Publications, Inc.: Mineola, N.Y., 1976).

### Contact Angle Measurements

Contact angles of surfaces were measured using a KRUSS tensiometer K12 that was interfaced with image-capturing software. Samples were injected as 5 μL liquid drops. Measurements were performed at room temperature using two probe liquids, including water (Milli-Q, surface tension at 20° C.: 72.8 mN/m) and diiodomethane (>99%, Sigma-Aldrich, surface tension at 20° C.: 50.8 mN/m) (Vogler, E. A., Adv. Colloid Interface Sci., 1998, 74: 69-117; Shimizu, R. N. and Demarquette, N. R., J. Appl. Polym. Sci., 2000, 76: 1831-1845).

### X-Ray Photoelectron Spectroscopy

X-ray photoelectron spectroscopy (XPS) measurements were taken using a Thermo Instruments Microlab 310F surface analysis system (Hastings, U.K.) under ultrahigh vacuum conditions. The Mg Kα X-ray (1486.6 eV) source was operated at a 15 kV anode potential with a 20 mA emission current. Scans were acquired in the Fixed Analyzer Transmission (FAT) mode, with a pass energy of 20 eV and a surface/detector take-off angle of 75°. All spectra were calibrated to the C is line at 285.0 eV, and minor charging effects were observed, which produced a binding energy increase between 1.0 and 2.0 eV.

### Transmission Electron Microscopy Measurements

For staining CS particles, 10.0 mg of CS particles, containing 6.5×10⁻³ mmol of HEA-Cl, was initially dissolved into 1.0 mL of methanol and then 2.0 mg of silver trifluoromethanesulfonate, 7.8×10⁻³ mmol, was added. The solution was stirred at 50° C. for 2 d and 4 d before it was cooled and sprayed onto the carbon-coated copper transmission electron microscopy (TEM) grid. TEM images were obtained using a Hitachi-7000 instrument operated at 75 kV.

### Atomic Force Microscopy (AFM)

Specimens were prepared by spraying solution samples onto freshly-cleaved mica surfaces and dried under vacuum. All samples were analyzed by AFM in the tapping-mode using a Veeco multimode instrument equipped with a Nanoscope IIIa controller.

Although this invention is described in detail with reference to embodiments thereof, these embodiments are offered to illustrate but not to limit the invention. It is possible to make other embodiments that employ the principles of the invention and that fall within its spirit and scope as defined by the claims appended hereto.

The contents of all documents and references cited herein are hereby incorporated by reference in their entirety.

We claim:

1. A multifunctional microsphere comprising at least one polymer chain having a first portion and a second portion, wherein the first portion is anchored to the surface of the multifunctional microsphere via grafting, crosslinking or a combination thereof, and the second portion comprises at least one fluorinated group and at least one reactive functional group capable of forming a covalent bond with an adhesive.

2. A multifunctional microsphere comprising a first polymer chain and a second polymer chain, each of said polymer chains having a first portion and a second portion, wherein the first portion of each polymer chain is anchored to the surface of the multifunctional microsphere via grafting, crosslinking or a combination thereof, and wherein the second portion of the first polymer chain comprises at least one fluorinated group, and the second portion of the second polymer chain comprises at least one reactive functional group capable of forming a covalent bond with an adhesive; optionally comprising one or more additional polymer chain(s), each additional polymer chain having a first portion and a second portion, wherein the first portion is anchored to the surface of the multifunctional microsphere via grafting, crosslinking or a combination thereof.

3. The multifunctional microsphere of claim 2, wherein the first polymer chain further comprises at least one reactive functional group capable of forming a covalent bond with an adhesive.

4. The multifunctional microsphere of claim 1, further comprising a polymer chain which is poly(ethylene glycol) (PEG), poly(dialkyl siloxane), poly(alkyl methacrylate), or poly(alkyl acrylate).

5. The multifunctional microsphere of claim 1, wherein the multifunctional microsphere comprises a silica particle, a nanoparticle, a metal oxide particle, a clay particle, a metal particle, wood dust, a cement particle, a salt particle, a ceramic particle, a sand particle, a mineral particle, a polymer particle, a crosslinked polymer microsphere, a silicon dioxide microsphere, an aluminum(III) trioxide microsphere, or an iron(III) trioxide microsphere.

6. The multifunctional microsphere of claim 1, wherein the multifunctional microsphere has a core-shell-corona (CSC) structure.

7-8. (canceled)

9. The multifunctional microsphere of claim 1, wherein the at least one fluorinated group comprises: 2-(perfluorooctyl)ethyl methacrylate (FOEMA); 2-(perfluorooctyl)ethyl acrylate (FOEA); 2-(perfluorohexyl)ethyl methacrylate; 2-(perfluorohexyl)ethyl acrylate; fluorinated poly(alkyl acrylate); fluorinated poly(alkyl methacrylate); fluorinated poly(aryl acrylate); fluorinated poly(aryl methacrylate); fluorinated polystyrene; fluorinated poly(alkyl styrene); fluorinated poly(α-methyl styrene); fluorinated poly(alkyl α-methyl styrene); poly(tetrafluoroethylene); poly(hexafluoropropylene); fluorinated poly(alkyl acrylamide); fluorinated polyvinyl alkyl ether); fluorinated polyvinyl pyridine); fluorinated polyether; fluorinated polyester; and/or fluorinated polyamide.

10-11. (canceled)

12. The multifunctional microsphere of claim 1, wherein the at least one reactive functional group comprises a hydroxyl group, an amino group, a carboxyl group, or an epoxy group.

13. The multifunctional microsphere of claim 1, wherein the polymer chain comprising at least one reactive functional group is poly(2-hydroxyethyl)methacrylate (PHEMA), polyacrylic acid (PAA), or 2-hydroxyethyl acrylate.

14. The multifunctional microsphere of claim 1, wherein the at least one reactive functional group is capable of bonding covalently with an adhesive selected from: a polyurethane adhesive; an isocyanate adhesive; an epoxy adhesive; a polyurethane glue; a thermo-setting glue; a thermo-plastic glue; an epoxy resin; a polyurethane; a resorcinol-formaldehyde resin; a urea-formaldehyde resin; a rubber cement; a silicone resin; and a polymer adhesive.

15. (canceled)

16. The multifunctional microsphere of claim 1, wherein the at least one polymer chain further comprises an end group at its terminus, wherein the end group is fluorinated alkyl, CF₃(CF₂)₇CH₂CH₂, CF₃(CF₂)₅CH₂CH₂, C₈F₁₇(CH₂)₂O(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aliphatic (e.q., alkyl), ester, aldehyde, an adamantane group, a cyclodextrin group, an azobenzene group, Br, Cl, amino or carboxyl.

17. (canceled)

18. The multifunctional microsphere of claim 1, wherein the at least one polymer chain further comprises an anchoring monomer unit, wherein the anchoring monomer unit comprises a crosslinking group, a grafting group, and/or a sol-gel forming group, and said at least one polymer chain is anchored to the surface of the microsphere via grafting, crosslinking or a combination thereof of the anchoring monomer unit to the surface of the microsphere.

19-20. (canceled)

21. The multifunctional microsphere of claim 18, wherein the anchoring monomer unit comprises a crosslinkable unit which is photocrosslinkable, crosslinkable by sol-gel formation, thermo crosslinkable, redox crosslinkable, UV-crosslinkable, and/or requires an additive for crosslinking.

22. (canceled)

23. The multifunctional microsphere of claim 1, wherein the multifunctional microsphere is nano- or micro-sized.

24-26. (canceled)

27. The multifunctional microsphere of claim 1, comprising at least one first polymer chain having a first portion and a second portion, wherein the first portion is anchored to the surface of the multifunctional microsphere via grafting, crosslinking or a combination thereof, and the second portion has the structure of formula (X):
FLₓ-GL1_{100%-x}ₘE1 (X)
wherein FL is a fluorinated monomer unit; GL1 is a reactive functional group capable of forming a covalent bond with an adhesive; E1 is an optional end group; x is from 1% to 100%; and m is 1 or greater than 1.

28. The multifunctional microsphere of claim 27, wherein when x is 100%, E1 is present and comprises a reactive functional group capable of forming a covalent bond with an adhesive.

29. The multifunctional microsphere of claim 27, wherein the multifunctional microsphere comprises a silica particle, a nanoparticle, a metal oxide particle, a clay particle, a metal particle, wood dust, a cement particle, a salt particle, a ceramic particle, a sand particle, a mineral particle, a polymer particle, a crosslinked polymer microsphere, a silicon dioxide microsphere, an aluminum(III) trioxide microsphere, or an iron(III) trioxide microsphere.

30-32. (canceled)

33. The multifunctional microsphere of claim 27, wherein the multifunctional microsphere has a core-shell-corona (CSC) structure.

34. The multifunctional microsphere of claim 27, wherein the multifunctional microsphere further comprises at least one second polymer chain having a first portion and a second portion, wherein the first portion of the at least one second polymer chain is anchored to the surface of the multifunctional microsphere via grafting, crosslinking or a combination thereof, wherein the second portion of the at least one second polymer chain has the structure of formula (Xa):
GL2ₙE2 (Xa)
wherein GL2 is a reactive functional group capable of forming a covalent bond with an adhesive; GL1 and GL2 are the same or different; E2 is an optional end group; E1 and E2 are the same or different; and n is 0, 1 or greater than 1; wherein, when n is 0, E2 is present and E2 comprises a reactive functional group capable of forming a covalent bond with an adhesive.

35. The multifunctional microsphere of claim 1, comprising at least one first polymer chain having a first portion and a second portion, wherein the first portion is anchored to the surface of the multifunctional microsphere via grafting, crosslinking or a combination thereof, wherein the at least one first polymer chain has the structure of formula (XI):
AₚFLₓ-GL3_{100%-x}ₘE3 (XI)
wherein FL is a fluorinated monomer unit; GL3 is a reactive functional group capable of forming a covalent bond with an adhesive; E3 is an optional end group; x is from 1% to 100%; A represents the first portion of the at least one first polymer chain and is an anchoring monomer unit anchored to the surface of the multifunctional microsphere via grafting, crosslinking or a combination thereof; p is 1 or greater than 1; and m is 1 or greater than 1.

36. The multifunctional microsphere of claim 35, wherein x is 100%, and E3 is present and comprises a reactive functional group capable of forming a covalent bond with an adhesive.

37. The multifunctional microsphere of claim 35, wherein the multifunctional microsphere further comprises at least one second polymer chain having a first portion and a second portion, the first portion of the at least one second polymer chain anchored to the surface of the multifunctional microsphere via grafting, crosslinking or a combination thereof, wherein the second portion of the at least one second polymer chain has the structure of formula (Xa) as defined in claim 34, wherein GL3 and GL2 are the same or different and E3 and E2 are the same or different.

38. A multifunctional microsphere comprising at least one first polymer chain of claim 27 and at least one second polymer chain, the at least one first polymer chain and the at least one second polymer chain each having a first portion and a second portion;
wherein the first portion of the at least one first polymer chain is anchored to the surface of the multifunctional microsphere via grafting, crosslinking or a combination thereof, and the second portion of the at least one first polymer chain has the structure of formula (X):
FLₓ-GL1_{100%-x}ₘE1 (X)
wherein FL is a fluorinated monomer unit; GL1 is a reactive functional group capable of forming a covalent bond with an adhesive; E1 is an optional end group; x is from 1% to 100%; and m is 1 or greater than 1;
wherein the first portion of the at least one second polymer chain is anchored to the surface of the multifunctional microsphere via grafting, crosslinking or a combination thereof, and wherein the at least one second polymer chain comprises:
a) a polymer chain having the structure of formula (XIa):
AₚFL2ₓ₂-GL3_{100%-x2}ₘE3 (XIa)
wherein FL2 is a fluorinated monomer unit; GL3 is a reactive functional group capable of forming a covalent bond with an adhesive; E3 is an optional end group; x2 is from 1% to 100%; A is an anchoring monomer unit anchored to the surface of the multifunctional microsphere via grafting, crosslinking or a combination thereof; p is 0, 1 or greater than 1; and m is 1 or greater than 1; and/or
b) a polymer chain having the structure of formula (Xa):
GL2ₙE2 (Xa)
wherein GL2 is a reactive functional group capable of forming a covalent bond with an adhesive, E2 is an optional end group, and n is 0, 1 or greater than 1; wherein, when n is 0, E2 is present and comprises a reactive functional group capable of forming a covalent bond with an adhesive; and/or
c) a polymer chain which is poly(ethylene) glycol (PEG) poly(dialkyl siloxane), poly(alkyl methacrylate), or poly(alkyl acrylate);
wherein any of GL1, GL2, and GL3 are the same or different, FL and FL2 are the same or different, and any of E1, E2 and E3 are the same or different;
wherein at least one of FL and FL2 is present;
wherein, if at least one of GL1, GL2 or GL3 is not present, then at least one of E1, E2 or E3 is present and comprises a reactive functional group capable of forming a covalent bond with an adhesive.

39. (canceled)

40. The multifunctional microsphere of claim 27, wherein the fluorinated monomer unit comprises 2-(perfluorooctyl)ethyl methacrylate (FOEMA); 2-(perfluorooctyl)ethyl acrylate (FOEA); 2-(perfluorohexyl)ethyl methacrylate; 2-(perfluorohexyl)ethyl acrylate; fluorinated poly(alkyl acrylate); fluorinated poly(alkyl methacrylate); fluorinated poly(aryl acrylate); fluorinated poly(aryl methacrylate); fluorinated polystyrene; fluorinated poly(alkyl styrene); fluorinated poly(α-methyl styrene); fluorinated poly(alkyl α-methyl styrene); poly(tetrafluoroethylene); poly(hexafluoropropylene); fluorinated poly(alkyl acrylamide); fluorinated poly(vinyl alkyl ether); fluorinated poly(vinyl pyridine); fluorinated polyether; fluorinated polyester; and/or fluorinated polyamide.

41. (canceled)

42. The multifunctional microsphere of claim 27, wherein the reactive functional group comprises a hydroxyl group, an amino group, a carboxyl group, or an epoxy group.

43. The multifunctional microsphere of claim 27, wherein the polymer chain comprising a reactive functional group is poly(2-hydroxyethyl)methacrylate (PHEMA), polyacrylic acid (PAA), or 2-hydroxyethyl acrylate.

44. The multifunctional microsphere of claim 27, wherein the reactive functional group is capable of bonding covalently with an adhesive selected from: a polyurethane adhesive; an isocyanate adhesive; an epoxy adhesive; a polyurethane glue; a thermo-setting glue; a thermo-plastic glue; an epoxy resin; a polyurethane; a resorcinol-formaldehyde resin; a urea-formaldehyde resin; a rubber cement; a silicone resin; and a polymer adhesive.

45. (canceled)

46. The multifunctional microsphere of claim 27, wherein the end group is fluorinated alkyl, CF₃(CF₂)₇CH₂CH₂, CF₃(CF₂)₅CH₂CH₂, C₈F₁₇(CH₂)₂—O—(CH₂)₃, CF₃(CF₂)₇CH₂CH₂OOCCH(CH₃), CF₃(CF₂)₅CH₂CH₂OOCCH(CH₃), CF₃(CF₂)₇CH₂CH₂OOCC(CH₃)₂, CF₃(CF₂)₅CH₂CH₂OOCC(CH₃)₂, H, OH, NH₂, SH, CO₂H, glycidyl, ketone, aliphatic (e.g., alkyl), ester, aldehyde, an adamantane group, a cyclodextrin group, an azobenzene group, Br, Cl, amino or carboxyl.

47. The multifunctional microsphere of claim 35, wherein the anchoring monomer unit has the structure of formula (XII):
(X_{q}-G_{100%-q}) (XII)
wherein X denotes a monomer unit that can undergo inter-polymer crosslinking; G denotes a grafting unit grafted to the surface of the multifunctional microsphere; and q is from 0% to 100%.

48. The multifunctional microsphere of claim 47, wherein q is 100% or 0%.

49. (canceled)

50. The multifunctional microsphere of claim 47, wherein G is selected from the group consisting of: maleic anhydride; glycidyl methacrylate; glycidyl acrylate; anhydrides; acrylates; methacrylates; acid chlorides; glycidyl groups; silyl halide groups; triazole groups; epoxide groups; isocyanate groups; and succinimide groups.

51. (canceled)

52. The multifunctional microsphere of claim 47, wherein G is selected from: (i) aldehyde and ketone-functional polymers such as polyacetal polymers, polyacrolein polymers, poly(methyl isopropenyl ketone) polymers, poly(vinyl methyl ketone) polymers, aldehyde-terminated poly(ethylene glycol) polymers, carbonylimidazole-activated polymers, and carbonyldiimidazole-terminated poly(ethylene glycol) polymers; (ii) carboxylic acid anhydride-functional polymers such as poly(acrylic anhydride) polymers, poly(alkalene oxide/maleic anhydride) copolymers, poly(azelaic anhydride) polymers, poly(butadiene/maleic anhydride) copolymers, poly(ethylene/maleic anhydride) copolymers, poly(maleic anhydride) polymers, poly(maleic anhydride/1-octadecene) copolymers, poly(vinyl methyl ether/maleic anhydride) copolymers, and poly(styrene/maleic anhydride) copolymers; (iii) carboxylic acid chloride-functional polymers such as poly(acrylolyl chloride) polymers and poly(methacryloyl chloride) polymers; and (iv) chlorinated polymers such as chlorine-terminated polydimethylsiloxane polymers, chlorinated polyethylene polymers, chlorinated polyisoprene polymers, chlorinated polypropylene polymers, poly(vinyl chloride) polymers, epoxy-terminated polymers, epoxide-terminated poly(ethylene glycol) polymers, isocyanate-terminated polymers, isocyanate-terminated poly(ethylene glycol) polymers, oxirane functional polymers, poly(glycidyl methacrylate) polymers, hydrazide-functional polymers, poly(acrylic hydrazide/methyl acrylate) copolymers, succinimidyl ester polymers, succinimidyl ester-terminated poly(ethylene glycol) polymers, tresylate-activated polymers, tresylate-terminated poly(ethylene glycol) polymers, vinyl sulfone-terminated polymers and vinyl sulfone-terminated poly(ethylene glycol) polymers.

53. The multifunctional microsphere of claim 35, wherein the anchoring monomer unit has the structure of formula (XIIa):
S^{I1}_{q}—S^{I2}_{100%-q} (XIIa)
wherein S^{I1} and S^{I2} denote different sol-gel forming monomer units, and q is from 0% to 100%.

54. The multifunctional microsphere of claim 53, wherein S^{I1}_{q}—S^{I2}_{100%-q} has the following structure: 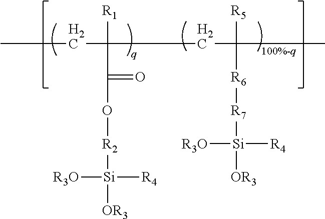
wherein R₁ and R₅ are hydrogen, alkyl, or an aromatic group containing a benzene ring; R₂ and R₇ are alkylene; R₃ is alkyl or aryl; R₄ is alkyl or —OR₃ or another type of alkoxy; R₆ is an aromatic ring, pyridine ring, pyran ring, furan ring, or methylene; and q is 1% or greater than 1%.

55. (canceled)

56. The multifunctional microsphere of claim 35, wherein the anchoring monomer unit has the structure shown in Formula (Id):
S^{I}ₖ—Xₗ (Id)
wherein S^{I} and X denote different monomer units that can undergo inter-polymer crosslinking, and S^{I} denotes a sol-gel forming monomer unit; l is 0, 1 or greater than 1; k is 0, 1 or greater than 1; and l and k are not both zero.

57. The multifunctional microsphere of claim 56, wherein 1<k<200 and/or 1<l<200.

58. (canceled)

59. The multifunctional microsphere of claim 35, wherein p is 10, x is 10, or both p and x are 10.

60. The multifunctional microsphere of claim 35, wherein the anchoring monomer unit is anchored to the surface of the multifunctional microsphere via photocrosslinking, crosslinking by sol-gel formation, thermo crosslinking, redox crosslinking and/or UV-crosslinking.

61. The multifunctional microsphere of claim 56, wherein S^{I} is a trialkoxysilane-containing unit, a dialkoxysilane-containing unit, or an IPSMA (3-(triisopropyloxysilyl)propyl methacrylate) unit; and/or wherein X is 2-cinnamoyloxyethyl methacrylate (CEMA) or 2-cinnamoyloxyethyl acrylate (CEA).

62. (canceled)

63. The multifunctional microsphere of claim 27, wherein the multifunctional microsphere comprises PIPSMA-b-PFOEMA, PCEMA-b-PFOEMA and/or PIPSMA-b-PCEMA-b-PFOEMA; or, poly(3(triisopropyloxysilyl))propyl methacrylate-block-poly(heptadecaperfluorooctyl)ethyl methacrylate, wherein the number of repeat units of both monomers is 10.

64. (canceled)

65. The multifunctional microsphere of claim 1, wherein the multifunctional microsphere is a poly(meth)acrylate polymer microsphere having a surface grafted with a random copolymer of FOEMA and hydroxyethylmethacrylate (HEMA); a poly(meth)acrylate polymer microsphere having a surface grafted with 2-(perfluorooctyl)ethyl acrylate (FOEA) and polyacrylic acid (PAA); a silicon dioxide sphere having a surface grafted with a random copolymer of FOEMA and HEMA; a silicon dioxide sphere having a surface grafted with PFOEMA and PAA; a silicon dioxide sphere having a surface grafted with a random copolymer of PF8AEG and HEMA; or a silicon dioxide sphere having a surface grafted with poly PF8AEG and PAA.

66-138. (canceled)
